(19) United States
(12) Patent Application Publication
(10) Pub. No.: US 2005/0260481 A1
(43) Pub. Date: Nov. 24, 2005

(54) Disposable fuel cell with and without cartridge and method of making and using the fuel cell and cartridge

(76) Inventors: Gennadi Finkelshtain, Shoham (IL); Mark Estrin, Meuhad (IL); Moti Meron, Hrzeliya (IL); Eric Torgeman, Tel Aviv (IL); Yuri Katsman, Hadera (IL); Alexander Silberman, Haifa (IL)

Correspondence Address: GREENBLUM & BERNSTEIN, P.L.C., 1950 ROLAND CLARKE PLACE, RESTON, VA, 20191, US

(21) Appl. No.: 10/849,503

(22) Filed: May 20, 2004

(51) Int. Cl. H01M 8/02

(52) U.S. Cl. 429/34; 429/127; 220/4.12

(57) ABSTRACT

Disposable fuel cell and a system for filling a disposable fuel cell. The system includes a fuel cell having at least one chamber, a cartridge having at least one chamber, and a valve system which regulates or controls fluid flow between the cartridge and fuel cell. A method of refilling a fuel cell provides for connecting the cartridge to the fuel cell and transferring fuel and electrolyte from the cartridge to the fuel cell. This Abstract is not intended to define the invention disclosed in the specification, nor intended to limit the scope of the invention in any way.

### BACKGROUND OF THE INVENTION

1. Field of the Invention

The present invention relates to a disposable fuel cell. The present invention also relates to a disposable, portable, and one-time fillable fuel cell capable of providing electricity. The invention also relates to a disposable single-use refilling device, e.g., a cartridge, for filling a disposable fuel cell which is connected to the fuel cell during its use. The present invention also relates to the combination of a disposable fully functioning self-contained fuel cell having one or more compartments for the electrodes and a disposable cartridge having one or more chambers which supplies and stores fuel(s) for the fuel cell. The cartridge is capable of supplying fresh fuel/electrolyte to the fuel cell a single instance and is prevented from being removed from the fuel cell. The fuel cell is prevented from being reused and/or refilled.

The invention also relates to a disposable fuel cell having a flexible collapsing chamber and a disposable cartridge having a flexible collapsing chamber, wherein the cartridge can be connected to the fuel cell only once and is thereafter prevented from being removed from and/or disconnected from the fuel cell as well as a method of making and using these devices.

The invention further relates to a disposable fuel cell and cartridge system which are attached to one another when fuel components are transferred from the cartridge to the fuel cell in a transfer phase. The fuel cell can then be used to produce electricity in a working phase. The fuel components (i.e., spent fuel and electrolyte) remain in the fuel cell and are prevented from being transferred back to the cartridge from the fuel cell. The fuel cell and cartridge can be disposed on once the fuel cell is no longer of generating the desired power.

2. Discussion of Background Information

Fuel cells produce electricity by bringing a fuel into contact with a catalytic anode. At the same time, an oxidant is brought into contact with a catalytic cathode. There are many well-known problems with conventional fuel (H₂, CH₃OH) storage and transportation associated with fuel cells, especially in the field of portable fuels and fuel cells. As the fuel cell produces electricity, the liquid fuel and the electrolyte, usually in a refillable liquid fuel cell, are gradually exhausted of their useful components. After a period of use, the spent liquid fuel and the spent electrolyte need to be removed from the fuel cell and replaced. This process is not easily and/or economically accomplished. Refilling the fuel cell also presents other difficulties due to the hazardous nature of the spent liquid fuel and the spent electrolyte. Thus, there is a need for a system for filling a fillable liquid fuel cell which allows one to perform the filling process more easily, more economically, and more safely, and which can safely store the spent fuel once its useful properties have been exhausted.

Disposable fuel cells are not known by Applicant to be in existence. Almost all types of fuel cells (PEM, alkaline, molten, etc.,) various types of fuel (hydrogen/hydrocarbons and different kinds of alcohol). They typically require a fuel tank, a fuel replacement system, a heater, a water management system, etc., All of these additional systems are needed for fuel replacement, to support the desired constant reaction conditions, and in order to provide for product elimination. Such arrangements yield to the energy capacity per unit volume of the fuel cell and provide for fuel cell systems which are not, to say the least, potable.

Conventional fuel cells require a continuous supply of fuel or a replaceable cartridge. Even with cartridge-based systems, the fuel is delivered, using a complex process which involves dilution, to a tank. The fuel then reacts with the anode. Micro-fuel cells based on methanol use a relatively small tank and require a feeding system to supply fuel to the tank.

Conventional fuel cells have also become very complicated, are not very reliable, and are very expensive. Accordingly, the idea that one would discard such conventional fuel cells is unthinkable in view of these considerations. For these reasons, there has been an absence of disposable fuel cells.

### SUMMARY OF THE INVENTION

There is a need for a fuel cell which is not complicated, which is reliable, inexpensive, and easy to use. If one of more of these features are utilizes in the fuel cell, one could consider producing such a fuel cell so as to be disposable or so as to be of a single-use design. Such a fuel cell would eliminate the fuel replacement system. It would also function without requiring heating and/or a heating system. It would additionally also not require a water management, a scrubber and other additional systems typically utilized with conventional fuel cells. The absence of all these systems would significantly increase energy capacity per unit volume of the fuel cell. Because of its simpler construction it would also be less likely to leak.

In particular, such a fuel cell system would eliminate the need to remove the spent fuel from the fuel cell for safe disposal or storage. If the fuel cell uses a cartridge system, the cartridge design can be made simpler and less expensive. The valve system between the fuel cell and the cartridge can also be made simpler and less expensive. The fuel cell can also be made so that it functions with either a binary fuel or with a one component fuel, and is not limited to borohydride based fuels. For example, borohydride/alcohol and pure alcohol based fuels can be used with the disposable fuel cell disclosed herein. Additionally, the disposable fuel cell can utilize alkaline electrolyte, a matrix, a jelly-like fuel, as well as electrolytes.

Due to the high-energy potential of Applicant's fuel composition (in all of the various possible compositions), Applicant has been able to produce a fuel cell whose fuel chamber(s) contains all of the required fuel components within a reasonable size. Such a fuel cell eliminates the need for expensive and complicated fuel delivery systems and allows for the fuel cell to be made disposable.

According to one non-limiting embodiment of the invention, a portable stand-alone single-use disposable fuel cell is designed so that it can be purchased or procured with the fuel component(s) being added at the time of purchase is provided. The seller will have a filling station which can be used at the time the user purchases the fuel cell. Applicant envisions such filling stations being located at electronics stores, such as Radio Shack®. The station will have a large supply of fuel components, as well as a system for filling the fuel cells quickly. Once filled, the user uses the fuel cell until it is exhausted. Then, the user simply discards and/or recycles the fuel cell. The design of the fuel cell is such that it cannot be refilled and/or its contents cannot be easily removed without destroying the fuel cell. Moreover, the filling station only has the ability to fill an empty fuel cell.

According to another non-limiting embodiment of the invention, a portable stand-alone single-use disposable fuel cell is designed so that it can be purchased or procured without the fuel components being contained therein is provided. The purchaser can then bring the unit to a filling station in order to have the fuel cell filled. This station can be a retailer or place of purchase. Applicant envisions such filling stations being located at electronics stores, such as Radio Shack®. The station will have a large supply of fuel components, as well as a system for filling the fuel cells quickly. Once filled, the user uses the fuel cell until it is exhausted. Then, the user simply discards and/or recycles the fuel cell. The design of the fuel cell is such that it cannot be refilled and/or its contents cannot be easily removed without destroying the fuel cell. Moreover, the filling station only has the ability to fill an empty fuel cell.

According to another non-limiting embodiment of the invention, a portable stand-alone single-use disposable fuel cell designed so that it can be purchased or procured with a non-removably attached and partially connected cartridge containing the fuel component(s) and without the fuel components being contained therein in the fuel cell is provided. The purchaser can then manipulate and/or move the cartridge relative to the fuel cell to cause the fuel component(s) in the cartridge to enter into the fuel cell. This can occur once mechanisms are removed which prevent the complete connection of the cartridge to the fuel cell. The fuel cell and cartridge cannot be disconnected from each other and there are no mechanisms for causing and/or allowing the fuel component(s) to move back from the fuel cell to the cartridge. A new cartridge cannot be connected to the fuel cell without destroying the fuel cell. Once filled, the user uses the fuel cell until it is exhausted. Then, the user simply discards and/or recycles the fuel cell. The design of the fuel cell is such that it cannot be refilled and/or its contents cannot be easily removed without destroying the fuel cell. Moreover, the non-removably connected cartridge is only capable of filling an empty fuel cell a single time.

According to still another non-limiting embodiment of the invention, a portable stand-alone single-use disposable fuel cell designed so that it can be purchased or procured as a unit assembly including a cartridge containing the fuel component(s) separated from a fuel cell which does not contain the fuel component(s). The purchaser can then install and/or connect the cartridge on, into, or to the fuel cell and cause the fuel component(s) in the cartridge to enter into the fuel cell. The fuel cell and cartridge, once initially connected, cannot be disconnected from each other and there are no mechanisms for causing and/or allowing the fuel component(s) to move back from the fuel cell to the cartridge. A new cartridge cannot be connected to the fuel cell without destroying the fuel cell. Once filled, the user uses the fuel cell until it is exhausted. Then, the user simply discards and/or recycles the fuel cell and cartridge as a unit. The design of the fuel cell is such that it cannot be refilled and/or its contents cannot be easily removed without destroying the fuel cell. Moreover, the non-removably connected cartridge is only capable of being connected to the fuel cell once and is capable of filling an empty fuel cell only a single time.

According to still another non-limiting embodiment of the invention, a portable stand-alone single-use disposable fuel cell designed so that it can be purchased or procured as a unit assembly including a cartridge containing the fuel component(s). The cartridge contains the fuel component(s) and is separated from the fuel cell which does not contain the fuel component(s). The purchaser can then install and/or connect the cartridge on, into, or to the fuel cell and cause the fuel component(s) in the cartridge to enter into the fuel cell. The fuel cell and cartridge, once initially connected and the fuel component(s) transferred from the cartridge to the fuel cell, can be disconnected from each other. The cartridge can then be disposed of or refilled and made ready (i.e., recycled) for use with another fuel cell. The fuel cell includes mechanism for preventing the fuel component(s) from exiting the fuel cell and/or from moving back from the fuel cell to the cartridge. Once filled, the user uses the fuel cell until it is exhausted. Then, the user simply discards and/or recycles the fuel cell. The design of the fuel cell is such that it cannot be refilled and/or its contents cannot be easily removed without destroying the fuel cell. Moreover, the removably connected cartridge is only capable of transferring the fuel component(s) to the fuel cell once and is capable of filling an empty fuel cell only a single time.

The invention thus provides for a disposable and/or single-use fuel cell system comprising a fuel cell that includes at least one variable volume chamber, a cartridge that includes at least one variable volume chamber, and a valve system which regulates or controls fluid flow between the cartridge and fuel cell and vice versa. The invention also provides for a fuel cell and/or cartridge system of the type disclosed in copending U.S. patent application Ser. No. 10/824,443 (attorney docket No. P24786), which was filed on Jan. 16, 2004, wherein the cartridge and/or the fuel cell is made disposable. The disclosure of copending U.S. patent application Ser. No. 10/824,443 is hereby expressly incorporated by reference in its entirety.

The at least one variable volume chamber of the fuel cell may comprise a flexible fuel chamber. The system may further comprise a defined volume electrolyte chamber. The system may further comprise an electrolyte chamber. The at least one variable volume chamber of the cartridge may comprise a flexible fuel chamber. The at least one variable volume chamber of the cartridge may comprise a flexible fuel chamber and a flexible electrolyte chamber. The at least one variable volume chamber of the fuel cell may comprise a flexible wall having folds. The at least one variable volume chamber of the cartridge may comprise a flexible wall having folds. The at least one variable volume chamber of the fuel cell may comprise a flexible expandable and contractable chamber. The at least one variable volume chamber of the cartridge may comprise a flexible expandable and contractable chamber.

The cartridge may be non-removably connected to the fuel cell. The cartridge may be non-removably connected to the fuel cell by a sliding connection. The cartridge may be non-removably connected to the fuel cell by a sliding cradle connection. The cartridge may be non-removably connected to the fuel cell by an abutting connection. The cartridge may be non-removably connected to the fuel cell by a rotational sliding connection.

The fuel cell may further comprise a front cover, a rear cover, a mounting frame, an anode assembly, a cathode assembly, a cathode protection device, and a frame rim. The at least one variable volume chamber of the fuel cell may comprise a flexible wall having folds and a peripheral rim secured to the anode assembly. The cathode protection device may comprise a cathode protection net. The anode assembly and the cathode assembly may be mounted to the mounting frame and wherein a volume defined by the mounting frame, the anode assembly and the cathode assembly forms an electrolyte chamber. The at least one variable volume chamber of the fuel cell may comprise a flexible wall having folds and a peripheral rim secured to the anode assembly and wherein a volume defined by the flexible wall and the anode assembly forms the at least one variable volume chamber of the fuel cell.

The cartridge may further comprise a front cover and a rear cover. The at least one variable volume chamber of the cartridge may be disposed between the front cover and the rear cover.

The at least one variable volume chamber of the cartridge may comprise a backing and a flexible wall having folds and a peripheral portion secured to the backing. The backing may comprise a plate.

The at least one variable volume chamber of the cartridge may comprise a variable volume fuel chamber and a variable volume electrolyte chamber, and further comprising fuel arranged within the variable volume fuel chamber and electrolyte arranged within the variable volume electrolyte chamber.

The at least one variable volume chamber of the fuel cell may comprise a variable volume fuel chamber, and the fuel cell may further comprise an electrolyte chamber, fuel arranged within the variable volume fuel chamber, and electrolyte arranged within the electrolyte chamber.

The valve system may be a one-time non-disconnectable connection and may comprise a first part which is coupled to the fuel cell and a second part which is coupled to the cartridge. The second part may be insertable into the first part. The second part may be non-releasably connectable to the first part. When the second part is not connected to the first part, the first part may prevent fluid from exiting out of the fuel cell and the second part prevents fluid from exiting out of the cartridge. When the second part is not connected from the first part, the first part may prevent fluid from leaking out of the fuel cell and the second part prevents fluid from leaking out of the cartridge.

The valve system may comprise a closed position and an opened position. The valve system may comprise a plurality of exit ports which are in fluid communication with the fuel cell. The fuel cell and the cartridge may each comprise a generally rectangular shape.

The invention also provides for a method of assembling a cartridge to a fuel cell, wherein the method comprises non-removably connecting the cartridge to the fuel cell wherein the cartridge comprises at least one variable volume chamber and wherein the fuel cell comprises at least one variable volume chamber, and transferring fluid from the cartridge to the fuel cell.

The method may further comprise preventing a substantial portion of the fluid from moving back to the cartridge. The method may further comprise preventing the cartridge from being disconnected and/or separated from the fuel cell. The transferring may comprise regulating or controlling fluid flow between the cartridge and fuel cell. The transferring may comprise allowing fluid flow between the cartridge and fuel cell and preventing fluid flow between the fuel cell and cartridge.

The method may further comprise preventing the transfer of spent fluid between the fuel cell and the cartridge. The method may further comprise controlling fluid flow between the cartridge and the fuel cell via a valve system. The method may further comprise controlling fluid flow between the fuel cell and the cartridge via a one-time connection valve system.

The transferring may comprise compressing the least one variable volume chamber of the cartridge to cause the fluid to enter into the fuel cell. The fluid may comprise fuel and electrolyte. The transferring may comprise forcing the fluid to enter into the at least one variable volume chamber of the fuel cell from the at least one variable volume chamber of the cartridge. The at least one variable volume chamber of the fuel cell may comprise a flexible wall with folds. The at least one variable volume chamber of the cartridge may comprise a flexible wall with folds. The at least one variable volume chamber of the fuel cell may comprise a flexible expandable and contractable chamber. The at least one variable volume chamber of the cartridge may comprise a flexible expandable and contractable chamber.

The method may further comprise, before the transferring, coupling a valve of the cartridge to a valve of the fuel cell. The method may further comprise, before the transferring, causing each valve to open from a closed position to allow fluid communication between the cartridge and the fuel cell.

The method may further comprise controlling fluid flow between the cartridge and the fuel cell and vice versa with a valve arrangement. The method may further comprise, before the transferring, securely non-removably attaching a male valve portion on the cartridge to a female valve portion on the fuel cell.

The method may further comprise, after the transferring, preventing the transfer of spent fluid from the fuel cell to the cartridge and preventing a disconnecting of the cartridge from the fuel cell. The method may further comprise, after the connecting, automatically transferring the fluid from the cartridge to the fuel cell.

The invention also provides for a disposable single-use portable cartridge for refilling a fuel cell, wherein the cartridge comprises a main container, at least one variable volume fuel chamber and at least one variable volume electrolyte chamber arranged within the main container, and a valve that communicates with the at least one variable volume fuel and electrolyte chambers.

The main container may comprise a rear cover and a front cover. The at least one variable volume fuel chamber may comprise an flexible material wall that is at least one of expandable and compressible and inflatable and deflatable. The at least one variable volume electrolyte chamber may comprise an flexible material wall that is at least one of expandable and compressible and inflatable and deflatable. The at least one variable volume fuel chamber may be defined by an inflatable and/or expandable flexible material wall and a rigid plate. The at least one variable volume electrolyte chamber may be defined by another inflatable and/or expandable flexible material wall and the rigid plate.

The at least one variable volume electrolyte chamber may be defined by an inflatable and/or expandable flexible material wall and a rigid plate. The at least one variable volume fuel chamber may comprise a flexible material wall with folds. The at least one variable volume electrolyte chamber may comprise a flexible material wall with folds. The main container may completely surround and contain the at least one variable volume fuel chamber and the at least one variable volume electrolyte chamber. The at least one variable volume fuel chamber and the at least one variable volume electrolyte chamber may be separated from each other.

The disposable single-use cartridge may further comprise fuel arranged within the at least one variable volume fuel chamber and electrolyte arranged within the at least one variable volume electrolyte chamber.

The valve may be adapted to prevent fuel and electrolyte from exiting the at least one variable volume fuel chamber and the at least one variable volume electrolyte chamber when the cartridge is separated from and/or not connected to the fuel cell, and the valve may be adapted to allow fuel and electrolyte to exit from the at least one variable volume fuel chamber and the at least one variable volume electrolyte chamber when the cartridge is non-removably connected to the fuel cell.

The valve may be adapted to prevent fuel and electrolyte from exiting the at least one variable volume fuel chamber and the at least one variable volume electrolyte chamber when the valve is not connected to a valve of the fuel cell, and the valve may be adapted to allow fuel and electrolyte to exit from the at least one variable volume fuel chamber and the at least one variable volume electrolyte chamber when the valve of the cartridge is non-removably connected to the valve of the fuel cell.

The valve may be adapted to connect to a valve of the fuel cell only a single time. The valve may comprise a closed position and an opened position. The valve may comprise a plurality of exit ports which are adapted for fluid communication with the fuel cell.

The cartridge may further comprise a securing cap that is removably secured to the valve. The fuel cell may comprise a cover that is removably secured to the fuel cell.

The invention also provides for a disposable portable single-use fuel cell adapted to connect to a cartridge, wherein the fuel cell comprises an outer shell, at least one variable volume fuel chamber and at least one electrolyte chamber arranged within the outer shell, an anode arranged within the outer shell, a cathode arranged within the outer shell, and a valve that communicates with the at least one variable volume fuel and electrolyte chambers.

The outer shell may comprise a rear cover and a front cover. The at least one variable volume fuel chamber may comprise an flexible material wall that is at least one of expandable and compressible and inflatable and deflatable. The at least one electrolyte chamber may comprise a defined volume chamber. The at least one variable volume fuel chamber may be defined by an inflatable and/or expandable flexible material wall and a rigid plate member. The rigid plate member may comprise the anode. The at least one electrolyte chamber may be defined by the cathode. The at least one electrolyte chamber may be defined by the cathode and a frame member.

The at least one variable volume fuel chamber may comprise a flexible material wall with folds. The fuel cell may further comprise a frame member supporting the anode and the cathode. The outer shell may completely surround and contain the at least one variable volume fuel chamber and the at least one electrolyte chamber. The at least one variable volume fuel chamber and the at least one electrolyte chamber may be separated from each other.

The fuel cell may further comprise fuel arranged within the at least one variable volume fuel chamber and electrolyte arranged within the at least one electrolyte chamber.

The valve may be adapted to prevent fuel and electrolyte from exiting the at least one variable volume fuel chamber and the at least one electrolyte chamber when the fuel cell is not connected to a cartridge, and the valve may be adapted to allow fuel and electrolyte to enter into the at least one variable volume fuel chamber and the at least one electrolyte chamber when the cartridge is non-removably connected to the fuel cell.

The valve may be adapted to prevent fuel and electrolyte from exiting the at least one variable volume fuel chamber and the at least one electrolyte chamber when the valve is not connected to a valve of the cartridge, and the valve may be adapted to allow fuel and electrolyte to enter into the at least one variable volume fuel chamber and the at least one electrolyte chamber when the valve of the cartridge is non-removably connected to the valve of the fuel cell.

The valve may be adapted to connect to a valve of the cartridge only a single time. The valve may comprise a closed position and an opened position. The valve may comprise a plurality of exit ports which are adapted for fluid communication with the cartridge.

The fuel cell may further comprise a securing cap that is removably secured to the valve.

The invention also provides for a disposable fuel cell and cartridge system, wherein the system comprises a fuel cell and a cartridge. The fuel cell comprises an anode, a cathode, at least one variable volume fuel chamber, at least one electrolyte chamber, and a first valve which regulates or controls fluid flow. The cartridge comprises at least one variable volume fuel chamber, at least one variable volume electrolyte chamber, and a second valve which regulates or controls fluid flow. The second valve is non-removably connectable to the first valve.

The fuel cell may comprise an outer shell having a rear cover and a front cover. Each at least one variable volume fuel chamber may comprise an flexible material wall that is at least one of expandable and compressible and inflatable and deflatable. The at least one electrolyte chamber of the fuel cell may comprise a defined volume chamber.

Each at least one variable volume fuel chamber may be defined by an inflatable and/or expandable flexible material wall and a rigid plate member. The at least one electrolyte chamber of the fuel cell may be defined by the cathode and a frame member.

Each at least one variable volume fuel chamber may comprise a flexible material wall with folds.

The system may further comprise a frame member supporting the anode and the cathode of the fuel cell.

The fuel cell may further comprise an outer shell that completely surrounds and contains the at least one variable volume fuel chamber and the at least one electrolyte chamber. The cartridge may further comprise a main container that completely surrounds and contains the at least one variable volume fuel chamber and the at least one variable volume electrolyte chamber. The at least one variable volume fuel chamber and the at least one electrolyte chamber of the fuel cell may be separated from each other, and the at least one variable volume fuel chamber and the at least one variable volume electrolyte chamber of the cartridge may be separated from each other.

The system may further comprise fuel arranged within the at least one variable volume fuel chamber and electrolyte arranged within the at least one electrolyte chamber of the fuel cell.

The system may further comprise fuel arranged within the at least one variable volume fuel chamber and electrolyte arranged within the at least one variable volume electrolyte chamber of the cartridge.

The first valve may be adapted to prevent fuel and electrolyte from entering the at least one variable volume fuel chamber and the at least one electrolyte chamber when the fuel cell is separated from the cartridge, and the second valve may be adapted to allow fuel and electrolyte to exit from the at least one variable volume fuel chamber and the at least one variable volume electrolyte chamber of the cartridge when the cartridge is non-removably connected to the fuel cell. The first valve may be adapted to prevent fuel and electrolyte from entering the at least one variable volume fuel chamber and the at least one electrolyte chamber when the first valve is not connected to the second valve of the cartridge, and the first valve may be adapted to allow fuel and electrolyte to enter into the at least one variable volume fuel chamber and the at least one electrolyte chamber when the second valve of the cartridge is non-removably connected to the first valve of the fuel cell.

The first valve of the fuel cell may be adapted to connect to the second valve of the cartridge only a single time. Each of the first and second valves may comprise a closed position and an opened position. Each of the first and second valves may comprise a plurality of exit ports which are adapted for fluid flow.

The system may further comprise a first securing cap that is removably secured to the first valve and a second securing cap that is removably secured to the second valve. The first valve may be securely and sealingly connected to second valve.

The invention also provides for a method of filling a disposable fuel cell using the system described above, wherein the method comprises non-removably connecting the second valve of the cartridge to the first valve of the fuel cell, forcing fuel to enter into the at least one variable volume fuel chamber of the fuel cell from the at least one variable volume fuel chamber of the cartridge, and forcing electrolyte to enter into the at least one electrolyte chamber of the fuel cell from the at least one variable volume electrolyte chamber of the cartridge.

Each forcing may comprise compressing the at least one variable volume fuel chamber and the at least one variable volume electrolyte chamber to cause fuel and electrolyte to enter into the fuel cell.

The method may further comprise controlling fluid flow between the fuel cell and cartridge with the first and second valves.

The method may further comprise preventing fluid flow between the fuel cell and the cartridge.

The method may further comprise preventing fuel from entering into the at least one variable volume fuel chamber of the cartridge from the at least one variable volume fuel chamber of the fuel cell, preventing electrolyte from entering into the at least one variable volume electrolyte chamber of the cartridge from the at least one electrolyte chamber of the fuel cell, and preventing a disconnecting of the second valve from the first valve.

The invention also provides for a method of filling a disposable fuel cell with a non-removably connected cartridge, wherein the method comprises fully connecting the cartridge and the fuel cell to each other and transferring at least one fuel component from the cartridge to the fuel cell.

The method may further comprise preventing a transferring of the at least one fuel component from the fuel cell to the cartridge and preventing a disconnecting of the cartridge from the fuel cell.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an exploded view of one non-limiting embodiment of a disposable fuel cell and cartridge for filling a fuel cell. This embodiment uses a cartridge that includes separate fuel and electrolyte supply chambers;

FIG. 2 shows an enlarged exploded view of the fuel cell shown in FIG. 1;

FIG. 3 shows an enlarged exploded view of the cartridge shown in FIG. 1;

FIG. 4 shows a perspective cross-section view of the embodiment shown in FIG. 1. The fuel cell is shown on the left while the cartridge is shown on the right. In this position, the cartridge and fuel cell are not yet connected to each other and the cartridge contains the fresh fuel and electrolyte;

FIG. 5 shows an enlarged view of the circled portion in FIG. 4;

FIG. 6 shows another perspective cross-section view of the embodiment shown in FIG. 1. The fuel cell is shown on the left while the cartridge is shown on the right. In this position, the cartridge and fuel cell are not yet connected to each other and the cartridge contains the fresh fuel and electrolyte;

FIG. 7 shows a perspective cross-section view of the embodiment shown in FIG. 1. The fuel cell is shown on the left while the cartridge is shown on the right. In this position, the cartridge and fuel cell are arranged just prior to being connected to each other. The cartridge contains the fresh fuel and electrolyte which will be pumped into the fuel cell after the cartridge is inserted into the fuel cell;

FIG. 8 shows an enlarged view of the circled portion in FIG. 7;

FIG. 9 shows another perspective cross-section view of the embodiment shown in FIG. 1. The fuel cell is shown on the left while the cartridge is shown on the right. In this position, the cartridge and fuel cell are arranged just prior to being connected to each other. The cartridge contains the fresh fuel and electrolyte which will be pumped into the fuel cell after the cartridge is inserted into the fuel cell;

FIG. 10 shows a perspective cross-section view of the embodiment shown in FIG. 1. The fuel cell is shown on the left while the cartridge is shown on the right. In this position, the cartridge and fuel cell are fully connected to each other. The cartridge continues to contain the fresh fuel and electrolyte;

FIG. 11 shows an enlarged view of the circled portion in FIG. 10;

FIG. 12 shows another perspective cross-section view of the embodiment shown in FIG. 1. The fuel cell is shown on the left while the cartridge is shown on the right. In this position, the cartridge and fuel cell are fully connected to each other. The cartridge continues to contain the fresh fuel and electrolyte;

FIG. 13 shows a perspective cross-section view of the embodiment shown in FIG. 1. The fuel cell is shown on the left while the cartridge is shown on the right. In this position, the cartridge and fuel cell are fully connected to each other and the fresh fuel and electrolyte have been pumped from the cartridge to the fuel cell;

FIG. 14 shows an enlarged view of the circled portion in FIG. 13;

FIG. 15 shows another perspective cross-section view of the embodiment shown in FIG. 1. The fuel cell is shown on the left while the cartridge is shown on the right. In this position, the cartridge and fuel cell are fully connected to each other and the fresh fuel and electrolyte have been pumped from the cartridge to the fuel cell;

FIG. 16 shows another non-limiting embodiment of a disposable fuel cell and cartridge arrangement. This embodiment uses a cartridge which slides into connection with the fuel cell from a vertical position. This embodiment also uses separate fuel and electrolyte supply chambers;

FIG. 17 shows another non-limiting embodiment of a disposable fuel cell and cartridge arrangement. This embodiment uses a cartridge which slides onto the fuel cell from a horizontal position. This embodiment also uses separate fuel and electrolyte supply chambers;

FIG. 18 shows another non-limiting embodiment of a disposable fuel cell and cartridge arrangement. This embodiment uses a cartridge which slides onto the fuel cell from a horizontal position and which rotates from an angled position to the vertical position. This embodiment also uses separate fuel and electrolyte supply chambers;

FIG. 19 shows a view of the embodiment of FIG. 18 with the cartridge in the angled position prior to being connected to the fuel cell and rotated to the vertical position;

FIG. 20a shows a partial view of the outer portions of the valve sleeves arranged adjacent to one another;

FIG. 20b shows a first spring and plunger valve which is utilized in the fuel cell valve;

FIG. 20c shows a second spring and ball valve which is utilized in the cartridge valve;

FIG. 20d shows a partial view of the two valves in an assembled state prior to being connected to each other;

FIG. 20e shows a partial view of the two valves in a connected state and in a state which allows for fluid communication between the cartridge and fuel cell;

FIG. 21a shows a partial view of another valve embodiment wherein the outer portions of the valve sleeves are arranged adjacent to one another;

FIG. 21b shows a first spring and plunger valve which is utilized in the fuel cell valve;

FIG. 21c shows side cross-sectional and front end views of pierceable washer which is utilized in the cartridge valve;

FIG. 21d shows a partial view of the two valves in an assembled state prior to being connected to each other;

FIG. 21e shows a partial view of the two valves in a connected state and in a state which allows for fluid communication between the cartridge and fuel cell. The pierceable washer is shown in pierced state and the plunger valve is shown in a retracted position caused by fluid pressure sufficient to overcome the biasing force of the first spring, i.e., the fluid pressure caused by the fluid being forced from the cartridge and into the fuel cell;

FIG. 22 shows a bottom view of a removable protective cover for a disposable fuel cell;

FIG. 23 shows a side cross-section view of the removable protective cover shown in FIG. 22;

FIG. 24 shows a side view of a generally rectangular disposable fuel cell which can utilize the cover shown in FIGS. 22 and 23;

FIG. 25 shows a top view of the disposable fuel cell shown in FIG. 24 with the protective cover removed;

FIG. 26 shows a side cross-section view of the disposable fuel cell shown in FIGS. 24 and 25 with the protective cover removed. The anode and cathodes are not shown;

FIG. 27 shows a bottom view of a disposable cartridge without the pierceable washer and sealing ring;

FIG. 28 shows a side cross-section view of the disposable cartridge shown in FIG. 27. The pierceable washer and sealing ring are shown in an uninstalled state;

FIG. 29a shows a side cross-section view of the sealing ring used in the disposable cartridge shown in FIGS. 27 and 28;

FIG. 29b shows an end view of the sealing ring shown in FIG. 29a;

FIG. 30a shows a side cross-section view of the pierceable washer used in the disposable cartridge shown in FIGS. 27 and 28;

FIG. 30b shows an end view of the sealing ring shown in FIG. 30a;

FIG. 31 shows a side cross-section view of the disposable cartridge shown in FIGS. 27 and 28, and the disposable fuel cell shown in FIGS. 25 and 26. The cartridge contains the fuel component(s) and the sealing ring and the pierceable washer in an installed state. The cartridge is arranged in an aligned position prior to being connected to the fuel cell;

FIG. 32 shows a side cross-section view of the disposable cartridge and the disposable fuel cell shown in FIG. 31 in a non-removably fully connected state. The cartridge is shown with its pierceable washers being pierced by the piercing members of the fuel cell;

FIG. 33 shows a side cross-section view of the disposable cartridge and the disposable fuel cell shown in FIG. 32. The pistons of the cartridge are shown in a lowermost position after having moved automatically under the influence of the springs. The fuel component(s) of the cartridge has been transferred to the fuel cell;

FIG. 34 shows a side cross-section view of another disposable cartridge and the disposable fuel cell in a non-removably connected state. This embodiment includes projections and corresponding recesses on the cartridge and fuel cell to ensure that the cartridge cannot be connected with the fuel cell unless they are properly aligned with each other;

FIG. 35 shows a side cross-section view of another disposable cartridge and the disposable fuel cell in a partially non-removably connected state. This embodiment includes removable separator mechanisms on the cartridge and fuel cell to ensure that the cartridge cannot be fully connected with the fuel cell unless these mechanisms are first removed;

FIG. 36 shows a side cross-section view of the disposable cartridge and the disposable fuel cell of FIG. 35, but with the removable separator mechanisms removed there from;

FIG. 37 shows a side cross-section view of the disposable cartridge and the disposable fuel cell of FIGS. 35 and 36 in a non-removably fully connected state;

FIG. 38 shows a side cross-section view of the disposable cartridge and the disposable fuel cell shown in FIG. 37. The pistons of the cartridge are shown in a lowermost position after having moved automatically under the influence of the springs. The fuel component(s) of the cartridge has been transferred to the fuel cell;

FIG. 39 shows a top view of another disposable fuel cell embodiment with its protective cover removed. The fuel cell is designed to function without the need for a cartridge and can be filled once at a designated filling station;

FIG. 40 shows a side partial cross-section view of the disposable fuel cell of FIG. 39 with the protective cover arranged in an installed and/or non-removable state;

FIG. 41 shows a side cross-section view of one non-limiting valve system for filling the fuel cell of FIG. 40;

FIG. 42 shows the valve system of FIG. 41 in a fully connected state;

FIG. 43 shows a side cross-section view of another non-limiting valve system for filling the fuel cell of FIG. 40;

FIG. 44 shows the valve system of FIG. 43 in a fully connected state;

FIG. 45 shows the fuel cell valve port of the valve system of FIGS. 43 and 44 with a protective cap installed thereon;

FIG. 46 shows a side cross-section view of another disposable cartridge and the disposable fuel cell in a removably connected state. This embodiment includes one-way valves in the fuel cell to prevent the fuel components in the fuel cell from exiting out of the fuel cell and from re-entering the cartridge. This embodiment allows the empty cartridge to be removed from fuel cell so that the fuel cell can be used is smaller spaces which would not accommodate the additional space required by the cartridge;

FIG. 47 shows an enlarged partial view of FIG. 46;

FIG. 48 shows the embodiment of FIG. 47 with the empty cartridge disconnected from the fuel cell;

FIG. 49 shows a side cross-section view of another disposable cartridge and the disposable fuel cell in a fully non-removably connected state. This embodiment is similar to the embodiment shown in FIGS. 25-33 except that it includes flexible variable-volume chambers in the cartridge;

FIG. 50 shows an enlarged partial view of FIG. 49;

FIG. 51 shows a possible arrangement of a two piece cartridge body which can be used with the embodiment shown in FIG. 49. The cartridge body is shown in an unconnected state;

FIG. 52 shows the two piece cartridge body of FIG. 51 in a connected state;

FIG. 53 shows a side cross-section view of another disposable cartridge and the disposable fuel cell in a fully non-removably connected state. This embodiment is similar to the embodiment shown in FIGS. 25-33 except that it utilizes a mechanical piston actuation system in place of the springs and except that it utilizes one-way cartridge valves in place of the piercing washer;

FIG. 54 shows an enlarged partial view of FIG. 53;

FIG. 55 shows an enlarged partial view of an alternative fuel port/cartridge port connection;

FIG. 56 shows a side cross-section view of another disposable cartridge and the disposable fuel cell in a fully connected state. This embodiment uses a valve system to connect the cartridge to the fuel cell;

FIG. 57 shows a graph illustrating the performance of the fuel cell shown in FIG. 56; and

FIG. 58 illustrates one non-limiting way in which the cartridges and fuel cells shown in FIGS. 24-40 and 46-56 can be formed by assembly two main components, e.g., a body portion and a cover portion.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

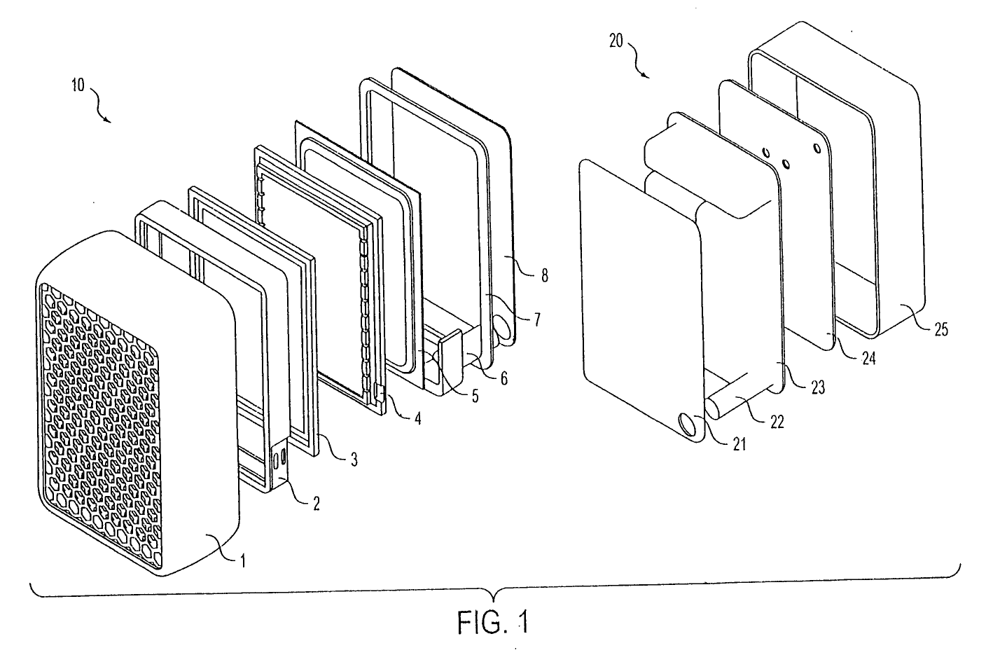

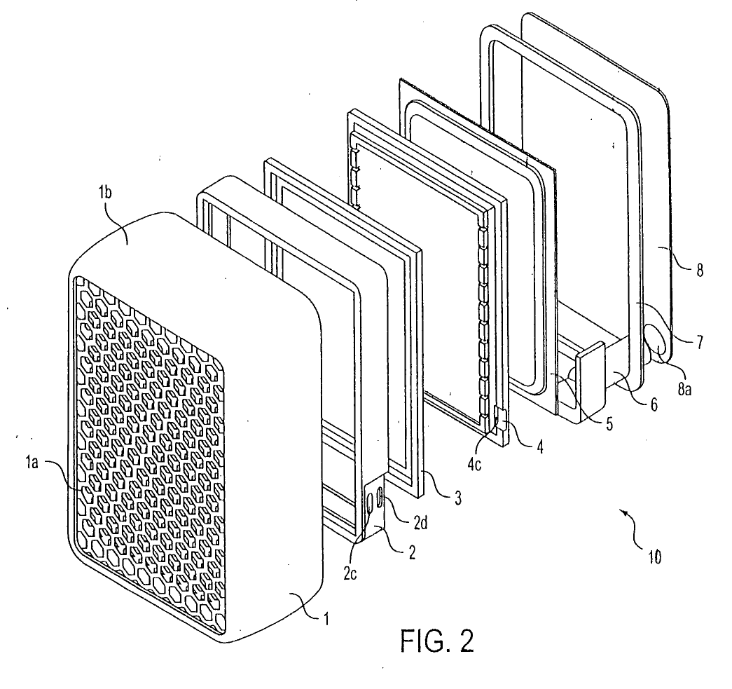

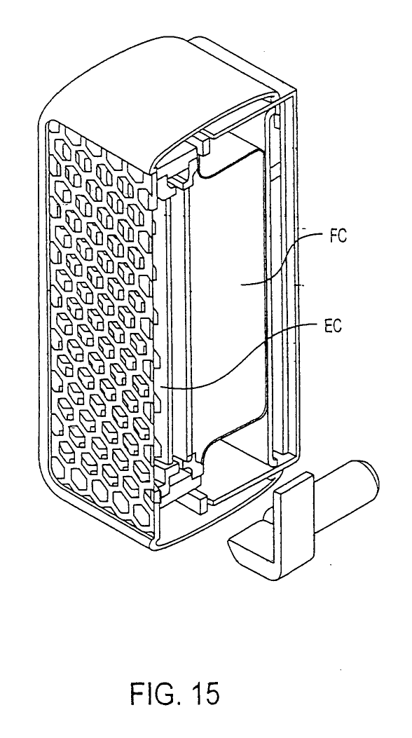

FIGS. 1-15 show a first non-limiting embodiment of a disposable fuel cell 10 and cartridge 20 arrangement and/or system. The fuel cell 10 includes a front cover 1 and is generally rectangular in shape. Of course, the fuel cell 10 can have any other desired shape including, but not limited to any other polygonal or any other linear and/or curvilinear shape. The front cover 1 functions as a support frame for the internal components 2-8, and preferably together with the rear cover 8, defines a fuel cell enclosure. As can be seen in, e.g., FIG. 2, the front cover 1 includes an outer peripheral wall 1b and a cathode protection net 1a which is fixed to an outer perforated surface of the cover 1. An electrode frame member 2 is mounted and/or fixed within the front cover 1. The frame 2 is generally rectangular in shape. Of course, the frame 2 can have any other desired shape. The frame 2 functions as a support frame for inner and outer electrodes.

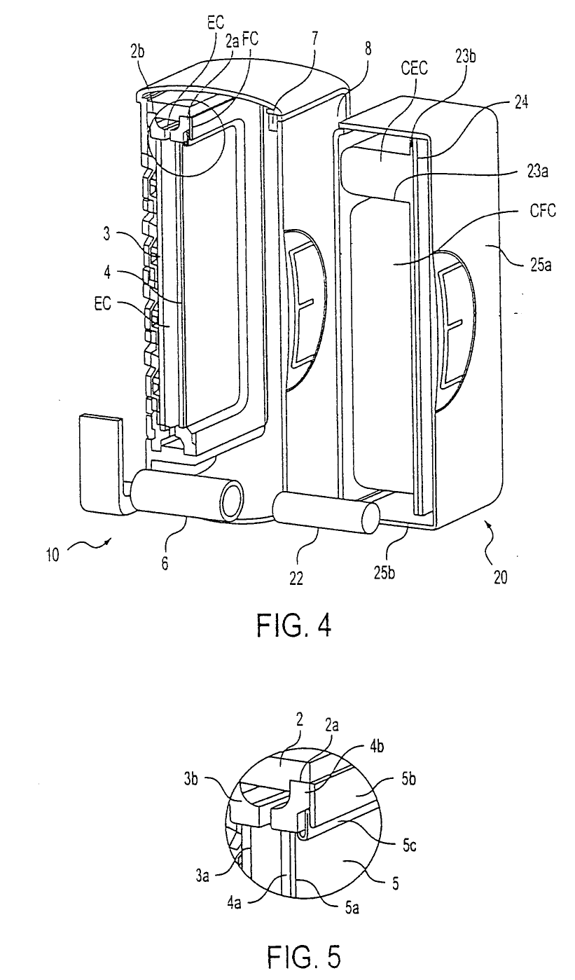

The outer electrode constitutes a cathode member 3 while the inner electrode constitutes an anode member 4. As can be seen in FIGS. 4 and 5, the cathode member 3 includes a cathode plate member 3a that is mounted within a peripheral rim member 3b, both of which are generally rectangular in shape. The rim portion 3b, in turn, is mounted within the frame 2. The anode member 4 includes an anode plate member 4a that is mounted within a peripheral rim member 4b, both of which are generally rectangular in shape. The rim portion 4b is similarly mounted within the frame 2. In this regard, the frame 2 includes an outer internal peripheral shoulder wall 2b which receives therein, in a sealing and/or press fit manner, the peripheral rim member 3b of the cathode member 3, as well as an opposite facing inner internal peripheral shoulder wall 2a which receives therein, in a sealing and/or press fit manner, the peripheral rim member 4b of the anode member 4. The arrangement of the cathode member 3, anode member 4 and frame 2 is such that they define an internal volume and/or space which forms a defined volume electrolyte chamber EC. The electrolyte chamber EC can be filled with electrolyte via one or more openings 2c (see FIG. 2).

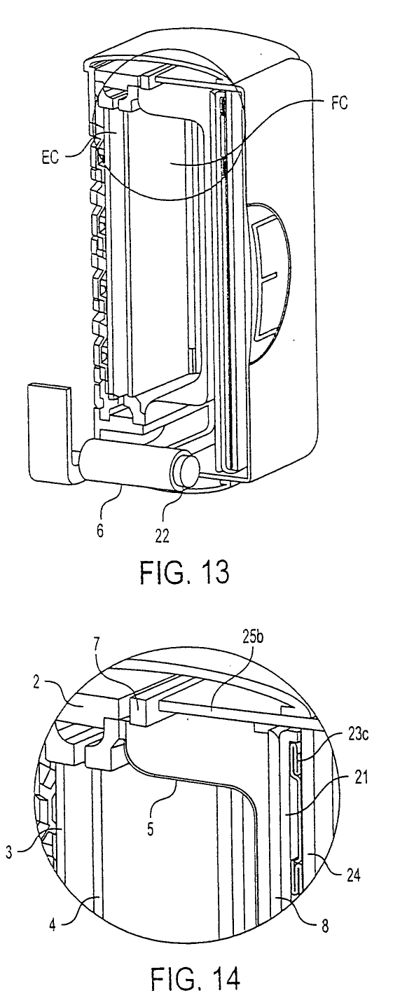

A flexible material member 5 includes a flexible expandable/inflatable wall 5a, one or more peripheral flexible folds 5c and a peripheral portion 5b (see FIG. 5). The flexible material 5 may be made of LLDPE (linear low density PE). Alternatively, the flexible material 5 may be a hot formed flat multiplayer polymer film. In this case, one or more outer layers may have a melting temperature that will substantially meet or equal the part of it that it will be heat welded to, RF welded to, or ultrasonically welded to (such a weld joint can be provided between portions 4b and 5b in FIG. 5). The flexible member 5 can be made as a one-piece member. Alternatively, the wall 5a and folds 5c can be formed as a one-piece member and securely and sealingly attached to a separately formed peripheral portion 5b using, e.g., adhesive bonding, ultrasonic welding, etc. As can be seen in FIGS. 4 and 5, the peripheral portion 5b of the flexible material member 5 is securely and sealingly attached to the peripheral rim member 4b and is also generally rectangular in shape. The rim 5b may be up to approximately 1 mm thick, while the remaining flexible or freely expandable portion(s) 5c, 5a may be approximately 0.3 mm thick. The rim member 4b may be made of ABS 5-20% carbon filled and/or may include a mechanical cavity imbedded into it in the area of the weld joint. This cavity can be filled and/.or injected with PE using a consecutive injection process. Such an imbedded polymer rim 4b would facilitate attachment to the rim 5b of the flexible member 5. The arrangement of the anode member 4 and flexible material member 5 is such that they define an internal volume and/or space which forms a variable volume fuel chamber FC. The fuel chamber FC can be filled with fuel via one or more openings 2d in the frame 2, as well as one or more through openings 4c (which are aligned with openings 2d) in the rim 4b of the anode member 4 (see FIG. 2). The fuel chamber FC is a variable volume chamber by virtue of the flexible wall 5a and peripheral folds 5c. In this way, the variable volume fuel chamber FC constitutes and/or functions as a flexible expandable and contractable chamber which can expand when filled and/or inflated with fuel (see FIGS. 13-15) and which is in a contracted state when the fuel is not yet arranged therein (see FIGS. 4, 6, 7, 9, 10 and 12).

A movable rim member 7 arranged to move within the front cover 1. The rim member 7 is generally rectangular in shape and functions as a filler member to produce a gap or spacing (and thereby prevent contact) between member 2 and 25. For example, FIGS. 13 and 14 show a travel range of the member 7 and illustrates how the member 7 prevents the wall 25b from contacting member 2. The rim member 7 and rear plate 8 can each be made as a one-piece members. As can be seen in FIG. 2, the rear plate 8 includes an opening 8a which is sized to receive therein a valve 6. The valve 6 is configured to allow electrolyte and fuel to enter (separately from each other) into the fuel cell 10 and is also configured to mate with a valve 22 of a cartridge 20. In this regard, the valve 6 includes openings (as will be explained in detail later on) which communicate with openings 2c and 2d of the frame 2 to allow fuel and electrolyte to enter into the electrolyte chamber EC and the variable volume fuel chamber FC of the fuel cell 10. Although not shown, the invention contemplates fuel cells with more than one electrolyte chamber EC and more than one variable fuel chamber FC. This can be accomplished by using additional anode, cathode and frame arrangements, as well as additional anode and flexible material member arrangements. Alternatively, the electrolyte chamber EC can be made up of a plurality of smaller electrolyte sub-chambers which may or may not be in fluid communication with each other, but which would be in fluid communication with the valve 6. Similarly, the fuel chamber FC can be made up of a plurality of smaller fuel sub-chambers which may or may not be in fluid communication with each other, but which would be in fluid communication with the valve 6.

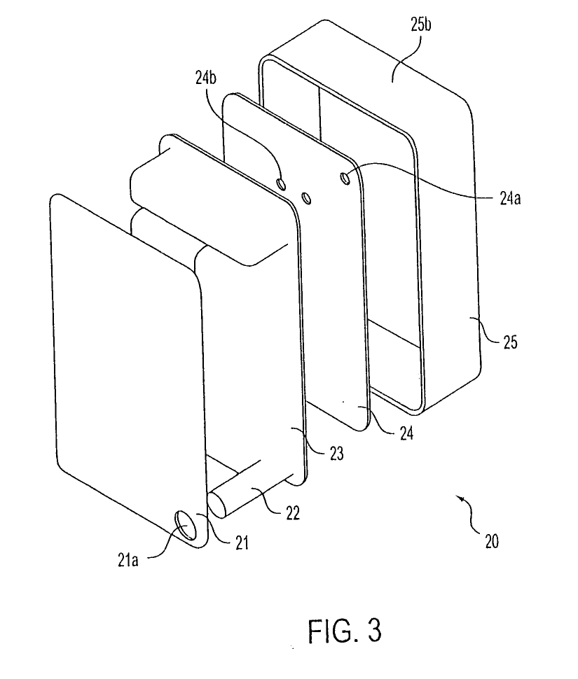

The disposable cartridge 20 is also generally rectangular in shape. Of course, the cartridge 20 can have any other desired shape. The cartridge 20 has the form of an enclosure and includes a movable front cover plate 21 and a rear cover 25. The rear cover 25 functions as a support frame for the internal components 23 and 24 and together with the front cover 21 defines a cartridge enclosure. As can be seen in, e.g., FIGS. 3 and 4, the rear cover 25 includes an outer peripheral wall 25b and a rear wall 25a. A peripheral portion 23b of a flexible material wall 23a is mounted and/or fixed in a sealing manner to the cover plate 24. The plate 24 is generally rectangular in shape. Of course, the plate 24 can have any other desired shape. The plate 24 functions as a rigid support for the flexible wall 23a. The arrangement of the flexible member 23 and plate 24 is such that they define two separate internal volumes and/or spaces which form a variable volume cartridge electrolyte chamber CEC and a variable volume cartridge fuel chamber CFC. The electrolyte chamber CEC can be filled with electrolyte via one or more openings 24a in the plate 24 (see FIG. 3) while the fuel chamber CFC can be filled with fuel via one or more openings 24b in the plate 24 (see FIG. 3).

As noted above, the flexible material member 23 includes a flexible expandable/inflatable wall 23a which is secured to the plate 24 at various locations. The wall 23a includes one or more flexible folds 23c (see FIG. 14) for each variable volume chamber CEC, CFC. The flexible member 23 and folds 23c can be formed as a one-piece member and securely and sealingly attached to a separately formed plate 24 using, e.g., adhesive bonding, ultrasonic welding, etc. As can be seen in FIG. 4, the peripheral portion 23b as well as other portions of the flexible material member 23 are securely and sealingly attached to the plate 24 to define the variable volume chambers CEC and CFC. The flexible material 23 may be made of LLDPE (linear low density PE). Alternatively, the flexible material 23 may be a hot formed flat multiplayer polymer film. In this case, one or more outer layers may have a melting temperature that will substantially meet equal the part of the it will be heat welded to, RF welded to, or ultrasonically welded to (such a weld joint can be provided between portions 23b and 24 in FIG. 4). The arrangement of the plate 24 and flexible material member 23 is such that they define one or more small internal volumes and/or spaces which form one or more variable volume electrolyte chambers CEC and one or more internal volumes and/or spaces which form one or more variable volume fuel chambers CFC. The fuel chamber CFC and electrolyte chamber CEC are thus variable volume chambers by virtue of the flexible wall 23 and the folds 23c. In this way, the variable volume fuel and electrolyte chambers CFC and CEC constitute and/or function as a flexible expandable and contractable chambers which can expand when filled (i.e., when filled initially) and/or inflated with fuel and electrolyte (see FIGS. 4, 6, 7, 9, 10 and 12) and which can contract when the fuel and electrolyte are removed therefore (see FIGS. 13-15). The rim 5b may be up to approximately 1 mm thick, while the remaining flexible or freely expandable portion(s) 5c, 5a may be approximately 0.3 mm thick. The member 24 may be made of ABS 5-20% carbon filled and/or may include a mechanical cavity imbedded into its peripheral area or weld joint area. This cavity can be filled and/.or injected with PE using a consecutive injection process. Such an imbedded polymer rim would facilitate attachment to the rim 23b of the flexible member 23.

As noted above, the movable plate member 21 is arranged to move within the rear cover 25. The plate 21 and rear cover 25 can each be made as one-piece members. As can be seen in FIG. 3, the plate 21 includes an opening 21a which is sized to receive therein a valve 22. The valve 22 is configured to allow electrolyte and fuel to enter (separately from each other) into the cartridge 20 when it is filled initially and is also configured to mate with a valve 6 of the fuel cell 10. In this regard, the valve 22 includes openings (as will be explained in detail below) which communicate with openings 24a and 24b of the plate 24 to allow fuel and electrolyte to enter into the variable volume electrolyte chamber CEC and the variable volume fuel chamber CFC. Although not shown, the invention contemplates cartridges with more than one variable volume electrolyte chamber CEC and more than one variable fuel chamber CFC. This can be accomplished by using additional plates and flexible wall arrangements. Alternatively, the electrolyte chamber CEC can be made up of a plurality of smaller electrolyte sub-chambers which may or may not be in fluid communication with each other but which would be in fluid communication with the valve 22. Similarly, the fuel chamber CFC can be made up of a plurality of smaller fuel sub-chambers in any desired configuration which may or may not be in fluid communication with each other but which would be in fluid communication with the valve 22.

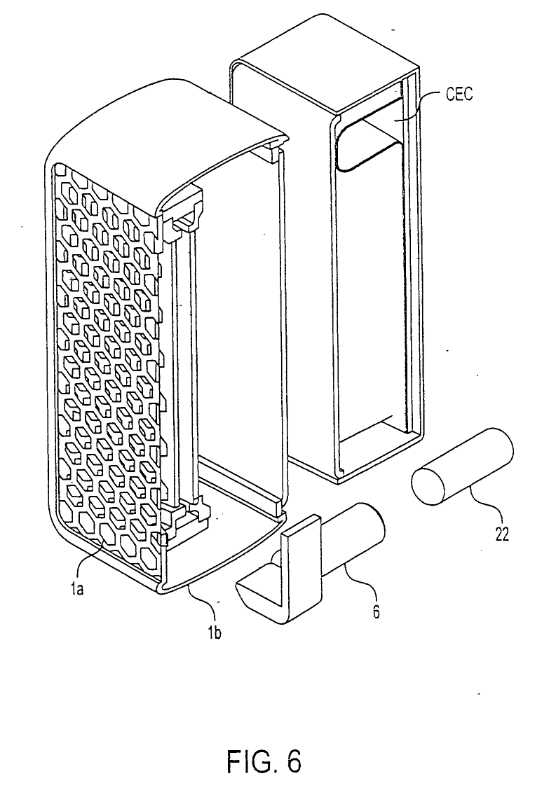

FIGS. 4 and 6 show the disposable fuel cell 10 and the disposable cartridge 20 in a position prior to the cartridge 20 being inserted into the fuel cell 10. At this point, the valve 22 of the cartridge 20 has also not mated with the valve 6 of the fuel cell 10. In this position, the cartridge 20 contains a substantially full and/or expanded electrolyte chamber CEC and a substantially full and/or expanded fuel chamber CFC. In the case of a new cartridge 20, these chambers CEC and CFC contain new or fresh electrolyte and fuel which is ready to be used and/or transferred to the fuel cell 10. The amounts of electrolyte and fuel contained in the cartridge 20 should generally correspond to the requirements of a particular fuel cell 10. Thus, the amount of electrolyte in the chamber CEC of the cartridge 20 should be sufficient to fill the chamber EC (up to a desired point) in the fuel cell 10 when the cartridge 20 is fully inserted and/or connected to the fuel cell 10 (see FIGS. 13-15). Similarly, the amount of fuel in the chamber CFC of the cartridge 20 should be sufficient to fill the chamber FC (up to a desired point) in the fuel cell 10 when the cartridge 20 is fully inserted and/or connected to the fuel cell 10 (see FIGS. 13-15). Of course, this may require that the chambers CEC and CFC of the cartridge 20 contain more electrolyte and fuel than can normally be accommodated in the chambers EC and FC in the fuel cell 10, owing to the fact that some fuel and electrolyte will be left in the valves 6 and 22, as well as in the fluid communication passages of both the fuel cell 10 and cartridge 20.

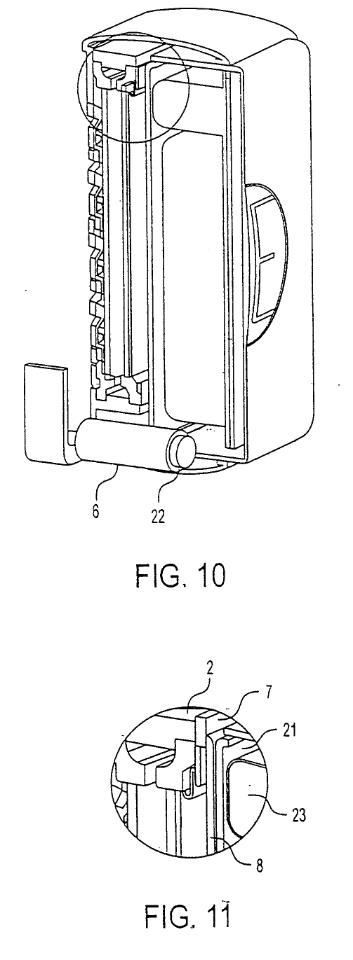

In the case of a new fuel cell 10, the electrolyte chamber EC and the variable volume fuel chamber FC are empty. In other words, the volume and/or space defined by the frame 2, cathode 3 and anode 4 is essentially empty of electrolyte and the fuel chamber FC is essentially in a fully deflated position and/or defines a lower volume limit (e.g., it has essentially zero volume because the flexible material member 5 is arranged closely adjacent to the anode member 4). This unconnected position is also characterized by the plate 21 being in a fully expanded position relative to the rear cover 25 of the cartridge 20, and by the plate 8 being in a fully expanded position and ready to move to a fully retracted position shown in FIGS. 10-12.

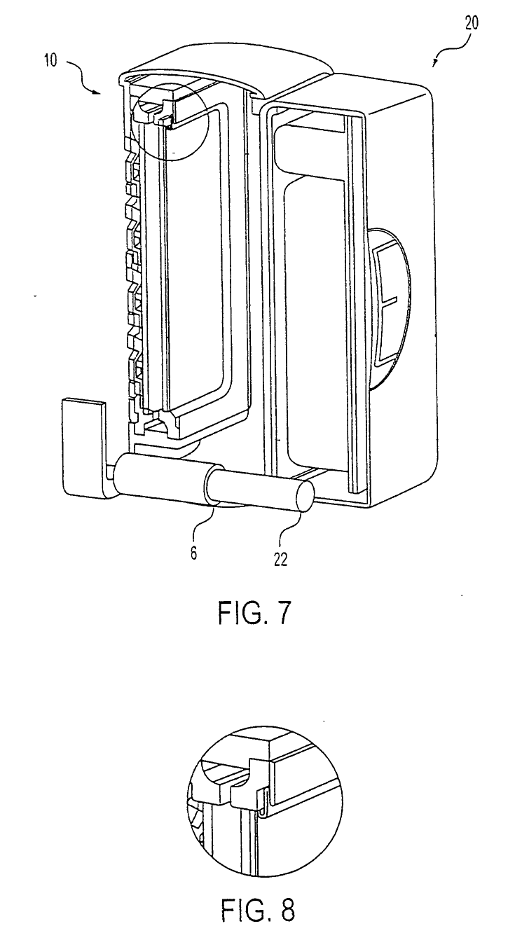

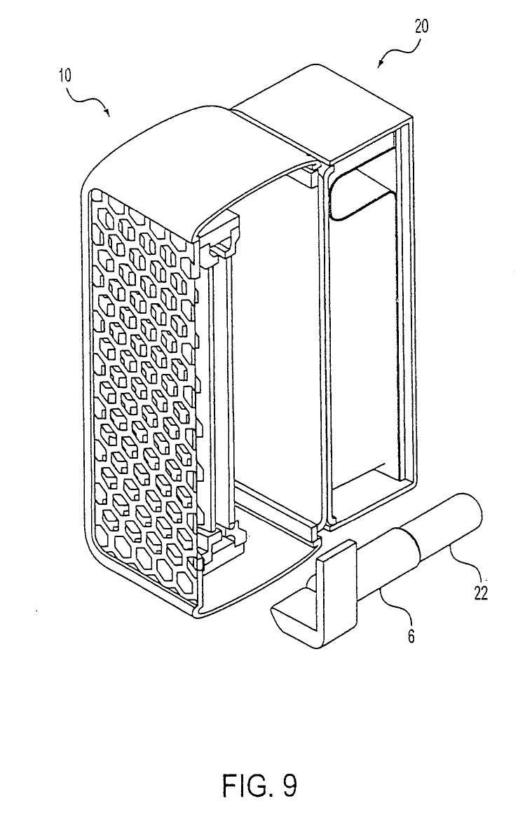

FIGS. 7 and 9 show the fuel cell 10 and the cartridge 20 in a position just prior to the cartridge 20 being inserted into the fuel cell 10. At this point, the valve 22 of the cartridge 20 has been aligned with the valve 6 of the fuel cell 10 and is ready for mating therewith. Moreover, the cartridge 20 body is also aligned with and in contact with the fuel cell 10 body and is otherwise ready for insertion therein. In this position, the cartridge 20 continues to contain a substantially full and/or expanded electrolyte chamber CEC and a substantially full and/or expanded fuel chamber CFC. In the case of a new cartridge 20, these chambers CEC and CFC contain new or fresh electrolyte and fuel which is ready to be used and/or transferred to the fuel cell 10. The amounts of electrolyte and fuel contained in the cartridge 20 should generally correspond to the requirements of a particular fuel cell 10. Thus, the amount of electrolyte in the chamber CEC of the cartridge 20 should be sufficient to fill the chamber EC (up to a desired point) in the fuel cell 10 when the cartridge 20 is fully inserted and/or connected to the fuel cell 10 (see FIGS. 13-15). Similarly, the amount of fuel in the chamber CFC of the cartridge 20 should be sufficient to fill the chamber FC (up to a desired point) in the fuel cell 10 when the cartridge 20 is fully inserted and/or connected to the fuel cell 10 (see FIGS. 13-15). Of course, as explained above, this may require that the chambers CEC and CFC of the cartridge 20 contain more electrolyte and fuel than can normally be accommodated in the chambers EC and FC in the fuel cell 10, owing to the fact that some fuel and electrolyte will be left in the valves 6 and 22 and fluid communication passages of both the fuel cell 10 and cartridge 20.

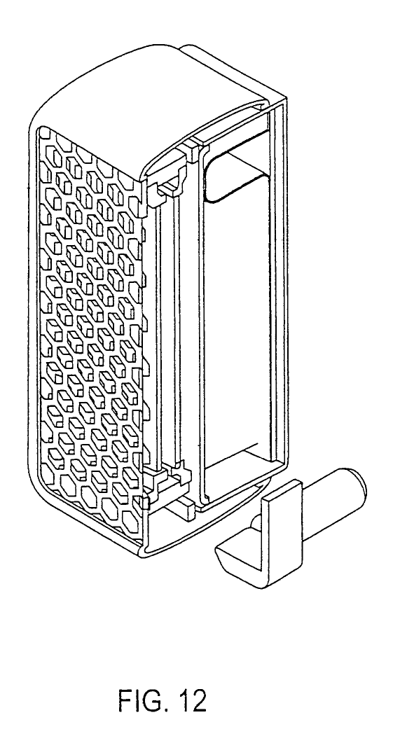

In the case of a new fuel cell 10, the electrolyte chamber EC and the variable volume fuel chamber FC continue to be empty. In other words, the volume and/or space defined by the frame 2, cathode 3 and anode 4 is essentially empty of electrolyte and the fuel chamber FC is essentially in a fully deflated position and/or defines a lower volume limit (e.g., it has essentially zero volume because the flexible material member 5 is arranged closely adjacent to the anode member 4). This pre-installation/insertion position is also characterized by the plate 21 being in a fully expanded position relative to the rear cover 25 of the cartridge 20, and by the plate 8 being in a fully expanded position and ready to in the move to a fully retracted position shown in FIG. 12.

FIGS. 10 and 12 show the fuel cell 10 and the cartridge 20 in a position after the cartridge 20 has been fully inserted into the fuel cell 10. At this point, the valve 22 of the cartridge 20 has been mated with the valve 6 of the fuel cell 10. Moreover, the plate 21 of the cartridge 20 body has forced the plate 8 and rim 7 of the fuel cell 10 to move to a fully retracted position adjacent the frame 2 and flexible member 5 from a fully expanded position shown in, e.g., FIGS. 4, 6, 7 and 9. In this position, the cartridge 20 continues to contain a substantially full and/or expanded electrolyte chamber CEC and a substantially full and/or expanded fuel chamber CFC. In the case of a new cartridge 20, these chambers CEC and CFC contain new or fresh electrolyte and fuel which is ready to be used and/or transferred to the fuel cell 10. Again, the amounts of electrolyte and fuel contained in the cartridge 20 should generally correspond to the requirements of a particular fuel cell 10. Thus, the amount of electrolyte in the chamber CEC of the cartridge 20 should be sufficient to fill the chamber EC (up to a desired point) in the fuel cell 10 when the cartridge 20 is fully inserted and/or connected to the fuel cell 10 and the electrolyte is transferred from the cartridge 20 to the fuel cell 10 (see FIGS. 13-15). Similarly, the amount of fuel in the chamber CFC of the cartridge 20 should be sufficient to fill the chamber FC (up to a desired point) in the fuel cell 10 when the cartridge 20 is fully inserted and/or connected to the fuel cell 10 and the fuel is transferred from the cartridge 20 to the fuel cell 10 (see FIGS. 13-15). Of course, as explained above, this may require that the chambers CEC and CFC of the cartridge 20 contain more electrolyte and fuel than can normally be accommodated in the chambers EC and FC in the fuel cell 10, owing to the fact that some fuel and electrolyte will be left in the valves 6 and 22 and the fluid communication passages of both the fuel cell 10 and cartridge 20 after transfer.

In the case of a new fuel cell 10, the electrolyte chamber EC and the variable volume fuel chamber FC continue to be empty in the position shown in FIGS. 10 and 12. In other words, the volume and/or space defined by the frame 2, cathode 3 and anode 4 is essentially empty of electrolyte and the fuel chamber FC is essentially in a fully deflated position and/or defines a lower volume limit (e.g., it has essentially zero volume because the flexible material member 5 is arranged closely adjacent to the anode member 4). This fully inserted and pre-fluid transfer position is also characterized by the plate 21 being in a fully expanded position relative to the rear cover 25 of the cartridge 20, and by the plate 8 and rim 7 being in a fully retracted position and ready to move to a partially expanded position shown in FIGS. 13-15.

FIGS. 13-15 show the fuel cell 10 and the cartridge 20 in a position after the cartridge 20 has been fully inserted into the fuel cell 10 and after fluids have been transferred from the cartridge 20 to the fuel cell 10. At this point, the valve 22 of the cartridge 20 has been mated with the valve 6 of the fuel cell 10 and the valves 22 and 6 are opened to allow the fluids to flow from the cartridge 20 to the fuel cell 10. Moreover, the plate 21 of the cartridge 20 body has been forced by the plate 8 of the fuel cell 10 to move to a fully retraced position adjacent the plate 24 from a fully expanded position shown in, e.g., FIGS. 10 and 12. In the position shown in FIGS. 13-15, the fuel cell 10 now contains a substantially full electrolyte chamber EC and a substantially full and/or expanded fuel chamber FC. In the case of a new cartridge 20, the chambers CEC and CFC will have transferred the new or fresh electrolyte and fuel to the fuel cell 10 and the expansion of the fuel chamber FC will have caused and/or coincided with the deflation and/or collapse of the fuel and electrolyte chambers CFC and CEC of the cartridge 20. Again, the amounts of electrolyte and fuel contained in and transferred from the cartridge 20 should generally correspond to the requirements of a particular fuel cell 10. Thus, the amount of electrolyte in the chamber EC of the fuel cell 10 should be sufficient to fill the chamber EC (up to a desired point). Similarly, the amount of fuel in the chamber FC of the fuel cell 10 should be sufficient to fill the chamber FC (up to a desired point). Of course, as explained above, this may require that the chambers CEC and CFC of the cartridge 20 contain more electrolyte and fuel than can normally be accommodated in the chambers EC and FC in the fuel cell 10, owing to the fact that some fuel and electrolyte will be left in the valves 6 and 22 and fluid communication passages of both the fuel cell 10 and cartridge 20 after transfer.

In the case of a new fuel cell 10, the electrolyte chamber EC and the variable volume fuel chamber FC have now been filled in the position shown in FIGS. 13-15. In other words, the volume and/or space defined by the frame 2, cathode 3 and anode 4 is essentially full of electrolyte and the fuel chamber FC is essentially in a partially to fully inflated position and/or defines an upper volume limit (e.g., it has essentially a maximum desired volume because the flexible material member 5 is arranged at essentially a maximum position away from the anode member 4). This post-fluid transfer position is characterized by fluids being fully transferred from the cartridge 20 to the fuel cell 10 and is also characterized by the plate 21 being in a fully retracted position relative to the rear cover 25 of the cartridge 20, and by the plate 8 being in a fully expanded position and ready to move to a fully retracted position shown in FIGS. 10 and 12. It should be noted that in the position shown in FIGS. 13-15, the front edge of wall 25b of the rear cover 25 forces the rim 7 against the frame 2 and allows the plate 8 to move within it. Moreover, the valve 22 is fully inserted within the valve 6.

The fuel cell 10 described above thus includes a flexible and/or variable volume fuel chamber FC and a rigid or fixed volume electrolyte chamber EC. When the fuel cell 10 is not initially attached and/or connected to the cartridge 20, the fuel chamber FC is at its smallest volume stage. The way in which a volumetric change occurs in the fuel chamber FC is achieved by utilizing a flexible polymer sheet member 5. The sheet member 5 functions as a collapsing compartment and is flexible with regard to its ability to accommodate lesser and greater volumetric changes. The member 5 thus has a preformed shape that relates to and follows the fuel cell electrode geometry (which can have, e.g., a rectangular or a circular geometry). The electrode polymeric frame 2 and the flexible sheet 5 form a flexible fuel chamber FC. The flexible compartment or chamber FC can thus change its volume from a minimum volumetric stage such as whenever it does not contain fuel, to its largest volumetric stage when it extends to contain and/or accommodate the fuel. When the fuel chamber FC is filled with liquid, the chamber FC will extend and/or expand to a bigger volume up to a max predetermined volume and vice versa. The electrolyte compartment or chamber EC, on the other hand, is rigid, i.e., it defines a predetermined fixed volume which does not change and/or remains the same throughout all the fuel cell operational modes.

The cartridge 20 includes a flexible material member 23 that is divided into a number of compartments and/or flexible chambers. This flexible chamber or chamber member 23 can be made of the same material as the fuel cell chamber flexible member 5. In this regard, both flexible members 5 and 23 can be made out of a thin film flexible polymer and has a thickened rim portion 5b and 23b. Accordingly to one non-limiting arrangement, the cartridge 20 includes a plurality of flexible chambers with each chamber having a specific volume. Another possibility is to utilize a single flexible chamber which can be divided into distinct compartments. Of course, the number of chambers can be tailored to specific design requirements. The basic design can also provide for a fuel chamber FC or CFC that may also be divided into two different chambers, which will incorporate the fuel and other fuel components. Another chamber will incorporate the electrolyte. Thus, the invention contemplates an arrangement of the fuel cell 10 and cartridge 20 which can have two, three or even more different compartments. Moreover, as explained above, the liquids stored in the cartridge 20 prior to transfer to the fuel cell are preferably fresh fluids.

Each of the fuel cell 10 and cartridge 20 has a valve 6 and 22. These valves 6 and 22 are configured to be mated to each other. At a pre-mated phase shown in FIGS. 4 and 6, these valves are closed. On the other hand, at full mating phase shown in FIGS. 10 and 12, these valves 6 and 22 are open. The valves 6 and 22 function to open and close one another throughout engagement and disengagement process. Under normal working conditions and whenever the fuel cell 10 and cartridge 20 are not attached to each other (see FIGS. 4 and 6), the valves 6 and 22 are closed. However, when the fuel cell 10 and cartridge 20 are mated, these valves 6 and 22 are open to allow fluid to pass from the cartridge 20 to the fuel cell 10 and vice versa.

In the position shown in FIGS. 4 and 6, the fuel cell is empty, i.e., fluids are absent from both the fuel chamber FC as well as from the electrolyte chamber EC. The fuel chamber FC is at its smallest volumetric size. The cartridge 20, on the other hand, contains the fresh liquids (i.e., the fuel and electrolyte) in chambers CFC and CEC which are at their highest volumetric size. When the cartridge 20 is moved towards the fuel cell 10 in a so-called “engagement phase” (see FIGS. 7 and 9), the valves 6 and 22 are positioned in alignment for mating. At the end of the engagement phase (see FIGS. 10 and 12), both valves 6 and 22 are mated and opened. However, at this point the volumetric state of each compartment and/or chamber EC, FC, CEC and CFC remain unchanged. The next phase which takes place is a so-called “liquid transfer” phase (see FIGS. 13-15). In this phase, liquids from the cartridge 20 are forced by mechanical action to move through the valves 6 and 22 and into the fuel cell compartments or chambers EC and FC. At the end of the liquid transfer phase, the electrolyte substantially fills the electrolyte chamber EC and the fuel substantially fills the fuel chamber FC. This phase also constitutes a so-called “operational phase” of the fuel cell since the cartridge 20 and the fuel cell 10 remain connected to each other during use of the fuel cell to produce energy. The cartridge 20 can be maintained connected to and/or incorporated into the fuel cell 10 by a mechanical connection such as a latch system or an automatic locking system (not shown). As is apparent from FIGS. 13-15, in the operational phase, the fuel flexible compartment FC extends into the volume of the cartridge 20.

One non-limiting way in which mechanical action is used to cause the fluids to transfer from the cartridge 20 to the fuel cell 10 provides for actuation by a user. In this case, the user employs force to a lever or a knob (not shown). The knob can be located between members 8 and 21. The force exerted by the knob can be applied directly and/or transferred to member 21 during the refueling stage. This causes compression or a collapsing of the flexible member 23 and the transfer of the fluids from the cartridge 20 to the fuel cell 10. Such an arrangement can also utilize one or more springs arranged within each of the fuel cell 10 and cartridge 20. The springs bias the flexible chambers in a manner which tends to cause the fluids to be placed under pressure so as to cause the fluids to exit out of the fuel cell 10 and cartridge 20 when the springs are set free. This can occur, for example, automatically when the valves 6 and 22 are opened. In the cartridge 20, for example, the biasing force is exerted on the flexible member 23 directly or through a part, e.g., plate 21, of the cartridge that comes in direct or in an indirect contact with the member 23 in the fluid transfer phase. This biasing forces the fluids to flow out of the cartridge 20.

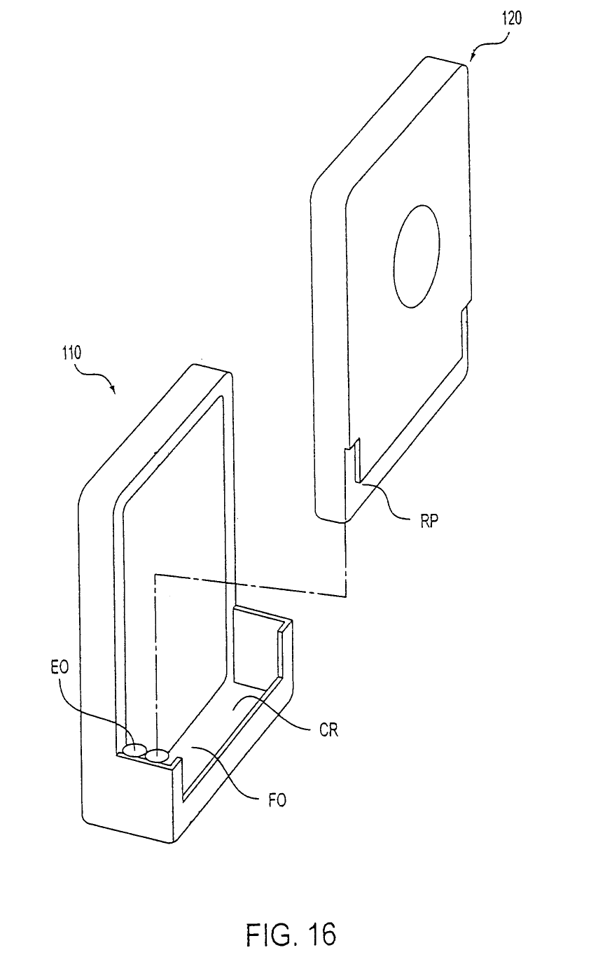

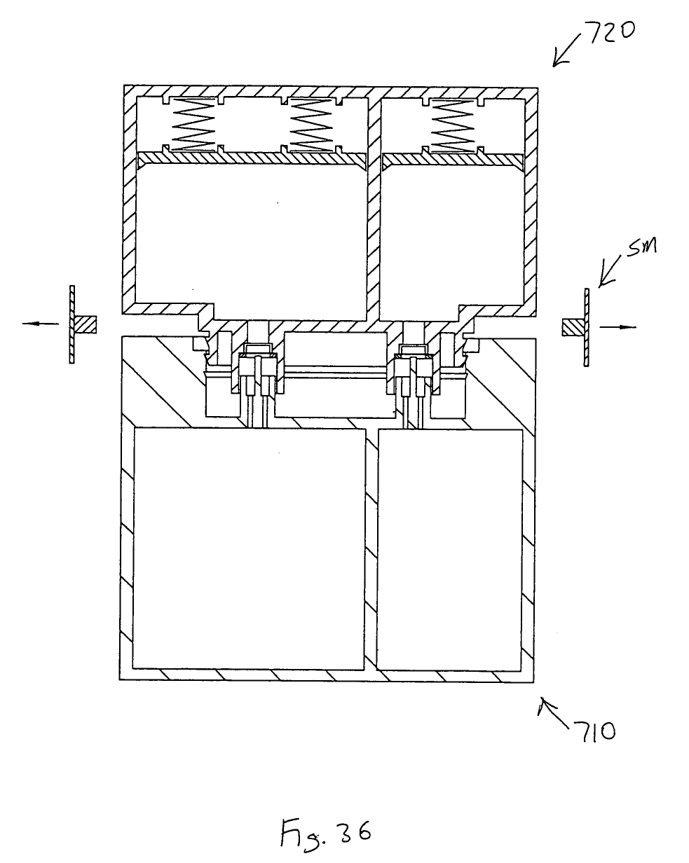

FIG. 16 shows another non-limiting embodiment of a fuel cell 110 and cartridge 120 arrangement. This embodiment uses a cartridge 120 which slides into connection with the fuel cell 110 from a vertical position. The fuel cell 110 includes a projecting lower cradle portion with fluid openings that communicate with the internal chambers of the fuel cell 110. Fuel opening FO communicates with the fuel chamber FC (not shown) and an electrolyte opening EO communicated with electrolyte chamber EC (not shown). These openings are configured to sealing align with and engage with corresponding openings of the cartridge 120 (not shown). The cartridge 120 also includes a lower recessed portion RP which is sized and shaped to slide within and to mate with a cradle recess CR of the fuel cell 110. As with the previously described embodiment, the fuel and electrolyte supply chambers of the cartridge 120 are separated from each other and constitute variable volume chambers similar to those of the embodiment shown in FIGS. 1-15. Similarly, the fuel and electrolyte chambers of the fuel cell 110 are separated from each other and constitute defined volume and variable volume chambers similar to those of the fuel cell of the embodiment shown in FIGS. 1-15. The cartridge 120 and fuel cell 110 also utilize internal valves (not shown) which open when the cartridge 120 is fully mated with the fuel cell 110. This embodiment preferably includes a system (such as a system of projections and recesses of the type shown in, e.g., FIG. 32) for non-releasably locking the cartridge 120 to the fuel cell 110 so as to form a disposable fuel cell system.

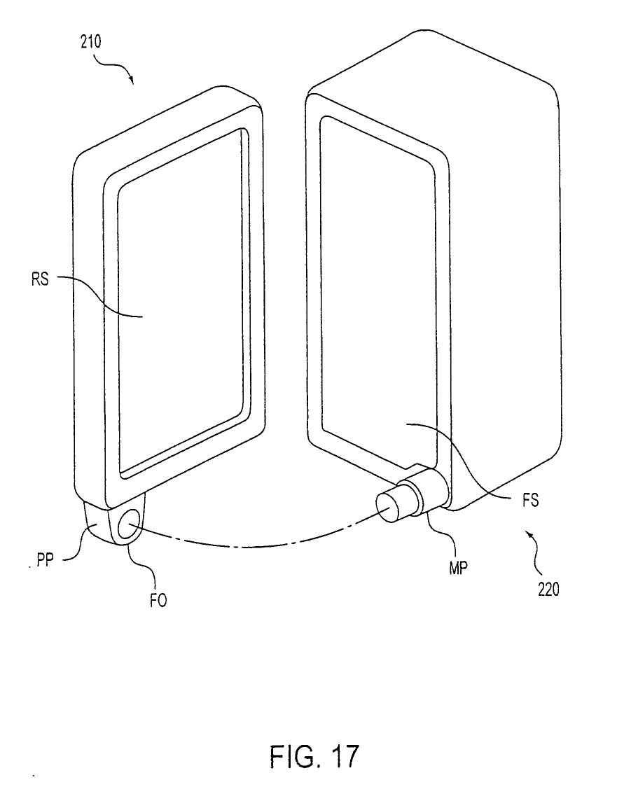

FIG. 17 shows another non-limiting embodiment of a fuel cell 210 and cartridge 220 arrangement. This embodiment uses a cartridge 220 which slides horizontally onto the fuel cell 210 to connect therewith. The fuel cell 210 includes a lower projecting portion PP with a fluid opening that communicate with the internal chambers of the fuel cell 210. Fluid opening FO communicates with the fuel chamber FC (not shown) and with electrolyte chamber EC (not shown). This opening FO is configured to sealing receive and mate with a mating portion MP of the cartridge 220. The cartridge 220 also includes a front surface FS which abuts against a rear surface RS of the fuel cell 210. As with the previously described embodiment, the fuel and electrolyte supply chambers of the cartridge 220 are separated from each other and constitute variable volume chambers similar to those of the embodiment shown in FIGS. 1-15. Similarly, the fuel and electrolyte chambers of the fuel cell 210 are separated from each other and constitute defined volume and variable volume chambers similar to those of the fuel cell of the embodiment shown in FIGS. 1-15. The cartridge 220 and fuel cell 210 also utilize internal valves (one arranged within portion MP and another arranged within portion PP) which open when the cartridge 220 is fully mated with the fuel cell 210. This embodiment also preferably includes a system (such as a system of projections and recesses of the type shown in, e.g., FIG. 32) for non-releasably locking the cartridge 220 to the fuel cell 210 so as to form a disposable fuel cell system.

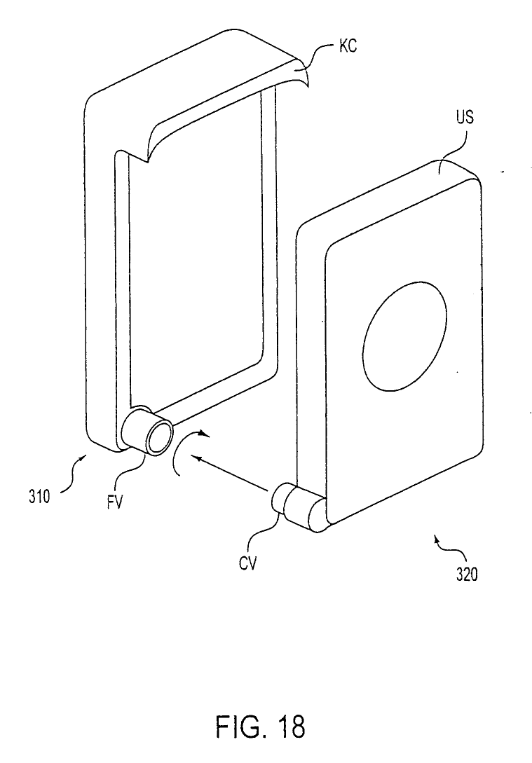

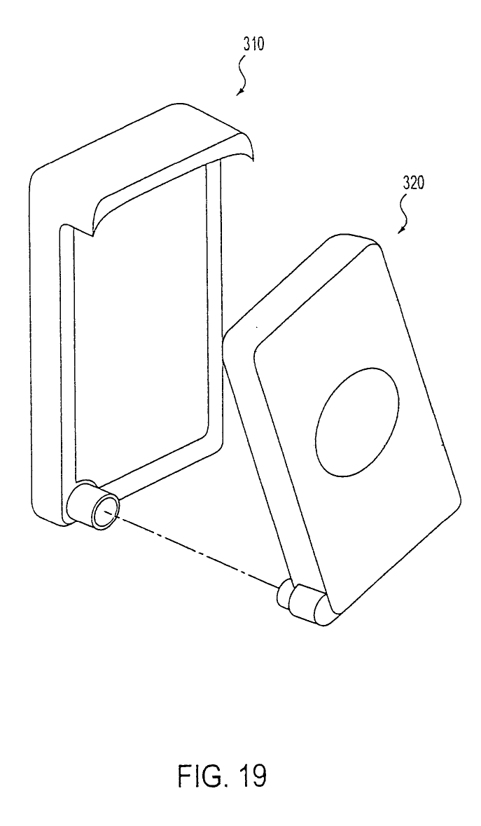

FIGS. 18 and 19 show another non-limiting embodiment of a fuel cell 310 and cartridge 320 arrangement. This embodiment uses a cartridge 320 which slides onto the fuel cell 310 from a horizontal angled position (see FIG. 19) and thereafter rotates to a vertical position. The fuel cell 310 includes a projecting upper cradle portion RC and a fluid valve FV with fluid openings that communicate with the internal chambers of the fuel cell 310. Fuel valve FV communicates with the fuel chamber FC (not shown) and with electrolyte chamber EC (not shown). The valve FV is configured to sealing align with and receive the valve CV of the cartridge 320. The valve CV of the cartridge 320 is sized and shaped to slide within and to mate with the valve FV of the fuel cell 110. Once the cartridge 320 is connected to the fuel cell 310 (which also results in a full connection of the valves FV and CV), the cartridge 320 is rotated until an upper end of the cartridge 320 slides into and otherwise sits within the cradle RC. As with the previously described embodiment, the fuel and electrolyte supply chambers of the cartridge 320 are separated from each other and constitute variable volume chambers similar to those of the embodiment shown in FIGS. 1-15. Similarly, the fuel and electrolyte chambers of the fuel cell 310 are separated from each other and constitute defined volume and variable volume chambers similar to those of the fuel cell of the embodiment shown in FIGS. 1-15. The cartridge 320 and fuel cell 310 may also utilize internal valves (not shown) in place of the external valves FV and CV which open when the cartridge 320 is fully mated with the fuel cell 310. This embodiment preferably includes a system (such as a non-releasable latch mechanism) for non-releasably locking the cartridge 320 to the fuel cell 310 so as to form a disposable fuel cell system.

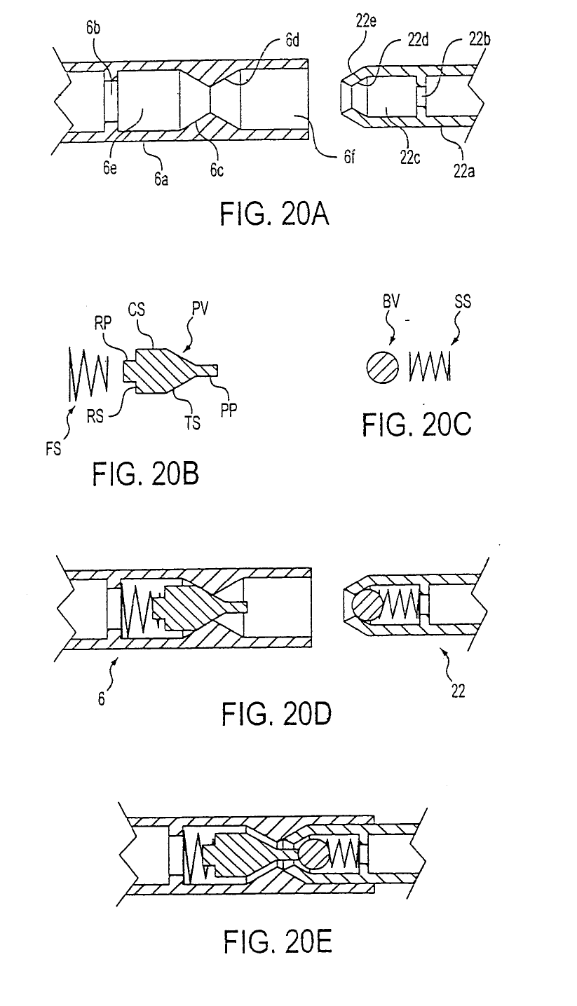

By way of one non-limiting example, the cartridge valve 22 and fuel cell valve 6 may have the arrangement shown in FIGS. 20a-20e. FIG. 20d shows the fuel cell valve 6 and cartridge valve 22 in a state prior to being connected to each other. In this state, the plunger valve PV prevents fluid and/or other substances from entering (as well as exiting) the fuel cell 10 by virtue of its tapered surface TS being in sealing contact and/or engagement with correspondingly tapered surface 6c of the valve sleeve 6a. A partially compressed first spring FS acts to bias the plunger valve PV so that sealing contact is maintained between surfaces TS and 6c. The first spring FS is a tapered spring whose larger diameter end is configured to abut against an internal cylindrical shoulder 6b of the sleeve 6a. The smaller diameter portion of the first spring FS is sized to receive therein a rear projection RP of the plunger valve PV and to abut against a rear shoulder RS. The sleeve 6a is generally cylindrical in shape and includes a front cylindrical opening 6f which is sized to receive therein a front cylindrical portion 22a of the cartridge valve 22. In order to ensure that the valve 22 is sealed with respect to the valve 6, the valve 22 includes a tapered surface 22e whose taper corresponds to the tapered surface 6d of the valve 6 (see FIG. 20e). The plunger valve PV and first spring FS are both arranged within cylindrical section 6e and can move axially within this opening (compare FIGS. 20d and 20e).

In a similar arrangement, a ball valve BV prevents fluid from exiting the cartridge 20 by virtue of its spherical surface being in sealing contact and/or engagement with tapered surface 22d of the valve sleeve 22a. A partially compressed second spring SS acts to bias the ball valve BV so that sealing contact is maintained between the spherical surface of the ball valve BV and tapered surface 22d. The second spring SS is a cylindrical wire spring whose rear end is configured to abut against an internal cylindrical shoulder 22b of the sleeve 22a. The front end of the second spring SS is sized to receive therein a portion of the spherical surface of the ball valve BV (see FIG. 20d). The sleeve 22a is generally cylindrical in shape and includes a front cylindrical opening 22c which is sized to receive therein the ball valve BV and second spring SS. As noted above, the valve 22 can be sealed with respect to the valve 6 when the tapered surface 22e engages the tapered surface 6d of the valve 6 (see FIG. 20e). The ball valve BV and second spring SS are arranged within cylindrical section 22c and can move axially within this opening (compare FIGS. 20d and 20e).

In the position shown in FIG. 20d. the valves 6 and 22 are closed and not connected to each other. However, in FIG. 20e, the valve 22 has been inserted fully into the valve 6 and both valves 6 and 22 are in an open state to allow fluid communication between the cartridge 20 and the fuel cell 10. In this opened position, it can be seen that the small diameter projecting portion PP has forced the ball valve BV to move axially away from sealing engagement with tapered surface 22d. This has occurred by causing the second spring SS to compress even more. Similarly, it can be seen that the biasing forces of the springs FS and SS are such that the second spring SS also forces the plunger valve PV, and specifically surface TS, to move axially away from sealing engagement with tapered surface 6c. This has occurred by causing the first spring FS to compress even more. Although not shown, each valve 6 and 22 may also include therein a sleeve or shoulder which allows the plunger valve PV and/or ball valve BV to move away from sealing engagement only a limited amount, thereby ensuring both valves PV and BV are unseated and placed in the opened position reliably and/or essentially simultaneously.

Because the front of the valve 6 is slotted, i.e., with slots 6g, a plurality of spring fingers are formed which deflect outwards when the valve 22 is inserted into the valve 6 (see FIG. 20e). This deflection occurs because the projections 6h engage with the cylindrical surface 22a during insertion. When the valve 22 reaches the position shown in FIG. 20e, the projections 6h drop into a circumferential recess 22f. At this point, the valve 22 is fully inserted into and non-removably connected to the valve 6. As is evident from these figures, the valves function to seal the fuel cell 10 and cartridge 20 when they are not connected (see FIG. 20d). Of course, the valve arrangement shown in FIGS. 20a-20e are but one possible example or embodiments of the valves 6 and 22. The invention contemplates other valve arrangements which allow for the one-time connection and opening of the valves and for the closing of the valves. The various parts of the valves 6 and 22 can be made of any desired material whether conventional or otherwise such as metal, plastic, and/or composites. Additionally, the invention may also utilize valves similar to those used in copending application P25032 (attorney docket number) filed on Mar. 10, 2004 and based upon Provisional Application No. 60/453,218 filed on Mar. 11, 2003, the disclosures of which are hereby expressly incorporated by reference herein in their entireties.

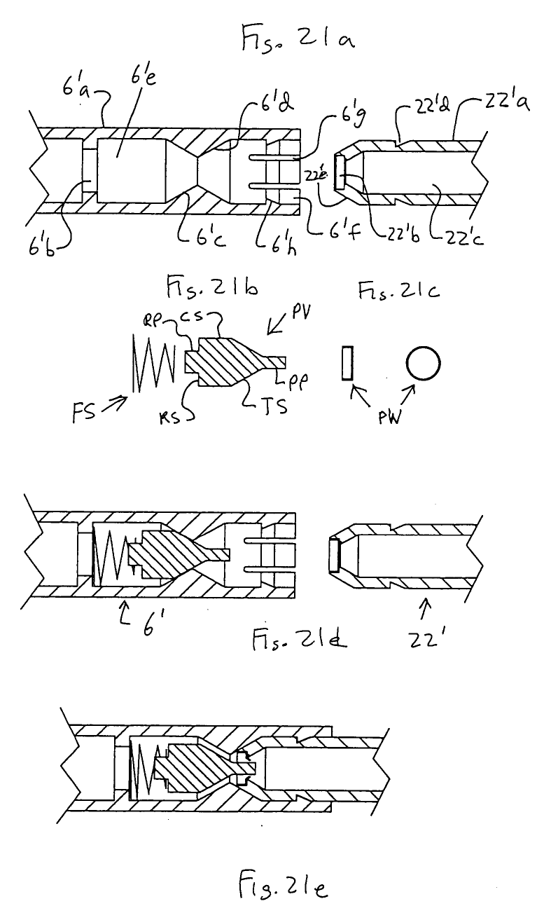

By way of another non-limiting example, the cartridge valve 22 and fuel cell valve 6 may instead have the arrangement shown in FIGS. 21a-21e. FIG. 21d shows the fuel cell valve 6′ and cartridge valve 22′ in a state prior to being connected to each other. In this state, the plunger valve PV prevents fluid from entering (as well as exiting) the fuel cell 10 by virtue of its tapered surface TS being in sealing contact and/or engagement with correspondingly tapered surface 6′c of the valve sleeve 6′a. A partially compressed first spring FS acts to bias the plunger valve PV so that sealing contact is maintained between surfaces TS and 6′c. The first spring FS is a tapered spring whose larger diameter end is configured to abut against an internal cylindrical shoulder 6′b of the sleeve 6′a. The smaller diameter portion of the first spring FS is sized to receive therein a rear projection RP of the plunger valve PV and to abut against a rear shoulder RS. The sleeve 6′a is generally cylindrical in shape and includes a front cylindrical opening 6′f which is sized to receive therein a front cylindrical portion 22′a of the cartridge valve 22′. In order to ensure that the valve 22′ is sealed with respect to the valve 6′, the valve 22′ includes a tapered surface 22′e whose taper corresponds to the tapered surface 6′d of the valve 6 (see FIG. 20e). The plunger valve PV and first spring FS are both arranged within cylindrical section 6′e and can move axially within this opening (compare FIGS. 20d and 20e).

Unlike the arrangement shown in FIGS. 20a-e, the cartridge valve 22′ in this arrangement does not utilize a one-way valve. Instead, a pierceable washer PW is used to prevent fluid from exiting the cartridge 20. The pierceable washer PW can be made of thin materials such as, e.g., plastic or aluminum, and may be press fit (or attached in other ways such as by adhesives) into a cylindrical recess 22′b formed in a front portion of the valve 22′. This can occur after the cartridge 20 is initially filled. As can be seen in FIG. 21e, the pierceable washer PW is designed to be pierced by the projecting portion pp of the plunger valve PV. To ensure that this occurs reliably, the projecting portion may have a sharpened tip (not shown). As can be seen in FIG. 21c, the pierceable washer is circular and has the form of cap. The sleeve 22′a is generally cylindrical in shape and includes a front cylindrical opening 22′c which allows the fluid to pass into the valve 6′ of the fuel cell 10. As noted above, the valve 22′ can be sealed with respect to the valve 6′ when the tapered surface 22′e engages the tapered surface 6′d of the valve 6′ (see FIG. 21e).

In the position shown in FIG. 21d. the valves 6′ and 22′ are closed and not connected from each other. However, in FIG. 21e, the valve 22′ has been inserted fully into the valve 6′ and both valves 6 and 22 are in an open state to allow fluid communication between the cartridge 20 and fuel cell 10. In this opened position, it can be seen that the small diameter projecting portion PP has pierced the pierceable washer PW. This has occurred because the biasing force of the first spring FS is string enough to causing piercing of the washer PW. On the other hand, the pressure flow from the cartridge 20 to the fuel cell 10 is sufficient to overcome the biasing force of the first spring FS, such that the pressure forces the plunger valve PV, and specifically surface TS, to move axially away from sealing engagement with tapered surface 6′c. This has occurred by causing the first spring FS to compress. Once the pressure in the cartridge 20 is reduced below the biasing force (which occurs after the fluid is transferred from the cartridge 20 to the fuel cell), the valve 6′ will close off. That is, the plunger valve PV, and specifically surface TS, will move axially towards sealing engagement with tapered surface 6′c. Although not shown, the valve 6′ may also include therein a sleeve or shoulder which allows the plunger valve PV to move away from sealing engagement only a limited amount, thereby ensuring the valve PV is unseated and placed in the opened more position reliably.

Because the front of the valve 6′ is slotted, i.e., with slots 6′g, a plurality of spring fingers are formed which deflect outwards when the valve 22′ is inserted into the valve 6′ (see FIG. 21e). This deflection occurs because the projections 6′h engage with the cylindrical surface 22′a during insertion. When the valve 22′ reaches the position shown in FIG. 21e, the projections 6′h drop into a circumferential recess 22′d. At this point, the valve 22′ is fully inserted into and non-removably connected to the valve 6′. As is evident from these figures, the valves 6′ and 22′ function to seal the fuel cell 10 and cartridge 20 when they are not connected (see FIG. 21d). Of course, the valve arrangement shown in FIGS. 21a-21e are but one possible example or embodiment of the valves which may be used on the fuel cell 10 and cartridge 20 disclosed herein. The invention contemplates other valve arrangements which allow for the one-time connection and opening of the valves and for the closing of the valves. The various parts of the valves 6′ and 22′ can be made of any desired material whether conventional or otherwise such as metal, plastic, and/or composites.

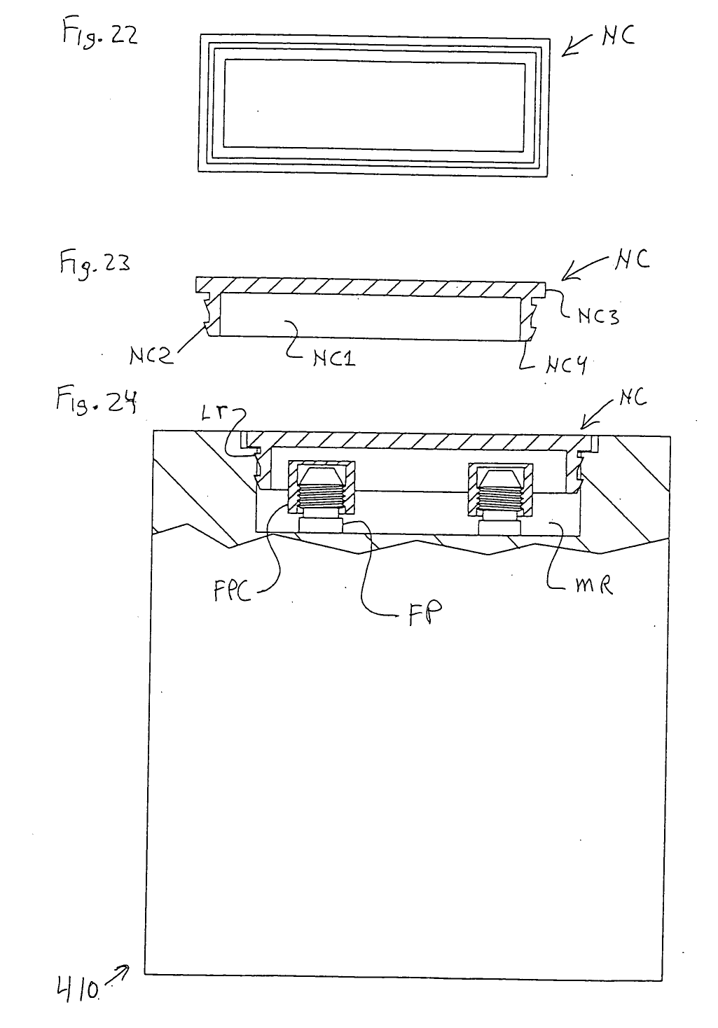

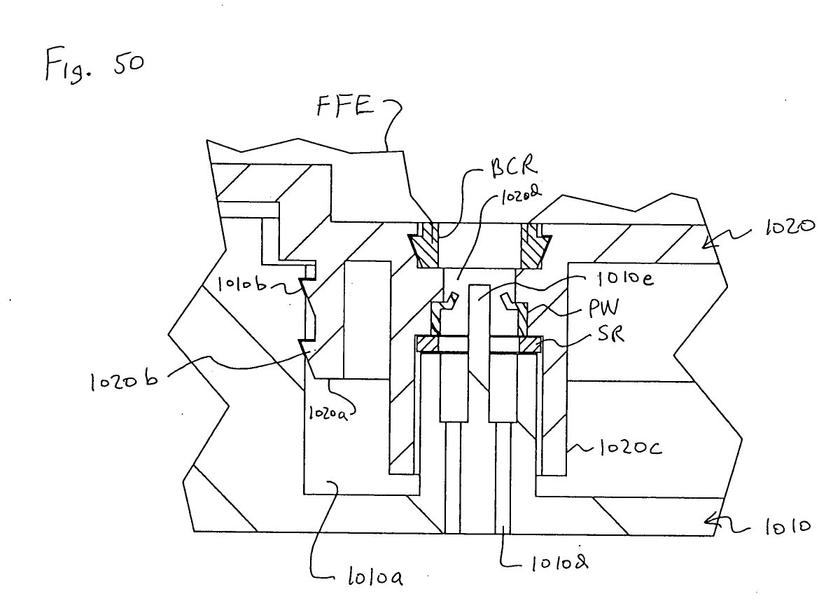

FIGS. 22-24 schematically illustrate another non-limiting embodiment of a portable stand-alone single-use disposable fuel cell 410. This embodiment is designed so that it can be purchased or procured with the fuel component(s) being added at the time of purchase. The seller facility may have a filling station (not shown) which can be used at the time the user purchases the fuel cell 410. Such filling stations can be located at, e.g., electronic stores, such as Radio Shack®. The filling station will have a large supply of fuel components, as well as a system for filling the fuel cells 410 quickly. Once filled, the user uses the fuel cell 410 until it is exhausted. Then, the user simply discards and/or recycles the fuel cell 410. The design of the fuel cell 410 is such that it cannot be refilled and/or its contents cannot be easily removed without destroying the fuel cell 410. This occurs with the use of a non-removable cover NC which is designed to be inserted into the fuel cell 410 immediately after it is filled (in the same as the embodiment shown in FIG. 40). By doing so, the user will not be able to refill and/or reuse the fuel cell 410 without destroying it in the attempt to do so. The fuel cell 410 can be filled by connecting one of more of its valves or filling ports FP (which can be similar to valves shown in FIG. 40) to the filling station. The fuel ports FP can be integrally formed with fuel cell body by, e.g., injection molding the body in two parts, or separately formed there from and then attached thereto by, e.g., adhesives or a threaded connection (similar to the threaded connection shown in FIG. 46). In performing the filling process, one simply removes the fuel port covers FPC by, e.g., unthreading them from the ports FP. Then, the fuel cell 410 is filled. Once filled, the covers FPC are threaded onto the ports FP to ensure that the fluids do not leak out of the fuel cell FC. Finally, the rectangular-shaped non-removably cover NC is installed to prevent reuse and refilling of the fuel cell 410. The protective cover NC may be made of a plastic such as, e.g., ABS plastic or ABS 5-20%, and utilizes projections NC2 which engage corresponding recesses Ir (similar to the recesses shown in FIG. 40) in the main recess MR of the fuel cell 410. The design of the projections NC2 and recesses Ir are such that the protective cover NC cannot be removed from the fuel cell 410 without destroying the fuel cell 410. Of course, the cover NC can also be non-removably secured to the fuel cell 410 in other ways such as by, e.g., adhesives and/or ultrasonic welding.

The fuel cell 410 is generally rectangular in shape and may be made of a plastic material such as, e.g., ABS plastic or ABS 5-20%. Of course, the fuel cell 410 can have any other desired shape including, but not limited to any other polygonal or any other linear and/or curvilinear shape. Although not shown, the fuel cell 410, like the fuel cell 10 in FIGS. 1-15, includes one or more cathodes, one or more anodes, and defines an electrolyte chamber and a fuel chamber. The fuel cell FC also includes all of the features otherwise required to produce power.

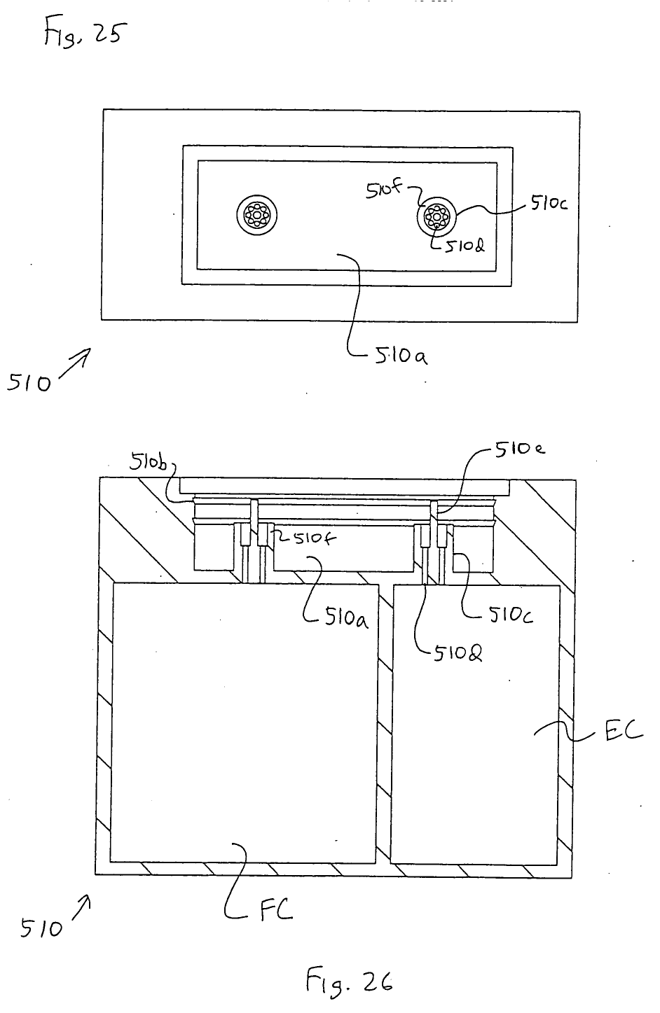

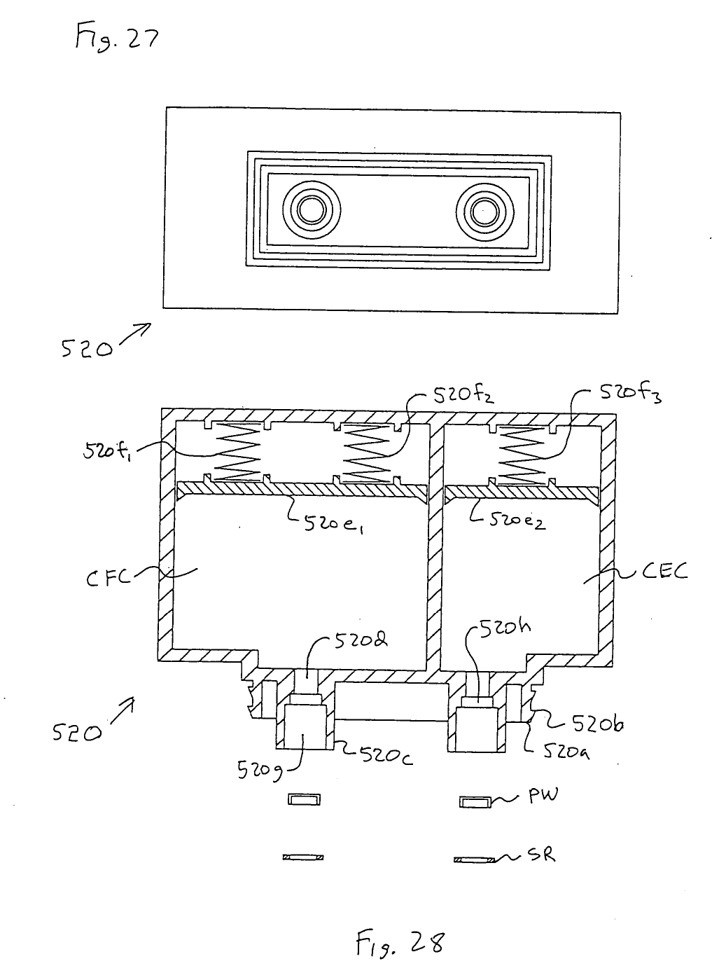

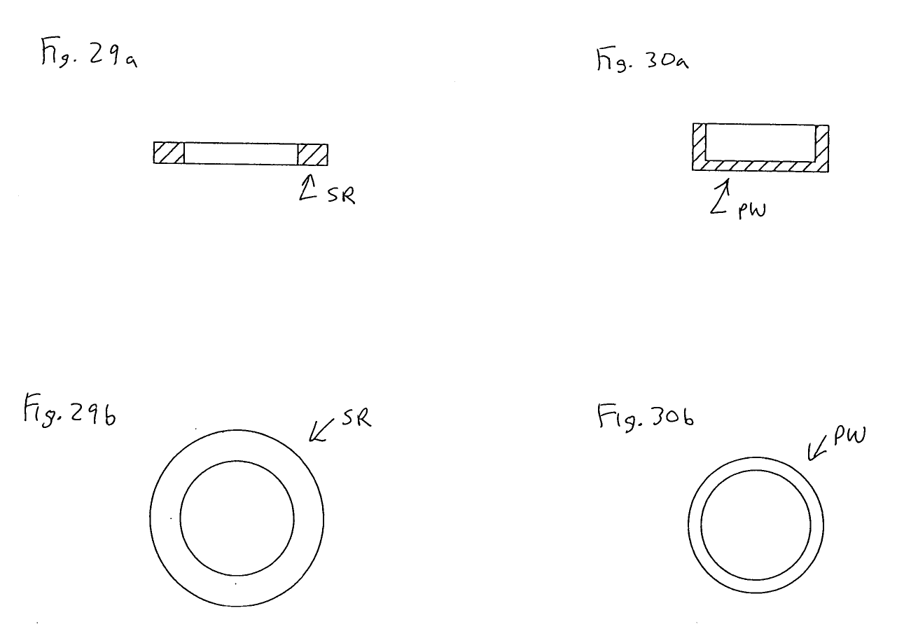

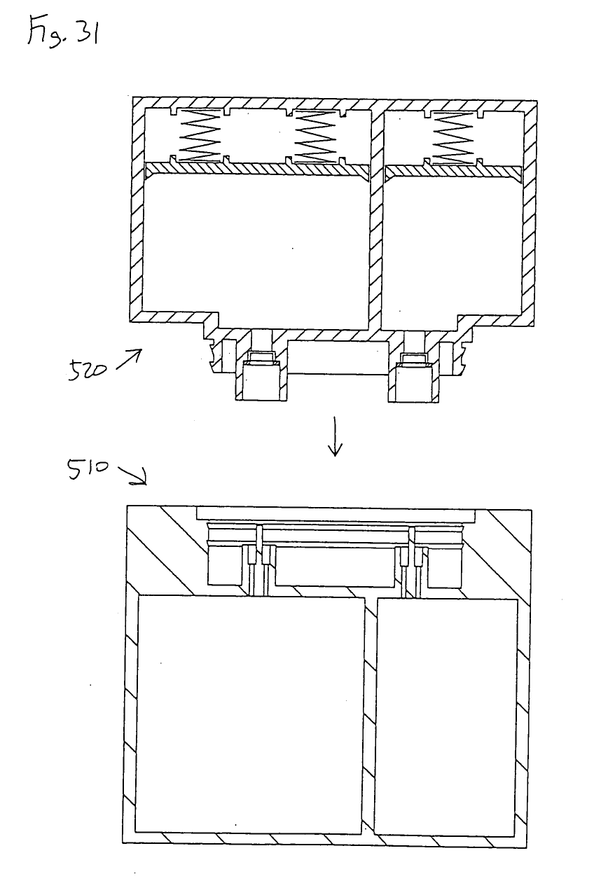

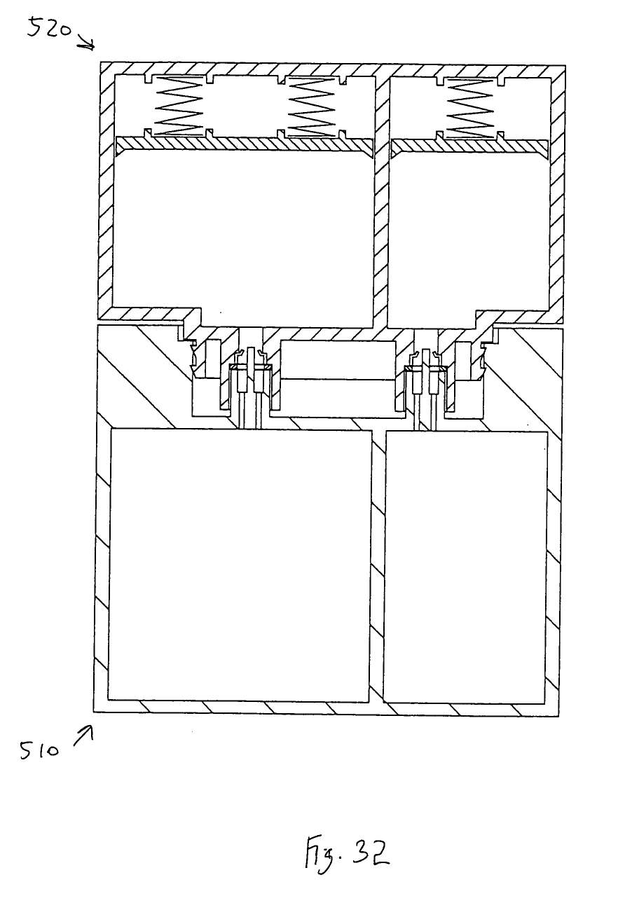

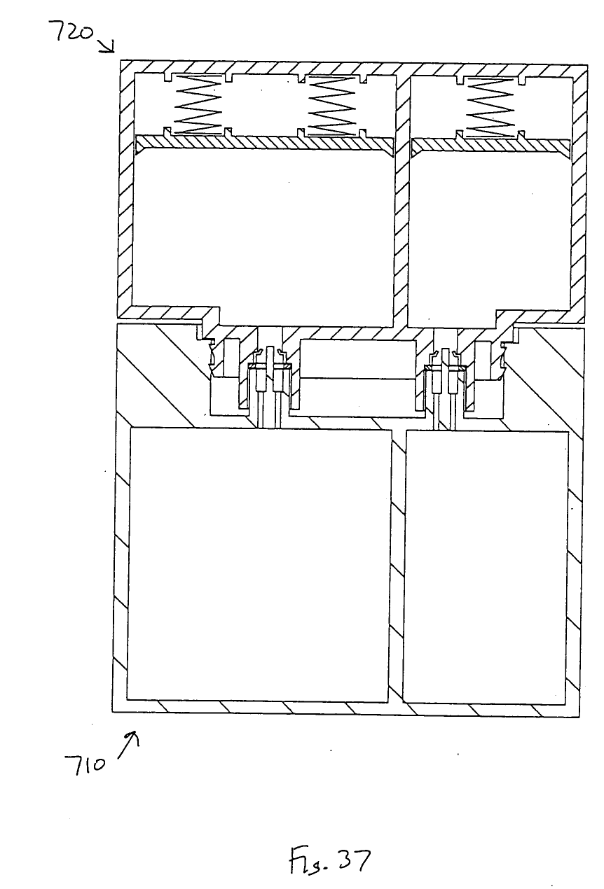

FIGS. 25-33 schematically illustrate another non-limiting embodiment of a portable stand-alone single-use disposable fuel cell 510 and cartridge 520 system. By way of non-limiting example, the fuel cell 510 includes two chambers FC and EC which are separated from each other and the cartridge 520 includes two chambers CEC and CFC which separated from each other. This embodiment is designed so that the fuel cell 510 and a cartridge 520 can be purchased or procured together as a dis-assembled and/or unconnected unit with the fresh fuel component(s) or fluids being contained only in the cartridge 520. The user then non-removably connects the cartridge 520 to the fuel cell 510 when the user desires to use the fuel cell 510. This embodiment has the advantage that the user can store the unit for relatively long periods of time and then fill and use the fuel cell 510 at a desirable point in time. Once filled, the user uses the fuel cell 510 with the connected cartridge 520 until it is exhausted, i.e. it stops generating the desired level of power. Then, the user simply discards and/or recycles the fuel cell 510/cartridge 520 as a unit. The design of the fuel cell 510/cartridge 520 is such that it cannot be refilled and/or its contents cannot be easily removed from the fuel cell 510 without destroying the fuel cell 510 and cartridge 520. This arrangement is ensured when the user fully connects the cartridge 520 to the fuel cell 510 (see FIGS. 31-33) because the cartridge 520 becomes non-removably connected to the fuel cell 510 when fully connected. As will be described herein, this connection also automatically triggers the transfer of fluids between the cartridge 520 and the fuel cell 510. By ensuring that, once fully connected, the cartridge 520 is essentially permanently connected to the fuel cell 510, the user will not be able to refill and/or reuse the fuel cell 510 without destroying it in the attempt to do so. The fuel cell 510 is thus usable only once and must then be discarded or recycled.

The two ports 510c (one for the fuel chamber FC and one for the electrolyte chamber EC) are arranged within a main recess 510a of the fuel cell 510. These ports 510c can be integrally formed with fuel cell body by, e.g., injection molding the body in two parts. Alternatively, the ports 510c can be separately formed there from and then attached thereto by, e.g., adhesives or a threaded connection (similar to the threaded connection shown in FIG. 46). The ports 510c include a plurality of openings 510d arranged allow fluids to enter into the fuel chamber FC and the electrolyte chamber EC. The ports 510c also include a cylindrical portion whose annular free end is configured to sealing engage with a sealing ring SR arranged within a cylindrical opening 520g of the cartridge ports 520c. The sealing ring SR may have any desired shape and may be made of a material such as, e.g., Viton. The two ports 520c (one for the fuel chamber CFC and one for the electrolyte chamber CEC) project from a bottom wall of the cartridge 520. The ports 520c and connecting portion 520a (as can be the case with ports 510c and recess 510a) can be integrally formed with the cartridge body by, e.g., injection molding the body in two parts. Alternatively, the ports 520c can be separately formed there from and then attached thereto by, e.g., adhesives or a threaded connection (similar to the threaded connection shown in FIG. 46). The ports 520c each include a main opening 520d arranged allow fluids to enter into the fuel chamber CFC and the electrolyte chamber CEC during initial filling and thereafter allow the fluids to exit and enter into the fuel cell 510 once the piercing washers PW are pierced. By way of non-limiting example, the chambers CFC and CEC can be initially filled with the fluids (e.g., fuel and electrolyte) entering under a fluid pressure which is capable of compressing the springs 520f. Then, the openings 520h are sealed with the piercing washers PW. The ports 520c include a cylindrical portion whose annular free end is configured to receive therein a sealing ring SR and a respective fuel cell port 510c. The ports 520c also include a cylindrical portion 520h which is configured to receive therein a piercing washer PW. The piercing washer PW can be secured to the opening 520h in any desired way as long as it is securely and sealingly connected to the cartridge 520 and as long as it can be pierced by the projecting portions 510e. This can occur by, e.g., a press fit connection or by using an adhesive connection.

In performing the filling process, one simply aligns the cartridge 520 with the fuel cell 510 (see FIG. 31). Then, the user moves the cartridge 520 into full engagement and/or connection with the fuel cell 510 (see FIG. 32). This causes the piercing plungers 510e of the fuel cell 510 to pierce the piercing washers PW, which in turn automatically triggers the fluid transfer from the cartridge 520 to the fuel cell 510 under the biasing or expansion action of the piston springs 520f1, 520f2, 520f3, and the cartridge pistons 520e1 and 520e2. Then, the fuel cell 510 is filled. Once filled, the piston springs 520f1, 520f2, 520f3, and the cartridge pistons 520e1 and 520e2 ensure that the fluids in the fuel cell 510 cannot flow back into the cartridge 520. Moreover, because the cartridge 520 is non-removably connected to the fuel cell 510, the user will not be able to reuse and refill of the fuel cell 510. To provide this non-removable connection, the cartridge 520 utilizes projections 520b which engage corresponding recesses 510b (similar to the recesses shown in FIG. 40) in the fuel cell 510. The design of the projections 520b and recesses 510b are such that the cartridge 520 cannot be removed from the fuel cell 510 without destroying the fuel cell 510. Of course, the cartridge 520 can also be non-removably secured to the fuel cell 510 in other ways such as by utilizing, e.g., pressure sensitive adhesives or by utilizing projections on the fuel cell 510 and recesses on the cartridge 520.

The fuel cell 510 and cartridge 520 may each be generally rectangular in shape and may be made of a plastic material such as, e.g., ABS plastic or ABS 5-20%. Of course, the fuel cell 510 and cartridge 520 can have any other desired shape including, but not limited to any other polygonal or any other linear and/or curvilinear shape. Although not shown, the fuel cell 510, like the fuel cell 10 in FIGS. 1-15, includes one or more cathodes, one or more anodes, and defines an electrolyte chamber and a fuel chamber. The fuel cell 510 also includes all of the features otherwise required to produce power. The cartridge 520 is not limited to any particular spring 520f and piston 520e arrangement and/or configuration. The important aspect of this embodiment is that the cartridge 520 have the ability of transferring its contents to the fuel cell 510 automatically once the cartridge is fully, sealingly and non-removably connected to the fuel cell 510. The arrangement shown in FIGS. 25-33 can also be modified so that the chambers CEC and CFC utilize flexible material enclosures, e.g., flexible polymer bags, which are in fluid communication with the openings 520d and which can be compressed by the springs 520f to cause their contents to be expelled out of the cartridge 520 and into the fuel cell 510 (i.e., similar to the arrangement shown in FIG. 49).

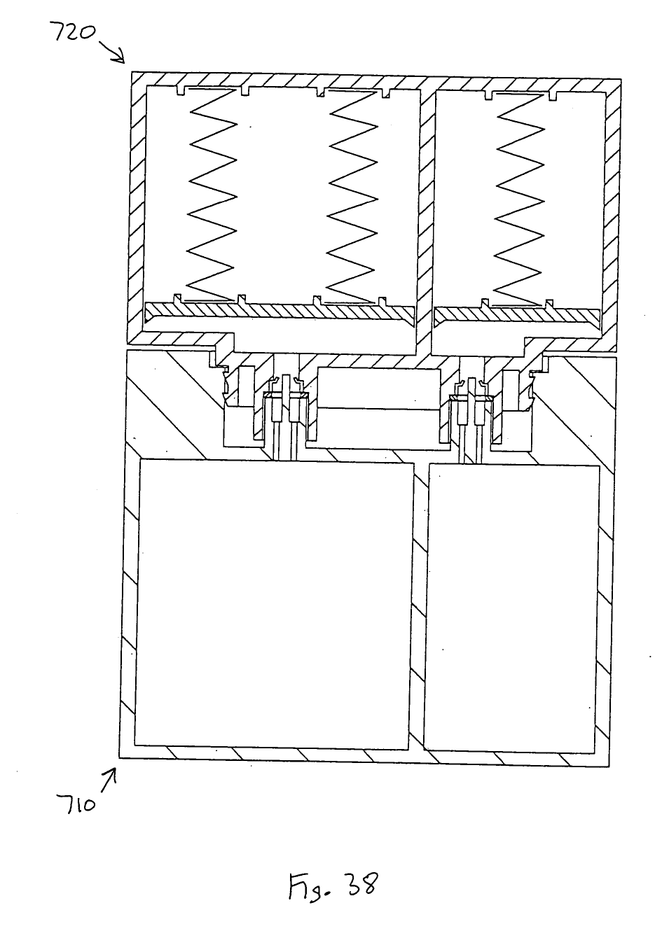

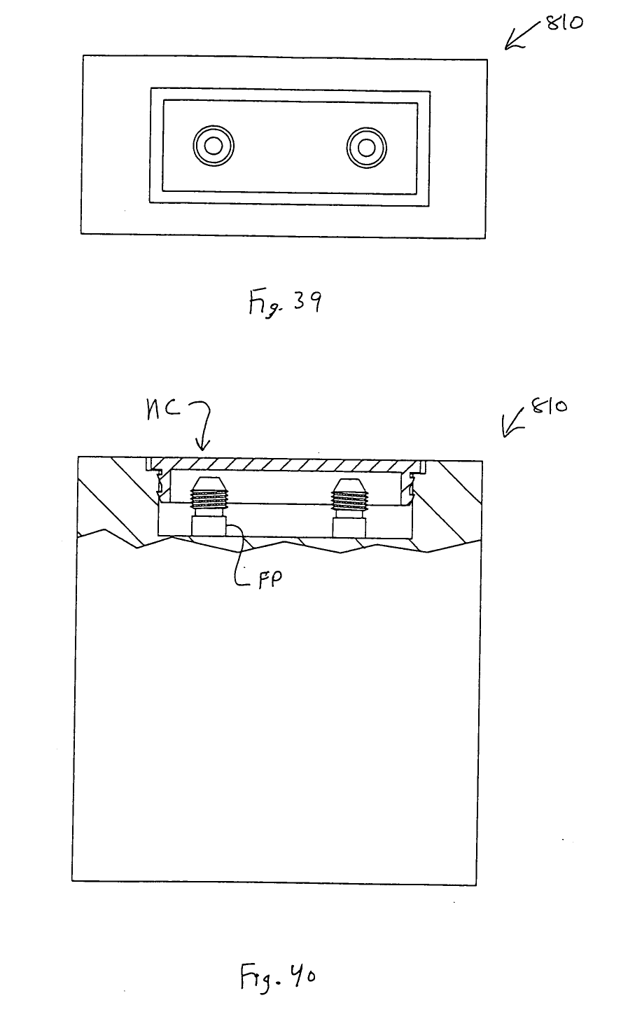

FIG. 34 schematically illustrate another non-limiting embodiment of a portable stand-alone single-use disposable fuel cell 610 and cartridge 620 system. This embodiment is designed so that the fuel cell 610 and a cartridge 620 can be purchased or procured together as a dis-assembled and/or unconnected unit with the fresh fuel component(s) or fluids being contained only in the cartridge 620. The user then non-removably connects the cartridge 620 to the fuel cell 610 when the user desires to use the fuel cell 610. This embodiment has the advantage that the user can store the unit for relatively long periods of time and then fill and use the fuel cell 610 at a desirable point in time. Once filled, the user uses the fuel cell 610 with the connected cartridge 620 until it is exhausted, i.e. it stops generating the desired level of power. Then, the user simply discards and/or recycles the fuel cell 610/cartridge 620 as a unit. The design of the fuel cell 610/cartridge 620 is such that it cannot be refilled and/or its contents cannot be easily removed from the fuel cell 610 without destroying the fuel cell 610 and cartridge 620. This arrangement is ensured when the user fully connects the cartridge 620 to the fuel cell 610 because the cartridge 620 becomes non-removably connected to the fuel cell 610 when fully connected. This connection also automatically triggers the transfer of fluids between the cartridge 620 and the fuel cell 610. By ensuring that, once fully connected, the cartridge 620 is essentially permanently connected to the fuel cell 610, the user will not be able to refill and/or reuse the fuel cell 610 without destroying it in the attempt to do so. The fuel cell 610 is thus usable only once and must then be discarded or recycled.

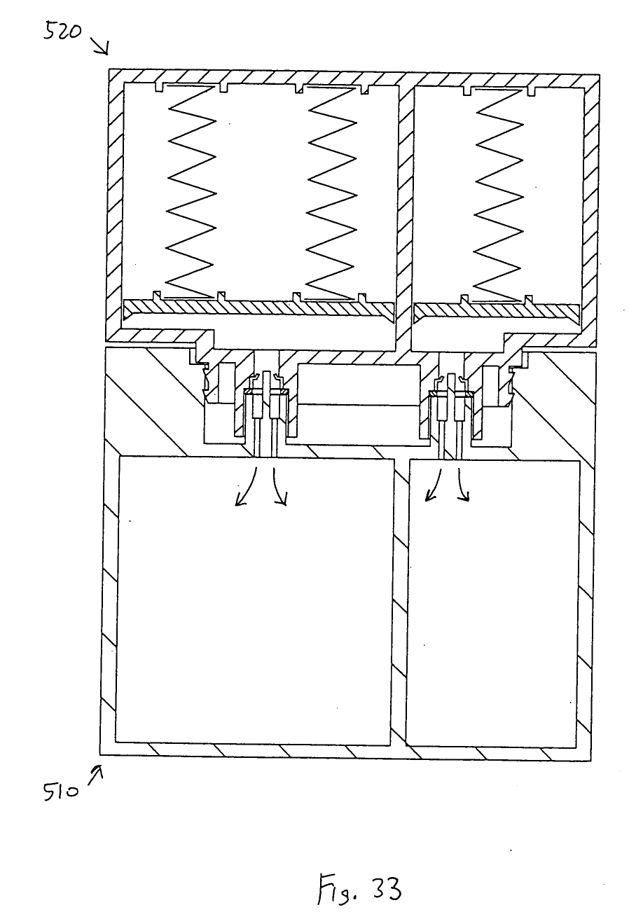

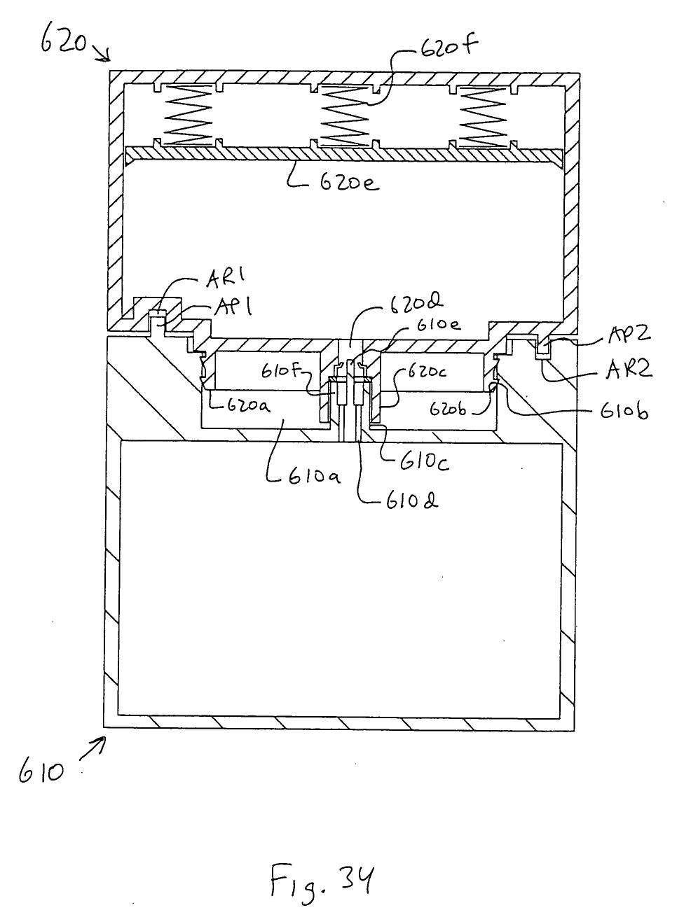

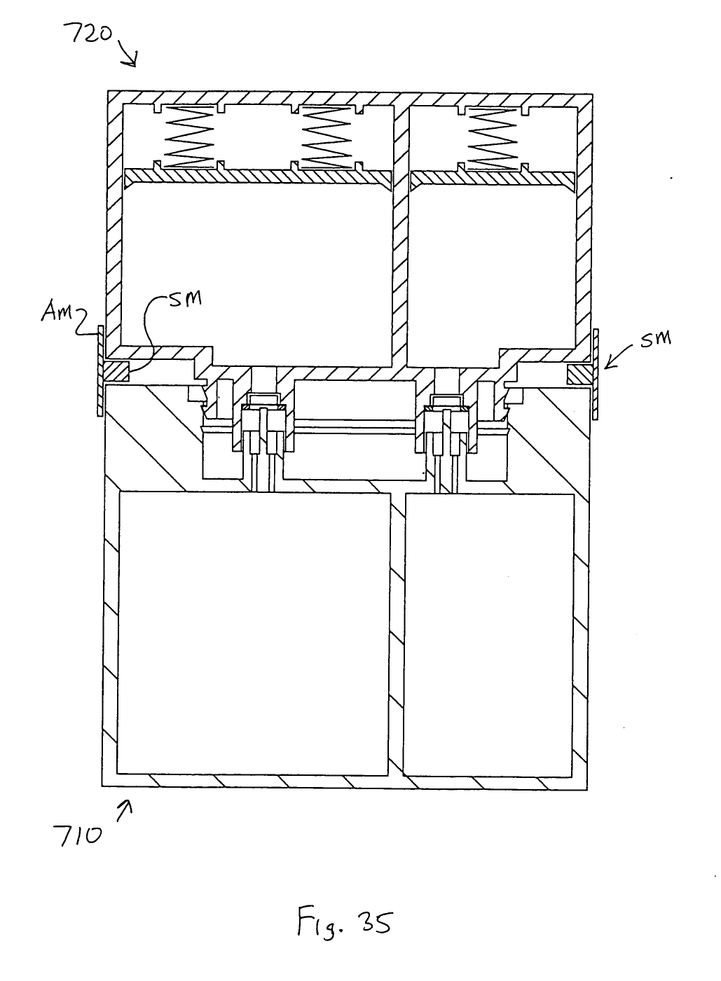

A single port 610c is arranged within a main recess 610a of the fuel cell 610. This port 610c can be integrally formed with fuel cell body by, e.g., injection molding the body in two parts. Alternatively, the port 610c can be separately formed there from and then attached thereto by, e.g., adhesives or a threaded connection (similar to the threaded connection shown in FIG. 46). The port 610c includes a plurality of openings 610d arranged allow fluids to enter into the fuel cell 610. The port 610c also include a cylindrical portion whose annular free end is configured to sealing engage with a sealing ring (similar to the sealing ring SR shown in FIGS. 29a-b) arranged within a cylindrical opening of the cartridge port 620c. The sealing ring may have any desired shape and may be made of a material such as, e.g., Viton. The cartridge port 620c projects from a bottom wall of the cartridge 620. The port 620c and connecting portion 620a (as can be the case with ports 610c and recess 610a) can be integrally formed with the cartridge body by, e.g., injection molding the body in two parts. Alternatively, the ports 610c can be separately formed there from and then attached thereto by, e.g., adhesives or a threaded connection (similar to the threaded connection shown in FIG. 46). The port 620c also includes a main opening 620d arranged allow fluids to enter into the cartridge 620 during initial filling and thereafter allow the fluids to exit and enter into the fuel cell 610 once the piercing washer (similar to the piercing PW shown in FIGS. 30a-b) is pierced. By way of non-limiting example, the cartridge 620 can be initially filled with a fluid (e.g., fuel and electrolyte) entering under a pressure which is capable of compressing the springs 620f. Then, the opening in the port 620c is sealed with a piercing washer. The port 620c further includes a cylindrical portion whose annular free end is configured to receive therein a sealing ring and the fuel cell port 610c. The piercing washer PW can be secured to in the port 620c in any desired way as long as it is securely and sealingly connected to the cartridge 620 and as long as it can be pierced by the projecting portion 610e. This can occur by, e.g., a press fit connection or by using an adhesive connection.

In performing the filling process, one simply aligns the cartridge 620 with the fuel cell 610 (in a manner similar to that shown in FIG. 31). Then, the user moves the cartridge 620 into full engagement and/or connection with the fuel cell 610 (see FIG. 34). Using the arrangement shown in FIG. 34 ensures correct alignment and full connection between the cartridge 620 and fuel cell 610. This is because the cartridge 620 has an alignment recess AR1 and an alignment projection AP2 which mate with corresponding alignment recess AR2 and alignment projection AP1 of the fuel cell 610. This arrangement may be particularly useful when used with a two port system cartridge/fuel cell arrangement, as in the embodiment shown in FIGS. 25-33. As with this previously described embodiment, full connection causes the piercing plunger 610e of the fuel cell 610 to pierce the piercing washer, which in turn automatically triggers the fluid transfer from the cartridge 620 to the fuel cell 610 under the biasing or expansion action of the piston springs 620f, and the cartridge piston 620e. Then, the fuel cell 610 is filled. Once filled, the piston springs 620f, and the cartridge piston 620e ensure that the fluids already transferred to the fuel cell 610 cannot flow back into the cartridge 620. Moreover, because the cartridge 620 is non-removably connected to the fuel cell 610, the user will not be able to reuse and refill of the fuel cell 610. To provide this non-removable connection, the cartridge 620 utilizes projections 620b which engage corresponding recesses 610b (similar to the recesses shown in FIG. 40) in the fuel cell 610. The design of the projections 620b and recesses 610b are such that the cartridge 620 cannot be removed from the fuel cell 610 without destroying the fuel cell 610. Of course, the cartridge 620 can also be non-removably secured to the fuel cell 610 in other ways such as by utilizing, e.g., pressure sensitive adhesives or by utilizing projections on the fuel cell 610 and recesses on the cartridge 620.

The fuel cell 610 and cartridge 620 may each be generally rectangular in shape and may be made of a plastic material such as, e.g., ABS plastic or ABS 5-20%. Of course, the fuel cell 610 and cartridge 620 can have any other desired shape including, but not limited to any other polygonal or any other linear and/or curvilinear shape. Although not shown, the fuel cell 610, like the fuel cell 10 in FIGS. 1-15, includes one or more cathodes, one or more anodes, and is defined by an electrolyte chamber and a fuel chamber. The fuel cell 610 also includes all of the features otherwise required to produce power. The cartridge 620 is not limited to any particular spring 620f and piston 620e arrangement and/or configuration. The important aspect of this embodiment is that the cartridge 620 have the ability of transferring its contents to the fuel cell 610 automatically once the cartridge 620 is properly, fully, sealingly and non-removably connected to the fuel cell 610. The arrangement shown in FIG. 34 can also be modified so that the chamber in the cartridge 620 utilizes a flexible material enclosure, e.g., a flexible polymer bag, which is in fluid communication with the openings 620d and which can be compressed by the springs 620f to cause its contents to be expelled out of the cartridge 620 and into the fuel cell 610 (i.e., similar to the arrangement shown in FIG. 49).

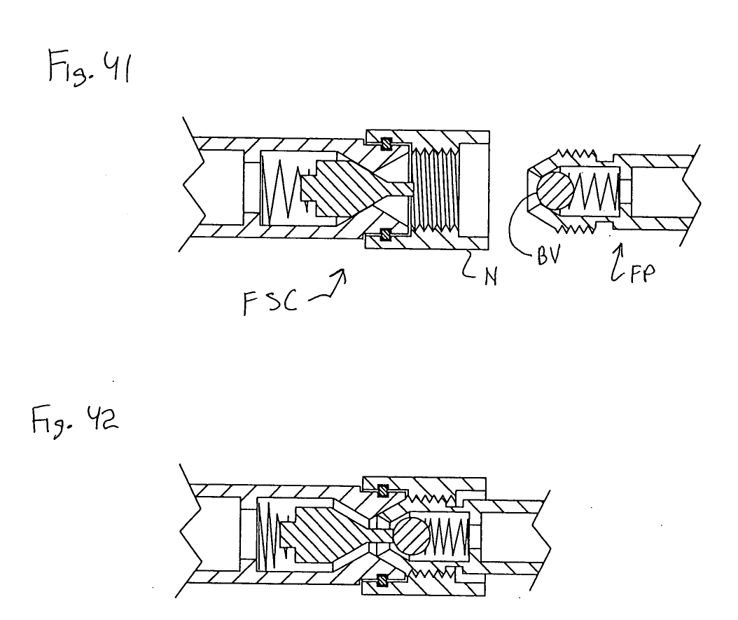

FIGS. 35-38 schematically illustrate another non-limiting embodiment of a portable stand-alone single-use disposable fuel cell 710 and cartridge 720 system. The design and configuration of the fuel cell 710 and cartridge 720 are substantially similar to the cartridge and fuel cell shown in FIGS. 25-33, whose features will not again be discussed. This embodiment, however, is designed so that the fuel cell 710 and a cartridge 720 can be purchased or procured together as a partially non-removably assembled and/or a partially non-removably connected unit with the fresh fuel component(s) or fluids being contained only in the cartridge 720. This embodiment uses two oppositely arranged spacer members SM (or one continuous one peripheral spacer member) to maintain a spacing between the cartridge 720 and the fuel cell 710. Each spacer member SM includes an adhesive member AM which has the form of, e.g., an adhesive tape, and a plastic spacer member SM secured to a central portion of the adhesive member AM. The spacer member SM has an inner surface which is releasably secured to outer surfaces of both the cartridge 720 and the fuel cell 710, and can be easily removed (see FIG. 36) by, e.g., un-peeling it from the cartridge 720 and fuel cell 710. This spacing ensures that the fuel cell 710 and cartridge 720 remain non-removably connected and also ensures that the fluids remain stored in the cartridge 720. However, when the user desires to place the fuel cell 710 into use, he need only removes spacer members SM (see FIG. 36) and cause and/or otherwise force the cartridge 720 into full engagement or connection with the fuel cell 710 (see FIG. 37). This embodiment has the advantage that the user can store the unit for relatively long periods of time and then fill and use the fuel cell 710 at a desirable point in time. Once filled (see FIG. 38), the user uses the fuel cell 710 with the connected cartridge 720 until it is exhausted, i.e. it stops generating the desired level of power. Then, the user simply discards and/or recycles the fuel cell 710/cartridge 720 as a unit. The design of the fuel cell 710/cartridge 720 is such that it cannot be refilled and/or its contents cannot be easily removed from the fuel cell 710 without destroying the fuel cell 710 and cartridge 720. This arrangement is ensured when the user fully connects the cartridge 720 to the fuel cell 710 (see FIG. 37) because the cartridge 720 becomes non-removably connected to the fuel cell 710 when fully connected. As with the embodiment shown in FIGS. 25-33, this connection also automatically triggers the transfer of fluids between the cartridge 720 and the fuel cell 710 (see FIG. 38). By ensuring that, once fully connected, the cartridge 720 is essentially permanently connected to the fuel cell 710, the user will not be able to refill and/or reuse the fuel cell 710 without destroying it in the attempt to do so. The fuel cell 710 is thus usable only once and must then be discarded or recycled.

FIGS. 39 and 40 schematically illustrate another non-limiting embodiment of a portable stand-alone single-use disposable fuel cell 810. This embodiment is designed so that it can be purchased or procured with the fuel component(s) being added at the time of purchase or at a later date. The seller facility may have a filling station (not shown) which can be used at the time the user purchases the fuel cell 810. Such filling stations can be located at, e.g., electronics stores, such as Radio Shack®. The filling station will have a large supply of fuel components, as well as a system for filling the fuel cells 810 quickly. The station may utilize one or more filling station connectors FSC (see FIGS. 41 and 42) to connect the filling station to the fuel cell 810. Once filled, the user uses the fuel cell 810 until it is exhausted. Then, the user simply discards and/or recycles the fuel cell 810. The design of the fuel cell 810 is such that it cannot be refilled and/or its contents cannot be easily removed without destroying the fuel cell 810. This occurs with the use of a non-removable cover NC which is designed to be inserted into the fuel cell 810 immediately after it is filled (in the same way as the embodiment shown in FIG. 24). By doing so, the user will not be able to refill and/or reuse the fuel cell 810 without destroying it in the attempt to do so.

As explained above, the fuel cell 810 can be filled by connecting one of more of its valves or filling ports FP (which can be similar to valves FP shown in FIGS. 41 and 42) to the filling station via filling station connectors FSC. The fuel ports FP can be integrally formed with fuel cell body by, e.g., injection molding the body in two parts, or separately formed there from and then attached thereto by, e.g., adhesives or a threaded connection (similar to the threaded connection shown in FIG. 46). In performing the filling process, one simply connects the connectors FSC to the fuel ports FP by, e.g., threading on the rotatably mounted nut N onto the ports FP. Once fully connected (see FIG. 42), the fluids can flow from the filling station and into the fuel cell 810. Then, the fuel cell 810 can be properly filled with fluids. Once filled, the connectors FSC are unthreaded from the ports FP. Moreover, the ports FP may include one-way ball valves (see FIGS. 41 and 42), to ensure that the fluids do not leak out of the fuel cell FC, i.e., the ball valve BV prevents fluid from leaking out of the fuel cell 810. The operation of this internal ball valve BV and the internal plunger valve of the connector FSC is similar in operation to the valves shown 20a-20e. Finally, the rectangular-shaped non-removably cover NC is installed to prevent reuse and refilling of the fuel cell 810. The protective cover NC may be made of a plastic such as, e.g., ABS plastic or ABS 5-20%.

The fuel cell 810 is generally rectangular in shape and may be made of a plastic material such as, e.g., ABS plastic or ABS 5-20%. Of course, the fuel cell 810 can have any other desired shape including, but not limited to any other polygonal or any other linear and/or curvilinear shape. Although not shown, the fuel cell 810, like the fuel cell 10 in FIGS. 1-15, includes one or more cathodes, one or more anodes, and defines an electrolyte chamber and a fuel chamber. The fuel cell 810 also includes all of the features otherwise required to produce power.

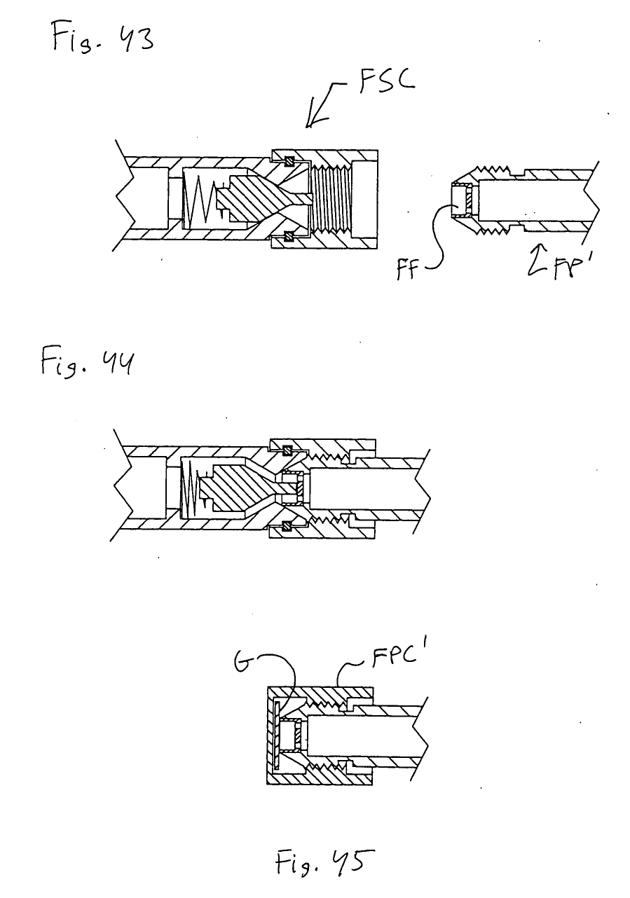

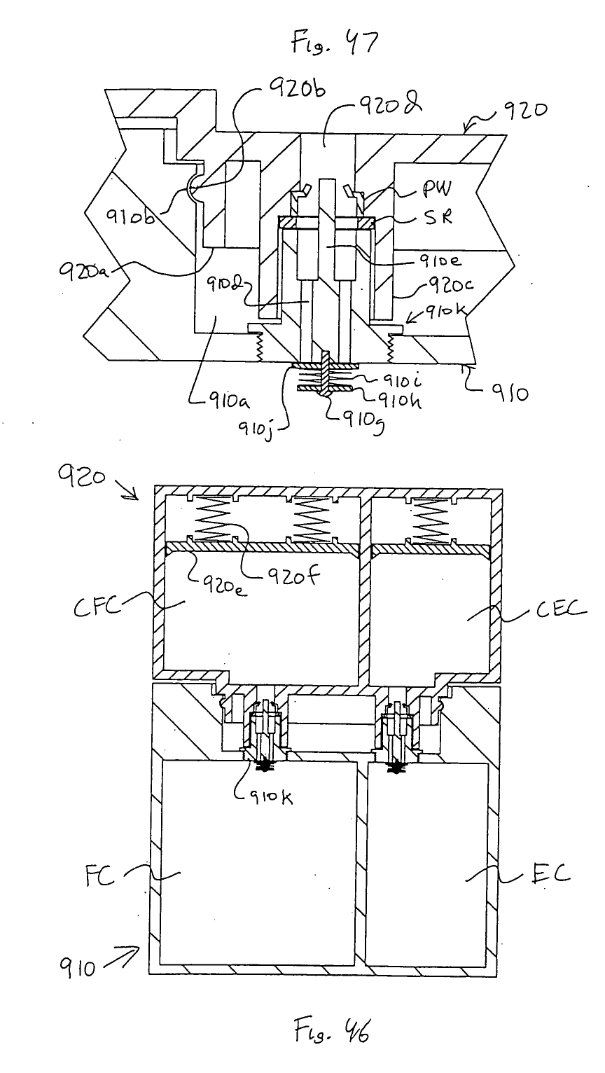

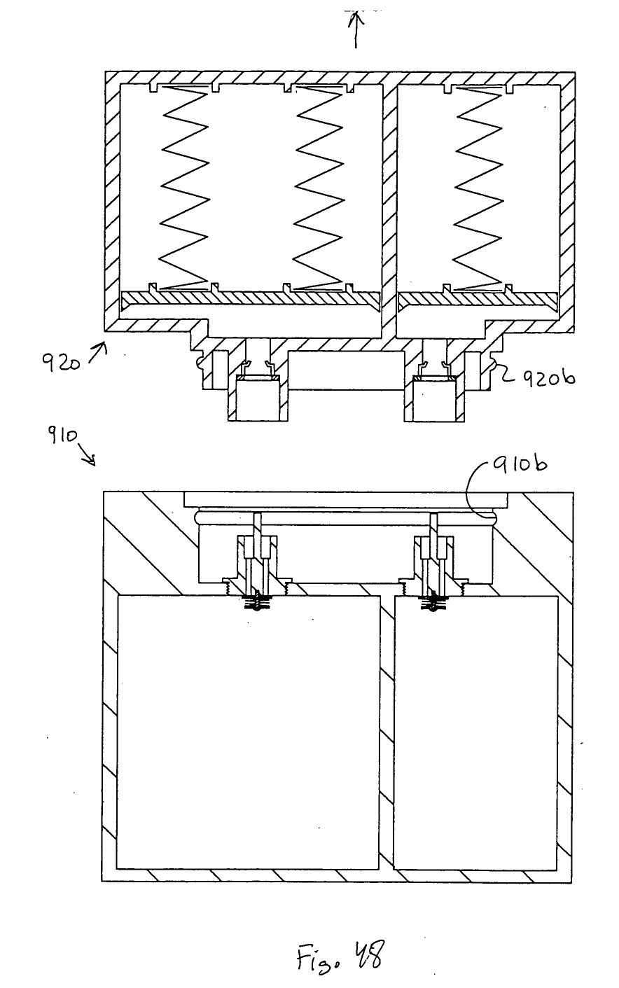

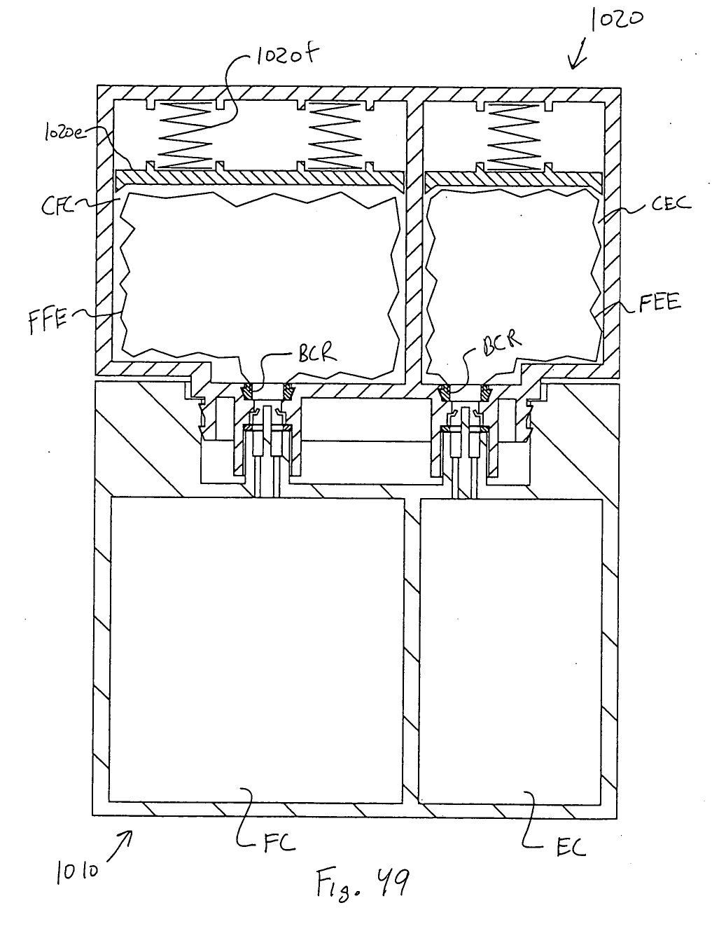

FIGS. 43-45 show another possible valve arrangement for use on the fuel cell 410 shown in FIG. 24. Instead of the open fuel ports shown in FIG. 24, the fuel ports FP′ can also utilize fluid filters FF to ensure that contaminants are not allowed to enter the fuel cell 410. The fuel filters FF are cap shaped washer devices whose flow openings are sized to allow the fluid to flow into the fuel cell 410, but which are prevent debris from also entering the fuel cell 420. As is evident from FIG. 44, the fuel filter FF also acts as a mechanism for causing the plunger valve to open, thereby allowing fluid to flow from the filling station connector FSC to the fuel cell 410. As with the embodiment shown in FIG. 24, this fuel port arrangement also utilizes a threadably mounted sealing cap FPC′. This embodiment also utilizes an inner polymer gasket G which forms a seal with the end of the fuel port FP′.

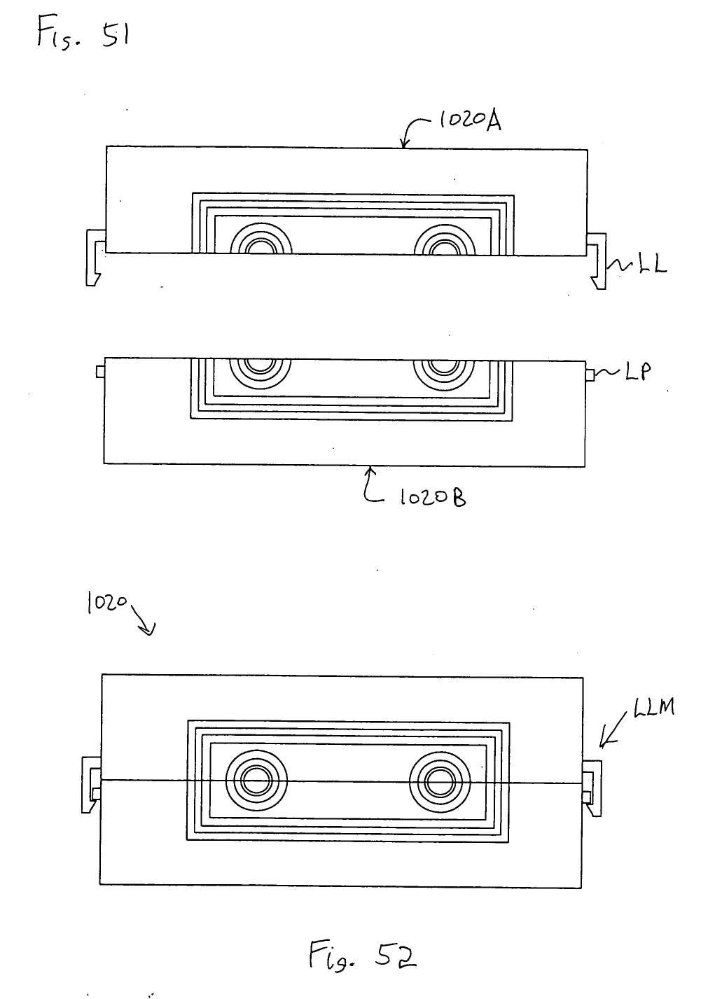

FIGS. 46-48 schematically illustrate another non-limiting embodiment of a portable stand-alone single-use disposable fuel cell 910 and cartridge 920 system. By way of non-limiting example, the fuel cell 910 includes two chambers FC and EC which are separated from each other and the cartridge 920 includes two chambers CEC and CFC which separated from each other. This embodiment is designed so that the fuel cell 910 and a cartridge 920 can be purchased or procured together as a dis-assembled and/or unconnected unit with the fresh fuel component(s) or fluids being contained only in the cartridge 920. The user then removably connects the cartridge 920 to the fuel cell 910 when the user desires to use the fuel cell 910. This embodiment has the advantage that the user can store the unit for relatively long periods of time and then fill and use the fuel cell 910 at a desirable point in time. Once filled, the user uses the fuel cell 910 with or without the connected cartridge 520 until it is exhausted, i.e. it stops generating the desired level of power. Then, the user simply discards and/or recycles the fuel cell 910 alone or the fuel cell 910/cartridge 920 as a unit. The design of the fuel cell 910/cartridge 920 is such that it cannot be refilled and/or its contents cannot be easily removed from the fuel cell 910 without destroying the fuel cell 910. This condition is ensured when the user fully connects the cartridge 920 to the fuel cell 910 (see FIG. 46) and also when the user disconnects the empty cartridge 920 from the fuel cell 910 (see FIG. 48). Because the fuel cell 910 contains one way valves 901g-910j, the cartridge 920 can be safely disconnected from the fuel cell 910 after the contents of the cartridge 920 are transferred to the fuel cell 910. As is evident from FIG. 46, a full connection between the cartridge 920 and the fuel cell 910 automatically triggers the transfer of fluids between the cartridge 920 and the fuel cell 910. By ensuring that, once fully connected, the cartridge 920 is sealingly connected to the fuel cell 910 and by ensuring that the fluids in the fuel cell 910, once placed therein, cannot be removed, the user will not be able to refill and/or reuse the fuel cell 910 without destroying it in the attempt to do so. The fuel cell 910 is thus usable only once and must then be discarded or recycled.

As with many of the previously described embodiments, the two ports 910c (one for the fuel chamber FC and one for the electrolyte chamber EC) are arranged within a main recess 910a of the fuel cell 910. The ports 910c can be separately formed therefrom and then attached thereto by, e.g., adhesives and/or a threaded connection. In this regard, the ports 910c may have a threaded collar 910k whose external threads sealingly engage with internal threads of the fuel cell body. The ports 910c include a plurality of openings 910d arranged allow fluids to enter into the fuel chamber FC and the electrolyte chamber EC. The ports 910c also include a cylindrical portion whose annular free end is configured to sealing engage with a sealing ring SR arranged within a cylindrical opening of the cartridge ports 920c. The sealing ring SR may have any desired shape and may be made of a material such as, e.g., Viton. The two ports 920c (one for the fuel chamber CFC and one for the electrolyte chamber CEC) project from a bottom wall of the cartridge 920. The ports 920c and connecting portion 920a can be integrally formed with the cartridge body by, e.g., injection molding the body in two parts. Alternatively, the ports 920c can be separately formed there from and then attached thereto by, e.g., adhesives or a threaded connection. The ports 920c each include a main opening 920d arranged allow fluids to enter into the fuel chamber CFC and the electrolyte chamber CEC during initial filling and thereafter allow the fluids to exit and enter into the fuel cell 910 once the piercing washers PW are pierced. By way of non-limiting example, the chambers CFC and CEC can be initially filled with the fluids (e.g., fuel and electrolyte) entering under a fluid pressure which is capable of compressing the springs 920f. Then, the openings are sealed with the piercing washers PW. The ports 920c include a cylindrical portion whose annular free end is configured to receive therein a sealing ring SR and a respective fuel cell port 910c. The ports 920c also include a cylindrical portion which is configured to receive therein a piercing washer PW. The piercing washer PW can be secured to the opening in any desired way as long as it is securely and sealingly connected to the cartridge 920 and as long as it can be pierced by the projecting portions 910e. This can occur by, e.g., a press fit connection or by using an adhesive connection.

In performing the filling process, one simply aligns the cartridge 920 with the fuel cell 910. Then, the user moves the cartridge 920 into full engagement and/or connection with the fuel cell 910 (see FIG. 46). This causes the piercing plungers 910e of the fuel cell 910 to pierce the piercing washers PW, which in turn automatically triggers the fluid transfer from the cartridge 920 to the fuel cell 910 under the biasing or expansion action of the piston springs 920f and the cartridge pistons 920e. The fluids force open a sealing disk 910j, i.e., cause it to move away from the openings 910d, by overcoming the biasing force of the spring 910i. This occurs because the fluid pressure in the cartridge 920 is sufficient to overcome the biasing force of the spring 910i. The springs 910i otherwise bias the sealing disks 910j towards a position closing off the openings 910d. This occurs by placing the spring 910i in a compressed state between the sealing disk 910j and a retaining disk 910h which is held in place by a pin 910g. The pin 910g is secured to a bottom surface of the threaded collar 910k in any desired way such as by, e.g., a press fit connection or an adhesive connection. With this arrangement, the fuel cell 910 can be filled without any of the fluids ever moving back into the cartridge 920. Once filled, the piston springs 920f and the cartridge pistons 920e remain in a lowermost position. On the other hand, because the cartridge 920 is removably connected to the fuel cell 910, the user can then disconnect the cartridge 920 and discard or recycle it. At the same time, the user will not be able to reuse and refill of the fuel cell 910. Such an arrangement may be beneficial in applications where space and/or weight is at a premium and it is desirable to disconnect the cartridge 920. To provide this removable connection, the cartridge 920 utilizes one or more rounded projections 920b which engage corresponding recesses 910b in the fuel cell 910. The design of the projections 920b and recesses 910b are such that the cartridge 920 can be removed from the fuel cell 910 without destroying the fuel cell 910. Of course, the cartridge 920 can also be removably secured to the fuel cell 910 in other ways such as by utilizing, e.g., projections on the fuel cell 910 and recesses on the cartridge 920.

The fuel cell 910 and cartridge 920 may each be generally rectangular in shape and may be made of a plastic material such as, e.g., ABS plastic or ABS 5-20%. Of course, the fuel cell 910 and cartridge 920 can have any other desired shape including, but not limited to any other polygonal or any other linear and/or curvilinear shape. Although not shown, the fuel cell 910, like the fuel cell 10 in FIGS. 1-15, includes one or more cathodes, one or more anodes, and defines an electrolyte chamber and a fuel chamber. The fuel cell 910 also includes all of the features otherwise required to produce power. The cartridge 920 is not limited to any particular spring 920f and piston 920e arrangement and/or configuration. The important aspect of this embodiment is that the cartridge 920 have the ability of transferring its contents to the fuel cell 910 automatically once the cartridge is fully, sealingly and removably connected to the fuel cell 910. The arrangement shown in FIGS. 46-48 can also be modified so that the chambers CEC and CFC utilize flexible material enclosures, e.g., flexible polymer bags, which are in fluid communication with the openings 920d and which can be compressed by the springs 920f to cause their contents to be expelled out of the cartridge 920 and into the fuel cell 910 (i.e., similar to the arrangement shown in FIG. 49).

FIGS. 49 and 50 schematically illustrate another non-limiting embodiment of a portable stand-alone single-use disposable fuel cell 1010 and cartridge 1020 system. By way of non-limiting example, the fuel cell 1010 includes two chambers FC and EC which are separated from each other and the cartridge 1020 includes two chambers CEC and CFC which separated from each other. This embodiment is also designed so that the fuel cell 1010 and a cartridge 1020 can be purchased or procured together as a dis-assembled and/or unconnected unit with the fresh fuel component(s) or fluids being contained only in the cartridge 1020. The user then removably connects the cartridge 1020 to the fuel cell 1010 when the user desires to use the fuel cell 1010. This embodiment has the advantage that the user can store the unit for relatively long periods of time and then fill and use the fuel cell 1010 at a desirable point in time. Once filled, the user uses the fuel cell 1010 with the non-removably connected cartridge 1020 until it is exhausted, i.e. it stops generating the desired level of power. Then, the user simply discards and/or recycles the fuel cell 1010/cartridge 1020 as a unit. The design of the fuel cell 1010/cartridge 1020 is such that it cannot be refilled and/or its contents cannot be easily removed from the fuel cell 1010 without destroying the fuel cell 1010. This condition is ensured when the user fully non-removably connects the cartridge 1020 to the fuel cell 1010 (see FIG. 49). This non-removable connection system is similar to that of the embodiment shown in, e.g.,

FIGS. 25-33. As is evident from FIG. 49, a full connection between the cartridge 1020 and the fuel cell 1010 automatically triggers the transfer of fluids between the cartridge 1020 and the fuel cell 1010. By ensuring that, once fully connected, the cartridge 1020 is sealingly connected to the fuel cell 1010 and by ensuring that the fluids in the fuel cell 1010, once placed therein, cannot be removed, the user will not be able to refill and/or reuse the fuel cell 1010 without destroying it in the attempt to do so. The fuel cell 1010 is thus usable only once and must then be discarded or recycled.

As with many of the previously described embodiments, the two ports 1010c (one for the fuel chamber FC and one for the electrolyte chamber EC) are arranged within a main recess 1010a of the fuel cell 1010. The ports 1010c can be separately formed there from and then attached thereto by, e.g., adhesives and/or a threaded connection. The ports 1010c include a plurality of openings 1010d arranged allow fluids to enter into the fuel chamber FC and the electrolyte chamber EC. The ports 1010c also include a cylindrical portion whose annular free end is configured to sealing engage with a sealing ring SR arranged within a cylindrical opening of the cartridge ports 1020c. The sealing ring SR may have any desired shape and may be made of a material such as, e.g., Viton. The two ports 1020c (one for the fuel chamber CFC and one for the electrolyte chamber CEC) project from a bottom wall of the cartridge 1020. The ports 1020c and connecting portion 1020a can be integrally formed with the cartridge body by, e.g., injection molding the body in two parts. Alternatively, the ports 1020c can be separately formed there from and then attached thereto by, e.g., adhesives or a threaded connection. The ports 1020c each include a main opening 1020d arranged allow fluids to enter into the flexible fuel chamber or enclosure FFE and the flexible electrolyte chamber or enclosure FEE during initial filling and thereafter allow the fluids to exit and enter into the fuel cell 1010 once the piercing washers PW are pierced. By way of non-limiting example, the flexible chambers FFE and FEE can be initially filled with the fluids (e.g., fuel and electrolyte) entering under a fluid pressure which is capable of compressing the springs 1020f. Then, the openings are sealed with the piercing washers PW. The ports 1020c include a cylindrical portion whose annular free end is configured to receive therein a sealing ring SR and a respective fuel cell port 1010c. The ports 1020c also include a cylindrical portion which is configured to receive therein a piercing washer PW. The piercing washer PW can be secured to the opening in any desired way as long as it is securely and sealingly connected to the cartridge 1020 and as long as it can be pierced by the projecting portions 1010e. This can occur by, e.g., a press fit connection or by using an adhesive connection.

As is evident in FIG. 50, the flexible enclosures FFE and FEE has an open end which is fixed to a connecting ring BCR. Each ring BCR includes an external projection which securely and sealingly engages with a corresponding internal recess in the cartridge body.

In performing the filling process, one simply aligns the cartridge 1020 with the fuel cell 1010. Then, the user moves the cartridge 1020 into full engagement and/or connection with the fuel cell 1010 (see FIG. 49). This causes the piercing plungers 1010e of the fuel cell 1010 to pierce the piercing washers PW, which in turn automatically triggers the fluid transfer from the cartridge 1020 to the fuel cell 1010 under the biasing or expansion action of the piston springs 1020f and the cartridge pistons 1020e. The pistons 1020e act to compress the flexible chambers FFE and FEE which forces their contents into the fuel cell 1010. With this arrangement, the fuel cell 1010 can be filled without any of the fluids ever moving back into the cartridge 1020. Once filled, the piston springs 1020f and the cartridge pistons 1020e remain in a lowermost position. On the other hand, the cartridge 1020 remains non-removably connected to the fuel cell 1010. At the same time, the user will not be able to reuse and refill of the fuel cell 1010.

The fuel cell 1010 and cartridge 1020 may each be generally rectangular in shape and may be made of a plastic material such as, e.g., ABS plastic or ABS 5-20%. Of course, the fuel cell 1010 and cartridge 1020 can have any other desired shape including, but not limited to any other polygonal or any other linear and/or curvilinear shape. Although not shown, the fuel cell 1010, like the fuel cell 10 in FIGS. 1-15, includes one or more cathodes, one or more anodes, and defines an electrolyte chamber and a fuel chamber. The fuel cell 1010 also includes all of the features otherwise required to produce power. The cartridge 1020 is not limited to any particular spring 1020f and piston 1020e arrangement and/or configuration. The important aspect of this embodiment is that the cartridge 1020 have the ability of transferring its contents to the fuel cell 1010 automatically once the cartridge is fully, sealingly and removably connected to the fuel cell 1010. The arrangement shown in FIGS. 49-50 can also be modified so that the cartridge body is formed two parts 1020A and 1020B (see FIGS. 51 and 52) which are attached to each other by locking latch mechanisms LLM which includes a deflectable locking latch LL fixed to the upper part 1020A and a locking projection LP fixed to the lower part 1020B.

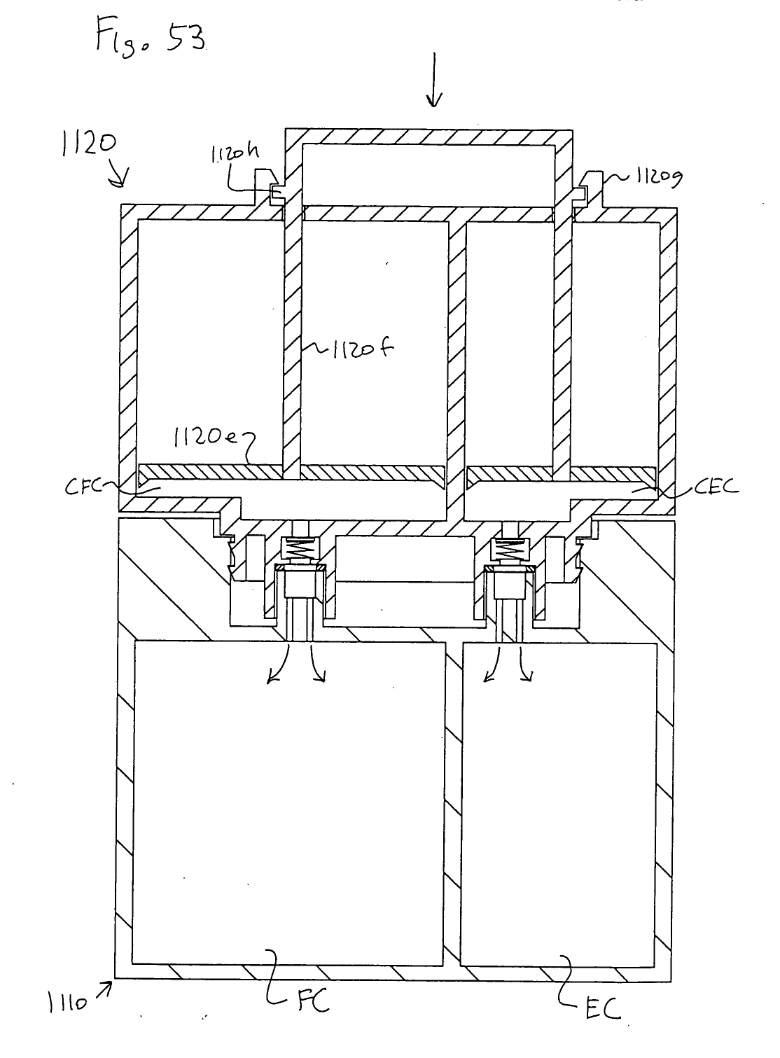

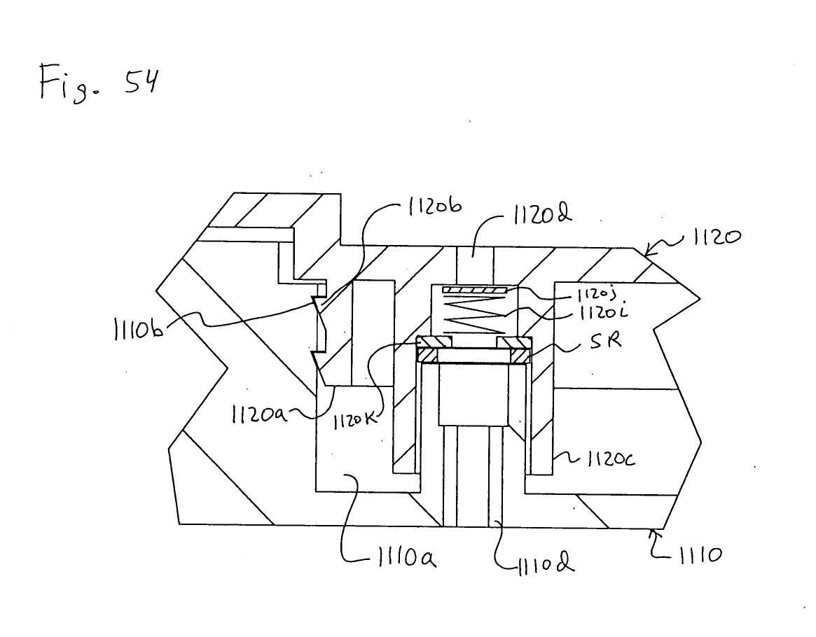

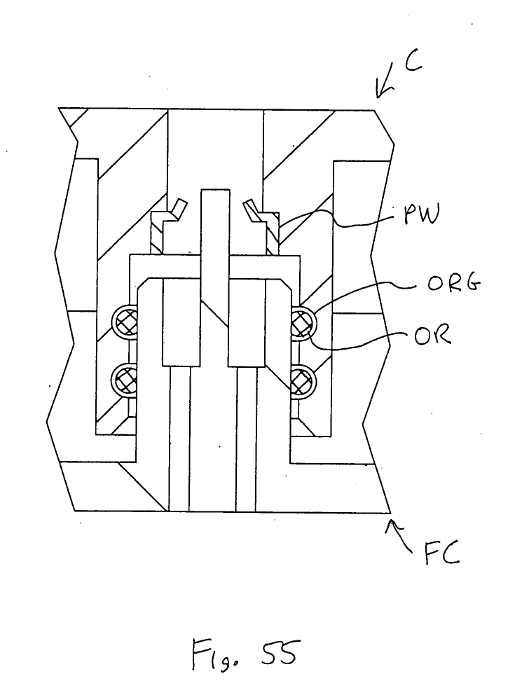

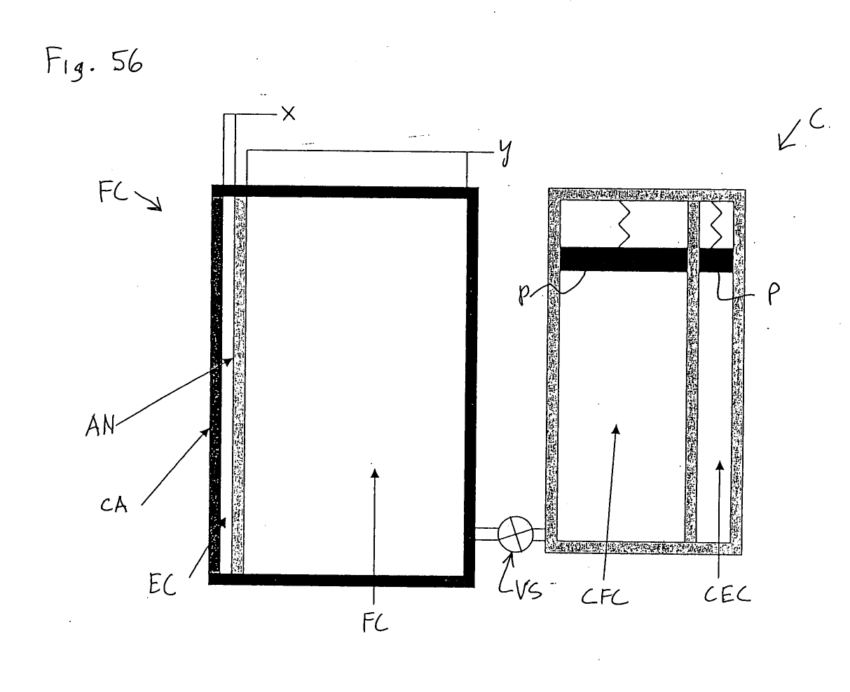

FIGS. 53 and 54 schematically illustrate another non-limiting embodiment of a portable stand-alone single-use disposable fuel cell 1110 and cartridge 1120 system. By way of non-limiting example, the fuel cell 1110 includes two chambers FC and EC which are separated from each other and the cartridge 1120 includes two chambers CEC and CFC which separated from each other. This embodiment is designed so that the fuel cell 1110 and a cartridge 1120 can be purchased or procured together as a dis-assembled and/or unconnected unit with the fresh fuel component(s) or fluids being contained only in the cartridge 1120. The user then removably connects the cartridge 1120 to the fuel cell 1110 when the user desires to use the fuel cell 1110. This embodiment has the advantage that the user can store the unit for relatively long periods of time and then fill and use the fuel cell 1110 at a desirable point in time. Once filled, the user uses the fuel cell 1110 with the non-removably connected cartridge 1120 until it is exhausted, i.e. it stops generating the desired level of power. Then, the user simply discards and/or recycles the fuel cell 1110/cartridge 1120 as a unit. The design of the fuel cell 1110/cartridge 1120 is such that it cannot be refilled and/or its contents cannot be easily removed from the fuel cell 1110 without destroying the fuel cell 1110. This condition is ensured when the user fully connects the cartridge 1120 to the fuel cell 1110 (see FIG. 53). Because the cartridge 1120 contains one way valves 1120i and 1120j, this embodiment can dispense with the need for valves in the fuel cell 1110 or with the piercing washer PW. As is evident from FIG. 53, a full connection between the cartridge 1120 and the fuel cell 1110 does not automatically trigger the transfer of fluids between the cartridge 1120 and the fuel cell 1110, as was the case with many of the previously described embodiments. Instead, this embodiment allows the user to physically and mechanically control the fluid transfer by moving the piston rods 1120f. To facilitate this movement, the user grips a handle which connects the two rods 1120f and moves it in the direction of the fuel cell 1110. At a lowermost position, the handle non-releasably locks to the cartridge 1120 so that the user will not be able to cause the fluids to move back into the cartridge 1120 from the fuel cell 1110. As can be seen in FIG. 53, this locking can occur by utilizing two deflectable locking members 1120g fixed to the cartridge body and two locking projections 1120h fixed to the rods 1120f. By ensuring that, once fully connected, the cartridge 1120 is sealingly connected to the fuel cell 1110 and by ensuring that the fluids in the fuel cell 1110, once placed therein, cannot be removed, the user will not be able to refill and/or reuse the fuel cell 1110 without destroying it in the attempt to do so. The fuel cell 1110 is thus usable only once and must then be discarded or recycled.

As with many of the previously described embodiments, the two ports 1110c (one for the fuel chamber FC and one for the electrolyte chamber EC) are arranged within a main recess 1110a of the fuel cell 1110. The ports 1110c can be separately formed there from and then attached thereto by, e.g., adhesives and/or a threaded connection. The ports 1110c include a plurality of openings 1110d arranged allow fluids to enter into the fuel chamber FC and the electrolyte chamber EC. The ports 1110c also include a cylindrical portion whose annular free end is configured to sealing engage with a sealing ring SR arranged within a cylindrical opening of the cartridge ports 1120c. The sealing ring SR may have any desired shape and may be made of a material such as, e.g., Viton. The two ports 1120c (one for the fuel chamber CFC and one for the electrolyte chamber CEC) project from a bottom wall of the cartridge 1120. The ports 1120c and connecting portion 1120a can be integrally formed with the cartridge body by, e.g., injection molding the body in two parts. Alternatively, the ports 1120c can be separately formed there from and then attached thereto by, e.g., adhesives or a threaded connection. The ports 1120c each include a main opening 1120d arranged allow fluids to enter into the fuel chamber CFC and the electrolyte chamber CEC during initial filling and thereafter allow the fluids to exit and enter into the fuel cell 1110 once the valves 1120j and 1120i are forced open under fluid pressure. By way of non-limiting example, the chambers CFC and CEC can be initially filled with the fluids (e.g., fuel and electrolyte) entering under a fluid pressure which is capable of filling the volume up to the pistons 1120e. Then, the openings are sealed with the sealing disk 1120j, spring 1120i and retaining washer 1120k (which can be press-fit into the cylindrical opening of the ports 1120c. The ports 1120c include a cylindrical portion whose annular free end is configured to also receive therein a sealing ring SR and a respective fuel cell port 1110c.

In performing the filling process, one simply aligns the cartridge 1120 with the fuel cell 1110. Then, the user moves the cartridge 1120 into full engagement and/or connection with the fuel cell 1110 (see FIG. 53). Then, the user moves the handle connected to the piston rods 1120f towards the fuel cell 1110. This, in turn, causes the fluid transfer from the cartridge 1120 to the fuel cell 1110 under the action of the cartridge pistons 1120e. The fluids force open a sealing disk 1120j, i.e., causing it to move away from the openings 1120d, by overcoming the biasing force of the spring 1120i. This occurs because the fluid pressure in the cartridge 1120 is sufficient to overcome the biasing force of the spring 1120i. The springs 1120i otherwise bias the sealing disks 1120j towards a position closing off the openings 1120d. This occurs by placing the spring 1120i in a compressed state between the sealing disk 1120j and a retaining washer 1120k which is held in place by, e.g., a press fit connection or an adhesive connection. With this arrangement, the fuel cell 1110 can be filled without any of the fluids ever moving back into the cartridge 1120. Once filled, the cartridge pistons 1120e remain in a lowermost position owing to the locking system 1120g/1120h. On the other hand, because the cartridge 1120 is non-removably connected to the fuel cell 1110, the user cannot disconnect the cartridge 1120. At the same time, the user will not be able to reuse and refill of the fuel cell 1110.

The fuel cell 1110 and cartridge 1120 may each be generally rectangular in shape and may be made of a plastic material such as, e.g., ABS plastic or ABS 5-20%. Of course, the fuel cell 1110 and cartridge 1120 can have any other desired shape including, but not limited to any other polygonal or any other linear and/or curvilinear shape. Although not shown, the fuel cell 1110, like the fuel cell 10 in FIGS. 1-15, includes one or more cathodes, one or more anodes, and defines an electrolyte chamber and a fuel chamber. The fuel cell 1110 also includes all of the features otherwise required to produce power. The cartridge 1120 is not limited to any particular piston 1120e arrangement and/or configuration. The important aspect of this embodiment is that the cartridge 1120 have the ability of non-reversibly transferring its contents to the fuel cell 1110 under the action of the user once the cartridge 1120 is fully, sealingly and removably connected to the fuel cell 1110. The arrangement shown in FIGS. 53 and 54 can also be modified so that the chambers CEC and CFC utilize flexible material enclosures, e.g., flexible polymer bags, which are in fluid communication with the openings 1120d and which can be compressed by the pistons 1120e to cause their contents to be expelled out of the cartridge 1120 and into the fuel cell 1110 (i.e., similar to the arrangement shown in FIG. 49).

As with many of the previously described embodiments, the two ports 1110c (one for the fuel chamber FC and one for the electrolyte chamber EC) are arranged within a main recess 1110a of the fuel cell 1110. The ports 1110c can be separately formed there from and then attached thereto by, e.g., adhesives and/or a threaded connection. The ports 1110c include a plurality of openings 1110d arranged allow fluids to enter into the fuel chamber FC and the electrolyte chamber EC. The ports 1110c also include a cylindrical portion whose annular free end is configured to sealing engage with a sealing ring SR arranged within a cylindrical opening of the cartridge ports 1120c. The sealing ring SR may have any desired shape and may be made of a material such as, e.g., Viton. The two ports 1120c (one for the fuel chamber CFC and one for the electrolyte chamber CEC) project from a bottom wall of the cartridge 1120. The ports 1120c and connecting portion 1120a can be integrally formed with the cartridge body by, e.g., injection molding the body in two parts. Alternatively, the ports 1120c can be separately formed there from and then attached thereto by, e.g., adhesives or a threaded connection. The ports 1120c each include a main opening 1120d arranged allow fluids to enter into the fuel chamber CFC and the electrolyte chamber CEC during initial filling and thereafter allow the fluids to exit and enter into the fuel cell 1110 once the valves 1120j and 1120i are forced open under fluid pressure. By way of non-limiting example, the chambers CFC and CEC can be initially filled with the fluids (e.g., fuel and electrolyte) entering under a fluid pressure which is capable of filling the volume up to the pistons 1120e. Then, the openings are sealed with the sealing disk 1120j, spring 1120i and retaining washer 1120k (which can be press-fit into the cylindrical opening of the ports 1120c. The ports 1120c include a cylindrical portion whose annular free end is configured to also receive therein a sealing ring SR and a respective fuel cell port 1110c.

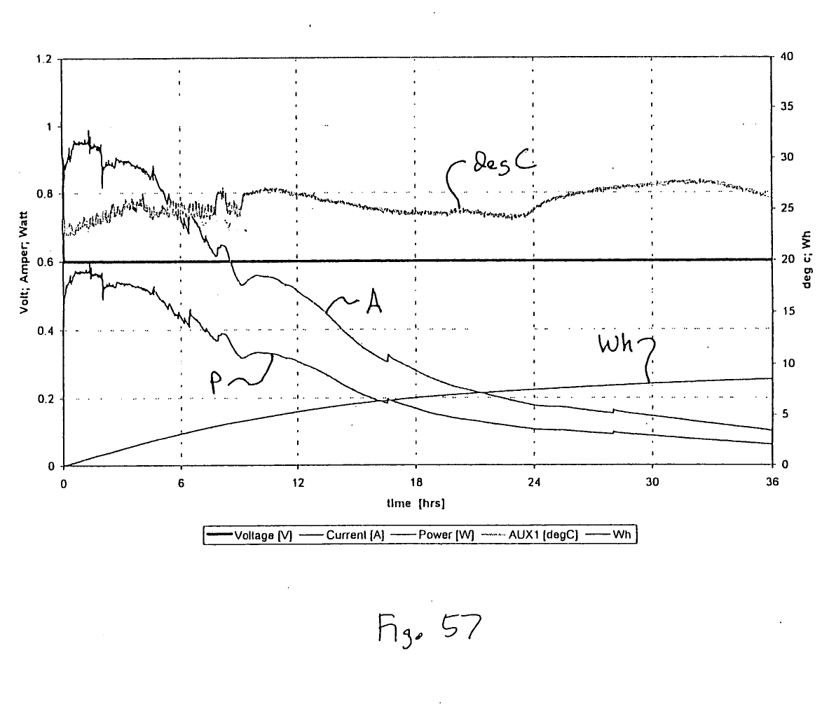

FIG. 55 shows an alternative non-limiting arrangement for the fluid-tight connection between the ports of the fuel cell FC and those of the cartridge C. This arrangement can be used of the embodiments shown in., e.g., FIGS. 25-39 and 46-50. This arrangement uses two O-rings RW arranged within two O-ring grooves ORG in place of the sealing SR. The O-rings OR sealingly engage with an outer cylindrical surface of the fuel cell ports.

FIG. 56 shows still another non-limiting embodiment of a disposable fuel cell FC and cartridge C. The portable stand-alone single-use disposable fuel cell FC/C is designed so that it can be purchased or procured as a unit assembly including a cartridge containing the fuel component(s) separated from a fuel cell which does not contain the fuel component(s). The purchaser can then install and/or connect the cartridge C on, into, or to the fuel cell FC and cause the fuel component(s) in the cartridge to enter into the fuel cell via a valve system VS. The fuel cell FC and cartridge C, once initially connected, either cannot be disconnected from each other and/or there are no mechanisms for causing and/or allowing the fuel component(s) to move back from the fuel cell FC to the cartridge C, as with the previously described embodiments. A new cartridge cannot be connected to the fuel cell without destroying the fuel cell. Once filled, the user uses the fuel cell until it is exhausted. Then, the user simply discards and/or recycles the fuel cell and cartridge as a unit. The design of the fuel cell FC is such that it cannot be refilled and/or its contents cannot be easily removed without destroying the fuel cell. By way of non-limiting example, the fuel cell FC has an anode AN, a cathode CA, an electrolyte chamber EC and a fuel chamber FC. The width of the electrolyte chamber “x” can be approximately 3 mm and the width “y” of the fuel chamber FC can be approximately 15 mm. The volume of the electrolyte chamber EC can be approximately 9 cc and the volume of the fuel chamber FC can be approximately 36 cc. The cartridge C may utilize spring actuated pistons P to cause the transfer of the fluids in the electrolyte chamber CEC and the fuel chamber CFC to the corresponding chambers EC and FC of the fuel cell FC. The volume of the electrolyte chamber CEC can be approximately 11 cc and the volume of the fuel chamber CFC can be approximately 38 cc.

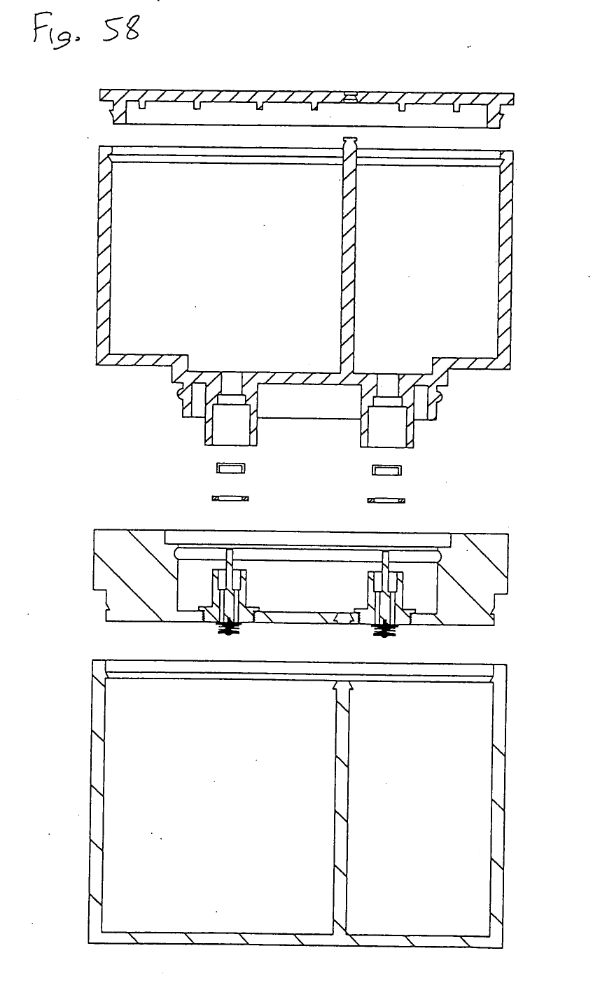

FIG. 57 illustrates the performance of the fuel cell shown in FIG. 56 using the fuel disclosed in U.S. Pat. No. 6,554,877, the disclosure of which is hereby expressly incorporated by reference in its entirety. The fuel cell FC was filled with a cartridge and contained 36 ml of fuel and 9 ml of electrolyte. The unit was then subjected to a discharge at constant voltage conditions (0.6 V).

FIG. 58 illustrates one non-limiting way in which the cartridges and fuel cells shown in FIGS. 24-40 and 46-56 can be formed by assembly two main components, e.g., a cover portion that is non-removably and sealingly connected to a body portion using projections and recesses. In this example, the upper wall of the cartridge is non-removably connected (using projections and projection receiving recesses) to the cartridge body after the pistons and springs are placed therein. The upper wall portion of the fuel cell is similarly non-removably and sealingly connected (via projections and projection receiving recesses) to the fuel cell body.

It is noted that both the fuel cell 10 and the cartridge 20 or refilling device are preferably disposable and is preferably made of light-weight materials. It should also be noted that the exemplary dimensions, values, sizes, volumes, etc., disclosed herein are not intended to be limiting and may vary by as much as, e.g., 50% less to 150% more. Moreover, it should be noted that one way that the spent fluids of the fuel cell 10 and cartridge 20 can be recycled is to remove the valve and allowing the contents to exit from cartridge 20. The majority of parts of the cartridge can be made of polymer materials which are suitable for the fuel cell environment and which can withstand contact/exposure with fuel and electrolyte from a fuel cell and/or similar chemicals. Examples of non-limiting polymer materials include PVC, PP and polyurethane, etc.

By way of non-limiting example, all types of fuels, electrolytes and electrodes which are known for use with fuel cells and the like are contemplated for use by the present invention. Non-limiting examples of fuels, electrolytes and electrodes which are suitable for use in the present invention are disclosed in, e.g., U.S. Pat. No. 6,554,877 B2, mentioned above, U.S. Pat. No. 6,562,497 B2, U.S. Patent Application Publication Nos. 2002/0076602 A1, 2002/0142196 and 2003/0099876 A1, as well as in co-pending U.S. patent application Ser. No. 10/634,806 in the names of Vladimir Meiklyar et al., entitled “Anode for Liquid Fuel Cell”. The entire disclosures of these documents are hereby expressly incorporated by reference. For example, all desirable liquid electrolytes (including those of very high and very low viscosity) may be utilized in each of the disclosed embodiments. Solid electrolytes may also be utilized as well as ion exchange membranes. Matrix electrolytes can also be utilized such as, e.g., a porous matrix impregnated by a liquid electrolyte. Additionally, jelly-like electrolytes can also be utilized with any one or more of the disclosed embodiments. The invention also contemplates using hydrogen elimination systems in the fuel cell and/or cartridge. Non-limiting examples of fuel cell arrangements/systems with hydrogen removal are disclosed in co-pending U.S. patent application Ser. No. 10/758,080, the entire disclosure of which is hereby expressly incorporated by reference in its entirety.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A disposable fuel cell system comprising:
a fuel cell comprising at least one variable volume chamber;
a cartridge comprising at least one variable volume chamber; and
a valve system which at least one of regulates, controls and prevents fluid flow between the cartridge and fuel cell,
wherein the fuel cell is non-refillable after use.

2. The system of claim 1, wherein the at least one variable volume chamber of the fuel cell comprises a flexible fuel chamber.

3. The system of claim 1, further comprising an electrolyte chamber having a defined volume.

4. The system of claim 1, further comprising an electrolyte chamber.

5. The system of claim 1, wherein the at least one variable volume chamber of the cartridge comprises a flexible fuel chamber.

6. The system of claim 1, wherein the at least one variable volume chamber of the cartridge comprises a flexible fuel chamber and a flexible electrolyte chamber.

7. The system of claim 1, wherein the at least one variable volume chamber of the fuel cell comprises a flexible wall having folds.

8. The system of claim 1, wherein the at least one variable volume chamber of the cartridge comprises a flexible wall having folds.

9. The system of claim 1, wherein the at least one variable volume chamber of the fuel cell comprises a flexible expandable and contractable chamber.

10. The system of claim 1, wherein the at least one variable volume chamber of the cartridge comprises a flexible expandable and contractable chamber.

11. The system of claim 1, wherein the cartridge is non-removably connected to the fuel cell.

12. The system of claim 11, wherein the cartridge is non-removably connected to the fuel cell by a sliding connection.

13. The system of claim 11, wherein the cartridge is non-removably connected to the fuel cell by a sliding cradle connection.

14. The system of claim 11, wherein the cartridge is non-removably connected to the fuel cell by an abutting connection.

15. The system of claim 11, wherein the cartridge is non-removably connected to the fuel cell by a rotational sliding connection.

16. The system of claim 1, wherein the fuel cell further comprises a front cover, a rear cover, a mounting frame, an anode assembly, a cathode assembly, a cathode protection device, and a frame rim.

17. The system of claim 16, wherein the at least one variable volume chamber of the fuel cell comprises a flexible wall having folds and a peripheral rim secured to the anode assembly.

18. The system of claim 16, wherein the cathode protection device comprises a cathode protection net.

19. The system of claim 16, wherein the anode assembly and the cathode assembly are mounted to the mounting frame and wherein a volume defined by the mounting frame, the anode assembly and the cathode assembly forms an electrolyte chamber.

20. The system of claim 16, wherein the at least one variable volume chamber of the fuel cell comprises a flexible wall having folds and a peripheral rim secured to the anode assembly and wherein a volume defined by the flexible wall and the anode assembly forms the at least one variable volume chamber of the fuel cell.

21. The system of claim 1, wherein the cartridge further comprises a front cover and a rear cover.

22. The system of claim 21, wherein the at least one variable volume chamber of the cartridge is disposed between the front cover and the rear cover.

23. The system of claim 1, wherein the at least one variable volume chamber of the cartridge comprises a backing and a flexible wall having folds and a peripheral portion secured to the backing.

24. The system of claim 23, wherein the backing comprises a plate.

25. The system of claim 1, wherein the at least one variable volume chamber of the cartridge comprises a variable volume fuel chamber and a variable volume electrolyte chamber, and further comprising fuel arranged within the variable volume fuel chamber and electrolyte arranged within the variable volume electrolyte chamber.

26. The system of claim 1, wherein the at least one variable volume chamber of the fuel cell comprises a variable volume fuel chamber, and wherein the fuel cell further comprises an electrolyte chamber, fuel arranged within the variable volume fuel chamber, and electrolyte arranged within the electrolyte chamber.

27. The system of claim 1, wherein the valve system comprises a first part which is coupled to and/or associated with the fuel cell and a second part which is coupled to and/or associated with the cartridge.

28. The system of claim 27, wherein the second part is insertable into the first part.

29. The system of claim 27, wherein the second part is non-releasably connectable to the first part.

30. The system of claim 27, wherein, when the second part is not connected from the first part, the first part prevents fluid from exiting out of the fuel cell and the second part prevents fluid from exiting out of the cartridge.

31. The system of claim 27, wherein, when the second part is not connected from the first part, the first part prevents fluid from leaking out of the fuel cell and the second part prevents fluid from leaking out of the cartridge.

32. The system of claim 1, wherein the valve system comprises a closed position and an opened position.

33. The system of claim 1, wherein the valve system comprises a plurality of exit ports which are in fluid communication with the fuel cell.

34. The system of claim 1, wherein the fuel cell and cartridge each comprise a generally rectangular shape.

35. A method of assembling a cartridge to a disposable non-refillable fuel cell, the method comprising:
connecting the cartridge comprising at least one variable volume chamber to the disposable non-refillable fuel cell comprising at least one variable volume chamber; and
transferring fluid from the cartridge to the disposable non-refillable fuel cell.

36. The method of claim 35, wherein the transferring comprises regulating or controlling fluid flow between the cartridge and the disposable non-refillable fuel cell.

37. The method of claim 35, wherein the transferring comprises filling the disposable non-refillable fuel cell.

38. The method of claim 35, wherein the connecting comprises non-removably connecting the cartridge to the disposable non-refillable fuel cell.

39. The method of claim 35, further comprising controlling fluid flow between the cartridge and the disposable non-refillable fuel cell via a valve system.

40. The method of claim 35, wherein the transferring comprises automatically causing fluid flow between the cartridge and the disposable non-refillable fuel cell.

41. The method of claim 35, wherein the transferring comprises compressing the least one variable volume chamber of the cartridge to cause the fluid to enter into the disposable non-refillable fuel cell.

42. The method of claim 41, wherein the fluid comprises fuel and electrolyte.

43. The method of claim 35, wherein the transferring comprises forcing the fluid to enter into the at least one variable volume chamber of the disposable non-refillable fuel cell from the at least one variable volume chamber of the cartridge.

44. The method of claim 35, wherein the at least one variable volume chamber of the disposable non-refillable fuel cell comprises a flexible wall with folds.

45. The method of claim 35, wherein the at least one variable volume chamber of the cartridge comprises a flexible wall with folds.

46. The method of claim 35, wherein the at least one variable volume chamber of the disposable non-refillable fuel cell comprises a flexible expandable and contractable chamber.

47. The method of claim 35, wherein the at least one variable volume chamber of the cartridge comprises a flexible expandable and contractable chamber.

48. The method of claim 35, further comprising, before the transferring, coupling a port of the cartridge to a port of the disposable non-refillable fuel cell.

49. The method of claim 48, further comprising, before the transferring, causing at least one of the ports to open from a closed position to allow fluid communication between the cartridge and the disposable non-refillable fuel cell.

50. The method of claim 35, further comprising controlling fluid flow between the cartridge and the fuel cell with a valve arrangement.

51. The method of claim 35, further comprising, before the transferring, securely attaching a male valve portion on the cartridge to a female valve portion on the disposable non-refillable fuel cell.

52. The method of claim 35, further comprising, after the transferring, disconnecting the cartridge from the disposable non-refillable fuel cell.

53. The method of claim 52, further comprising, after the disconnecting, disposing or recycling the cartridge.

54. A single-use cartridge for refilling a fuel cell, the cartridge comprising:
a main container;
at least one variable volume fuel chamber and at least one variable volume electrolyte chamber arranged within the main container; and
a fluid port that communicates with the at least one variable volume fuel and electrolyte chambers.

55. The cartridge of claim 54, wherein the main container comprises a rear cover and a front cover.

56. The cartridge of claim 54, wherein the at least one variable volume fuel chamber comprises an flexible material wall that is at least one of expandable and compressible and inflatable and deflatable.

57. The cartridge of claim 54, wherein the at least one variable volume electrolyte chamber comprises an flexible material wall that is at least one of expandable and compressible and inflatable and deflatable.

58. The cartridge of claim 54, wherein the at least one variable volume fuel chamber is defined by an inflatable and/or expandable flexible material wall and a rigid plate.

59. The cartridge of claim 58, wherein the at least one variable volume electrolyte chamber is defined by another inflatable and/or expandable flexible material wall and the rigid plate.

60. The cartridge of claim 54, wherein the at least one variable volume electrolyte chamber is defined by an inflatable and/or expandable flexible material wall and a rigid plate.

61. The cartridge of claim 54, wherein the at least one variable volume fuel chamber comprises a flexible material wall with folds.

62. The cartridge of claim 54, wherein the at least one variable volume electrolyte chamber comprises a flexible material wall with folds.

63. The cartridge of claim 54, wherein the main container completely surrounds and contains the at least one variable volume fuel chamber and the at least one variable volume electrolyte chamber.

64. The cartridge of claim 54, wherein the at least one variable volume fuel chamber and the at least one variable volume electrolyte chamber are separated from each other.

65. The cartridge of claim 54, further comprising fuel arranged within the at least one variable volume fuel chamber and electrolyte arranged within the at least one variable volume electrolyte chamber.

66. The cartridge of claim 54, wherein the fluid port is adapted to prevent fuel and electrolyte from exiting the at least one variable volume fuel chamber and the at least one variable volume electrolyte chamber when the cartridge is not connected to the fuel cell, and wherein the fluid port is adapted to allow fuel and electrolyte to exit from the at least one variable volume fuel chamber and the at least one variable volume electrolyte chamber when the cartridge is non-removably connected to the fuel cell.

67. The cartridge of claim 54, wherein the fluid port is adapted to prevent fuel and electrolyte from exiting the at least one variable volume fuel chamber and the at least one variable volume electrolyte chamber when the fluid port is not connected from a fluid port of the fuel cell, and wherein the fluid port is adapted to allow fuel and electrolyte to exit from the at least one variable volume fuel chamber and the at least one variable volume electrolyte chamber when the fluid port of the cartridge is connected to the fluid port of the fuel cell.

68. The cartridge of claim 54, wherein the fluid port is adapted to non-removably connect to a fluid port of the fuel cell.

69. The cartridge of claim 54, wherein the fluid port comprises a closed position and an opened position.

70. The cartridge of claim 54, wherein the fluid port comprises a plurality of exit ports which are adapted for fluid communication with the fuel cell.

71. The cartridge of claim 54, further comprising a securing cap that is removably secured to the fluid port.

72. A disposable fuel cell comprising:
an outer shell;
at least one fuel chamber and at least one electrolyte chamber arranged within the outer shell;
an anode arranged within the outer shell;
a cathode arranged within the outer shell; and
a valve that communicates with at least one of the fuel and electrolyte chambers.

73. The fuel cell of claim 72, wherein the outer shell comprises a rear cover and a front cover.

74. The fuel cell of claim 72, wherein the at least one fuel chamber comprises is larger than the at least one electrolyte chamber.

75. The fuel cell of claim 72, wherein the at least one electrolyte chamber comprises a defined volume chamber.

76. The fuel cell of claim 72, wherein the valve comprises two valves, one of the two valves being in fluid communication with the at least one fuel chamber and another of the two valves being in fluid communication with the at least one electrolyte chamber.

77. The fuel cell of claim 72, further comprising a protective cover non-removably connected to the fuel cell and preventing refilling of the fuel cell.

78. The fuel cell of claim 72, wherein the at least one electrolyte chamber is defined by the cathode.

79. The fuel cell of claim 78, wherein the at least one electrolyte chamber is defined by the cathode and a frame member.

80. The fuel cell of claim 72, wherein the at least one fuel chamber comprises a flexible material enclosure.

81. The fuel cell of claim 72, further comprising a frame member supporting the anode and the cathode.

82. The fuel cell of claim 72, wherein the outer shell completely surrounds and contains the at least one fuel chamber and the at least one electrolyte chamber.

83. The fuel cell of claim 72, wherein the at least one fuel chamber and the at least one electrolyte chamber are separated from each other.

84. The fuel cell of claim 72, further comprising fuel arranged within the at least one fuel chamber and electrolyte arranged within the at least one electrolyte chamber.

85. The fuel cell of claim 72, wherein the valve is adapted to prevent fuel and electrolyte from exiting the at least one fuel chamber and the at least one electrolyte chamber when the fuel cell is non-removably separated from a cartridge

86. The fuel cell of claim 72, wherein the valve comprises valves adapted to prevent fuel and electrolyte from exiting the at least one fuel chamber and the at least one electrolyte chamber when the valves are not connected to valves of a cartridge.

87. The fuel cell of claim 72, wherein the valve is adapted to non-removably connect to a valve of the cartridge.

88. The fuel cell of claim 72, wherein the valve comprises a closed position and an opened position.

89. The fuel cell of claim 72, wherein the valve comprises a plurality of exit ports which are adapted for fluid communication with the cartridge.

90. The fuel cell of claim 72, further comprising a securing cap that is removably secured to the valve.

91. A disposable fuel cell and cartridge system, the system comprising:
a disposable fuel cell comprising, an anode, a cathode, at least one fuel chamber, at least one electrolyte chamber, and a first valve which regulates or controls fluid flow; and
a disposable cartridge comprising at least one fuel chamber, at least one electrolyte chamber, and a second valve which regulates or controls fluid flow,
wherein the second valve is non-removably connectable to the first valve.

92. The system of claim 91, wherein the fuel cell comprises an outer shell having a rear cover and a front cover.

93. The system of claim 91, wherein each at least one fuel chamber comprises an flexible material wall that is at least one of expandable and compressible and inflatable and deflatable.

94. The system of claim 91, wherein the at least one electrolyte chamber of the fuel cell comprises a defined volume chamber.

95. The system of claim 91, wherein each at least one fuel chamber is defined by an inflatable and/or expandable flexible material wall and a rigid plate member.

96. The system of claim 91, wherein the at least one electrolyte chamber of the fuel cell is defined by the cathode and a frame member.

97. The system of claim 91, wherein each at least one fuel chamber comprises a flexible material wall with folds.

98. The system of claim 91, further comprising a frame member supporting the anode and the cathode of the fuel cell.

99. The system of claim 91, wherein the fuel cell further comprises an outer shell that completely surrounds and contains the at least one fuel chamber and the at least one electrolyte chamber.

100. The system of claim 91, wherein the cartridge further comprises a main container that completely surrounds and contains the at least one fuel chamber and the at least one electrolyte chamber.

101. The system of claim 91, wherein the at least one fuel chamber and the at least one electrolyte chamber of the fuel cell are separated from each other, and wherein the at least one fuel chamber and the at least one electrolyte chamber of the cartridge are separated from each other.

102. The system of claim 91, further comprising fuel arranged within the at least one fuel chamber and electrolyte arranged within the at least one electrolyte chamber of the fuel cell.

103. The system of claim 91, further comprising fuel arranged within the at least one fuel chamber and electrolyte arranged within the at least one electrolyte chamber of the cartridge.

104. The system of claim 91, wherein the first valve is adapted to prevent fuel and electrolyte from exiting the at least one fuel chamber and the at least one electrolyte chamber when the fuel cell is separated from the cartridge, and wherein the second valve is adapted to allow fuel and electrolyte to exit from the at least one fuel chamber and the at least one electrolyte chamber of the cartridge when the cartridge is non-removal connected to the fuel cell.

105. The system of claim 91, wherein the first valve is adapted to prevent fuel and electrolyte from exiting the at least one fuel chamber and the at least one electrolyte chamber when the first valve is not connected to the second valve of the cartridge, and wherein the first valve is adapted to prevent fuel and electrolyte from exiting from the at least one fuel chamber and the at least one electrolyte chamber when the second valve of the cartridge is not connected to the first valve of the fuel cell.

106. The system of claim 91, wherein the first valve of the fuel cell is adapted to non-removably connect to the second valve of the cartridge only once.

107. The system of claim 91, wherein each of the first and second valves comprises a closed position and an opened position.

108. The system of claim 91, wherein each of the first and second valves comprise a plurality of exit ports which are adapted for fluid flow.

109. The system of claim 91, further comprising a first securing cap that is removably secured to the first valve and a second securing cap that is removably secured to the second valve.

110. The system of claim 91, wherein the first valve is securely and sealingly connected to second valve.

111. A method of filling a disposable fuel cell, the method comprising:
connecting a disposable cartridge to the disposable fuel cell; and
transferring a fluid from the cartridge to the disposable fuel cell.

112. The method of claim 111, wherein the transferring comprises compressing automatically transferring the fluid from the cartridge to the disposable fuel cell when the cartridge is fully and sealingly connected to the disposable fuel cell.

113. The method of claim 111, further comprising controlling fluid flow between the cartridge and the disposable fuel cell with first and second valves.

114. The method of claim 111, further comprising preventing fluid flow between the cartridge and the disposable fuel cell when the cartridge is partially connected to the disposable fuel cell.

115. The method of claim 111, further comprising:
forcing fuel to enter into at least one fuel chamber of the disposable fuel cell from at least one fuel chamber of the cartridge;
forcing electrolyte to enter into at least one electrolyte chamber of the disposable fuel cell from at least one electrolyte chamber of the cartridge; and
disconnecting the cartridge from the disposable fuel cell; and
preventing fuel and electrolyte from exiting the disposable fuel cell after the disconnecting.

116. A method of filling a disposable fuel cell with a disposable cartridge, the method comprising:
non-removably connecting the cartridge and the fuel cell to each other; and
transferring at least one fuel component from the cartridge to the fuel cell.

117. The method of claim 116, further comprising:
disposing the fuel cell and the cartridge.

118. A disposable fuel cell system comprising a disposable fuel cell that includes:
an anode;
a cathode;
at least one fuel chamber;
at least one electrolyte chamber;
at least one fluid port allowing the disposable fuel cell to be filled with a fuel; and
a mechanism that prevents a refilling of the disposable fuel cell.

119. The disposable fuel cell system of claim 118, further comprising electrolyte disposed in the disposable fuel cell.

120. The disposable fuel cell system of claim 119, wherein the electrolyte comprises at least one of a liquid electrolyte, a solid electrolyte, a matrix electrolyte, and a jelly-like electrolyte.

121. The disposable fuel cell system of claim 118, further comprising a disposable cartridge for filling the disposable fuel cell a single time.

122. The disposable fuel cell of claim 121, wherein the disposable cartridge comprises at least one of a liquid electrolyte, a solid electrolyte, a matrix electrolyte, and a jelly-like electrolyte.

123. The disposable fuel cell system of claim 118, further comprising an ion exchange membrane arranged in the disposable fuel cell.
